(19) United States
(12) Patent Application Publication
(10) Pub. No.: US 2013/0218652 A1
(43) Pub. Date: Aug. 22, 2013

(54) Split Rewards

(71) Applicant: Rewarder, Inc., (US)

(72) Inventors: Kendall M. FARGO, Kentfield, CA (US); Graham H. Rasmussen, San Francisco, CA (US)

(73) Assignee: Rewarder, Inc., Kentfield, CA (US)

(21) Appl. No.: 13/851,433

(22) Filed: Mar. 27, 2013

Related U.S. Application Data
(63) Continuation of application No. PCT/US11/53502, filed on Sep. 27, 2011.
(60) Provisional application No. 61/386,923, filed on Sep. 27, 2010.

(51) Int. Cl. G06Q 30/02

(52) U.S. Cl. CPC G06Q 30/0239
USPC 705/14.16; 705/14.39

(57) ABSTRACT

Computer systems and methods on servers in a communication network, including computers having processors and executing computer-readable media, to receive a first request to share a reward page from a user, indicating a goal or need. And in response to the received request, disseminate the reward page to communication platforms via the network. Next, receive a request to share the reward page from a user. Next, in response to the received request, disseminate the reward page to another group of communication platforms via the network and receive solution opportunities from contacts from the communication platforms. Then determine one received solution opportunity from solution opportunities that achieves the goal or need of the reward page and determine a chain of contacts that resulted in the submission of selected at least one solution. Finally split the reward among the contacts in the chain.

### CROSS-REFERENCE TO RELATED APPLICATIONS

This patent application claims priority from and is related to International application no. PCT/US11/53502 filed on Sep. 27, 2011, which claims priority from U.S. provisional application 61/386,923 filed on Sep. 27, 2010, which is hereby incorporated by reference in its entirety. This application is additional related to U.S. application No. ______ filed on Mar. 27, 2013 entitled “Networked Incentive System”; U.S. application No. ______ filed on Mar. 27, 2013 entitled “Networked Solution Opportunity Reward”; U.S. application No. ______ filed on Mar. 27, 2013 entitled “Reward Creation”; U.S. application No. ______ filed on Mar. 27, 2013 entitled “Registering User with Reward Incentive System”; U.S. application No. ______ filed on Mar. 27, 2013 entitled “Reward Modification”; U.S. application No. ______ filed on Mar. 27, 2013 entitled “Reward Posting Search”; and U.S. application No. ______ filed on Mar. 27, 2013 entitled “Reward Incentive Monitor”.

### TECHNICAL FIELD

This relates to electrical digital data processing, and more particularly to input arrangements for transferring data to be processed into a form capable of being handled by a computer, output arrangements for transferring data from processing units to output units, and digital computing or data processing methods specially adapted for specific applications, which include interaction techniques for graphical user interfaces to offer rewards to users across communication networks.

### BACKGROUND

The Internet has evolved in such ways that users may search content in creative ways and stay connected with friends, family, other users with similar interests, business associates and the like.

Users and online businesses, however, are limited in their ability to fulfill personal or business needs by posting requests or advertisements using traditional methods. A person may post, for example, an ad at an online news service site or an online classified advertisement service like Craigslist. Unfortunately, the payment for the classified posting or advertisement is not tied to an actual result. The payment is made regardless of whether the classified posting or advertisement attracted anyone responding to the posting.

In another example, a user could manually post a description of what is being sought or requested on the user's social networks, but there is no incentive for those in the network to help that person fulfill the need. Nor does it incentivize those people to share or forward the information with other people in their respective networks who could help.

There is currently no medium for users to seek or request solutions to personal and business needs though the various network circuits available online.

### SUMMARY

This disclosure relates to a method for creating a reward on at least one server in a communication network. The method comprises generating an electronic posting at the at least one server on the communication network, the posting being based on information received from a posting user, the received information including a description of a goal or need, associating an incentive with the posting, the incentive being for a successful submission of a solution opportunity in response to the posting, disseminating the posting including information about the incentive to at least one communication platform on the network, causing a display of the disseminated posting in a display unit of at least a second user of the at least one communication platform, in response to the posting, receiving at least one solution opportunity from at least the second user, allowing a selection of at least one solution opportunity from any received solution opportunity, associating, at the at least one server, the selected solution opportunity with at least one recipient, and awarding the incentive to the at least one recipient.

In the method at least one communication platform on the network includes a social network. Also in the method, at least one communication platform on the network can be one from a group consisting of: email, SMS, and mobile application. The electronic posting includes a unique URL link associated with the user who created the electronic posting.

Also in the method, the unique URL link can be further associated with at least one contact user, the at least one contact user being one who shares the electronic posting with another.

In the method, the electronic posting includes a unique URL link associated with information about the posting user as the electronic posting can be disseminated to at least one communication platform on the network.

The method also comprises disseminating the posting including information about the incentive to at least one communication platform. The method comprises disseminating the posting to a first plurality of communication platforms, wherein the first plurality of communication platforms include a first plurality of contacts associated with the first user and wherein the first plurality of contacts includes the at least second user, and disseminating the posting to a second plurality of communication platforms, wherein the second plurality of communication platforms include a second plurality of contacts associated with the second user.

Further in the method, at least one solution opportunity can be received from the recipient in either the first plurality of contacts or the second plurality of contacts.

In the method, the incentive can be at least one from a group consisting of monetary currency, virtual currency, a gift card, merchandise, community status, special privileges, and points.

Also in the method, the points represent an incentive exchanged for goods or services.

In the method, the incentive includes a value that represents a privilege associated with a future activity or service by the server. At least one solution opportunity can be received in response to receiving an indication that a “Win this Reward” button was clicked on a user interface. The posting can be provided in an application to display on a user interface.

Further in the method, the application can be a mobile application for displaying on a mobile device.

The method comprises disseminating the posting to at least one communication platform is achieved by selecting a hyperlink to social network site. In the method, the hyperlink can be associated with a URL link. Also in the method, the hyperlink can be associated with an icon displayed on a user interface. The method further comprises awarding the incentive, based on the selected solution opportunity, is to a plurality of recipients, wherein the plurality of recipients share in the reward.

The method also comprises associating an incentive with the posting, the incentive being for the successful submission of a solution opportunity in response to the posting includes displaying, in the posting, a value that represents the amount the incentive has been funded up front.

Further in the method, the value that represents the amount the incentive has been funded up front is a percentage value.

The method comprises disseminating the posting including information about the incentive to at least one communication platform on the network further includes, allowing the posting user to pay for disseminating the posting to a predetermined group of communication platforms, and receiving payment to disseminate the posting to a predetermined group of communication platforms.

Further, the method comprises disseminating the posting including information about the incentive to at least one communication platform on the network further includes, allowing the posting user to pay for changing the number of communication platforms to which the posting is disseminated or changing the frequency of publishing the posting on a predetermined group of communication platforms.

The method further comprises providing, on a graphical user interface, at least one prompt to guide the posting user to choose a type of reward to offer. Also, the method further comprises providing, on a graphical user interface, at least one prompt to guide the posting user to select a reward amount as the incentive being offered.

This disclosure also relates to a method for sharing a reward on a network. The method comprises receiving a first request to share a reward page from a first user, the reward page indicating a goal or need, in response to receiving the first request, disseminating the reward page to a first plurality of social platforms via the network, receiving at least a second request to share the reward page from at least a second user, wherein the at least second user is a contact from the first plurality of communication platforms, in response to receiving the at least second request, disseminating the reward page to a second plurality of communication platforms via the network, receiving at least one solution opportunity from at least one contact from the first and second plurality of communication platforms, determining whether the at least one solution opportunity fulfills the goal or need of the reward page, and in response to a positive determination, rewarding the at least one contact for submitting the at least one solution opportunity.

The method comprises determining whether the at least one solution opportunity fulfills the goal or need is determined by a user responsible for creating the reward posting. The method further comprises determining whether the at least one solution opportunity fulfills the goal or need is automated, based on one or more factors.

This disclosure further relates to a method for paying out a reward. The method comprises receiving a first request to share a reward page from a first user, the reward page indicating a goal or need, in response to receiving the first request, disseminating the reward page to a first plurality of communication platforms via the network, receiving at least a second request to share the reward page from at least a second user, wherein the at least second user is a first contact from the first plurality of communication platforms, in response to receiving the at least second request, disseminating the reward page to a second plurality of communication platforms via the network, receiving a plurality of solution opportunities from one or more contacts from the first and second plurality of communication platforms, determining at least one received solution opportunity from the plurality of solution opportunities that fulfills the goal or need of the reward page, determining a chain of contacts that resulted in the submission of selected at least one solution, and splitting the reward among the contacts in the chain.

In addition, this disclosure relates to a method of modifying a reward page on a communication network. The method comprises disseminating a reward page to at least one communication platform on the network, wherein the reward page includes an associated goal or need and an initial reward amount, and wherein the at least one communication platform is accessed by a plurality of contacts. The method also comprises receiving a request from at least one contact from the plurality of contacts to modify the associated initial reward amount, upon validation of the request, updating the reward page to indicate the modified reward amount, disseminating the reward page with the modified reward amount to the at least one communication platform on the network, receiving, from the plurality of contacts, a plurality of solution opportunities to fulfill the goal or need associated with the reward page, selecting at least one of the plurality of solution opportunities to fulfill the goal or need of the reward page, and awarding the modified reward amount to at least one recipient who submitted the selected one of the plurality of solution opportunities.

In the method, the modified reward amount can be an additional amount to increase the initial reward amount. Also in the method, the modified reward amount can be modified by a value that matches the initial reward amount. Further in the method, the request to modify the reward amount is increased by a cumulative amount offered by a subset of the plurality of contacts.

The method comprises selecting at least one of the plurality of solution opportunities to fulfill the goal or need of the reward page is selected by the subset of the plurality of contacts voting.

In the method, the modified reward amount can be modified to increase the reward amount and changing a criterion for achieving the goal or need.

The method comprises disseminating the reward page to at least one communication platform on the network. The method includes disseminating the reward page to a first plurality of communication platforms, the first plurality of communication platforms having a first plurality of contacts associated with a first user, wherein the first user created the reward page, and disseminating the reward page to a second plurality of communication platforms, wherein the second plurality of communication platforms include a second plurality of contacts associated with a second user and the second user is a contact from the first plurality of contacts.

This disclosure relates to a method for creating a reward. The method comprises creating a reward file based on information received from a first user at a remote website on a network, associating a reward value to the reward file, the reward value being an incentive to submit a solution to a goal or need described in the reward file, creating a reward headline associated with the reward file, posting the reward headline on the remote website, receiving at least one solution opportunity responsive to the reward posting from at least a second user at the remote website, selecting at least one solution opportunity from a plurality of solution opportunities, and awarding the reward value to a recipient, wherein the recipient is selected from a plurality of users who submitted the plurality of solution opportunities, and wherein the group of users includes the at least second user.

The method further comprises disseminating the reward headline to at least one communication platform selected by the at least one second user at the remote website.

In the method, the at least one communication platform can be one from a plurality of communication platforms displayed on the remote website as clickable icons. Also in the method, the clickable icon can be associated with a URL link. Further in the method, the clickable icons can be associated with a social network site.

This disclosure also relates to a method for viewing and sharing a reward on a server in a communication network. This method comprises receiving log in information from a user, selecting a plurality of reward pages from a repository of reward pages, displaying the plurality of reward pages for the user to view, allowing the user to select at least one reward page from the plurality of reward pages, allowing the user to submit a solution opportunity for the selected at least one reward page, and notifying a reward creator of the solution opportunity, wherein the selected at least one reward page was created based on information provided by the reward creator.

The method further comprises tracking the activity of the user on the communication network.

The method comprises selecting the plurality of reward pages includes selecting based on the tracking activity of the user.

The method also comprises selecting based on the tracking activity of the user includes selecting based on a combination of the tracking activity and the user login information.

The method comprises selecting the plurality of reward pages includes selecting based on preference information provided by the user.

The method further comprises accessing at least one service from a group consisting of access to view the user's own account information, status of other reward opportunities submitted, history of rewards won, and history of rewards created.

The method comprises selecting the plurality of reward pages is selected based on at least one criteria. In the method, at least one criteria includes a duration of time.

This disclosure further relates to a method for operating a reward sharing system. The method comprises generating a reward file based on information received from a reward creator, wherein the information includes an incentive for achieving a goal or need of the reward creator, posting a reward page associated with the reward file in a market place, distributing the reward page to a plurality of contacts on one or more social network sites, receiving one or more submissions responding to the reward page posting from the market place or the one or more social network sites, and selecting a winner from the one or more submissions.

The method also comprises selecting the winner is based on the reward creator manually indicating which submission to select.

The method further comprises selecting the winner includes automatically selecting the winner based on at least one attribute from a group consisting of: user profile information, user activity information, reward category, relevance determination based on key words in the reward file, and user preferences.

In addition, this disclosure relates to a method for searching reward postings. The method comprises receiving a reward query through a user interface of a reward system from a user on a communication network, requesting a search for a plurality of reward pages associated with at least one term in the query from a search engine, and displaying at least a subset of the plurality of reward pages on a web browser on the communication network.

In the method, the search engine can be part of the reward system. Also in the method, the search engine can be remote from the reward system. Further in the method, the search result can be generated from a search conducted on the reward system. Finally in the method, the search result can be generated from a search conducted from a database that includes content from a plurality of communication platforms.

This disclosure relates to a method for accessing services of a reward incentive system on at least one server in a communication network. The method comprises receiving profile information from a user at a communication network, registering the user with the reward incentive system in response to receiving the profile information, creating a registered user profile, and sending a notification to the user about at least one reward posting based on at least one factor from the profile information.

In the method, at least one factor is at least one from a group consisting of: location information of the user, amount of the reward, demographics of the user from the user profile information, demographics of a creator of the reward, reward type, past interest in similar reward postings, user preferences, and privileges in the reward incentive system.

The method comprises sending the notification includes sending the notification to the user account at a social network site. The method further comprises sending the notification includes sending the notification to the user's email. The method also comprises sending the notification includes sending the notification via text message. Further, the method comprises sending the notification includes sending a message to a mobile application on a user's mobile device.

This disclosure also relates to a method of monitoring a user's activity on a reward incentive system. The method comprises receiving login information from a user at a communication network, logging in the user to the reward incentive system, determining at least a first action for creating a new reward page, determining at least a second action for selecting and viewing at least one reward page, determining at least a third action associated with submitting a solution opportunity, extracting relevancy data from determining of at least first, second, or third action, and storing data from determining the at least first, second, and third actions and the extracted relevancy data.

The method further comprising, based on the relevancy data, determining which reward postings to display to the user. The method also comprising based on the relevancy data, determining which reward postings to send a notification about to the user.

This disclosure further relates to a method of monitoring activity on a reward incentive system. The method comprises sending a notification to a user each time a solution opportunity is submitted for a reward page created by the user, the reward page being based on information received from the user and the received information including a description of a goal or need, receiving an acceptance or rejection selection indicator for each of the received solution opportunities, if a solution opportunity is rejection, associating a rating value with the rejected solution opportunity, and determining a future privilege for each user who submitted the rejected solution opportunity based on the rating value associated with the rejected solution opportunity.

The method further comprises increasing or decreasing the future privilege based on receiving additional rating value information as additional acceptance or rejection information is received about additional solution opportunity submissions.

In the method, a future privilege includes allowing the user to earn more submissions per day. Also in the method, a future privilege includes allowing the user to view a new reward page before at least one other user. Further in the method, the user represents a business entity.

The method further comprises allowing the user to purchase the future privilege, wherein the future privilege includes permission to submit additional solution opportunities if the number of submissions allowed are limited. The method also comprises allowing the user to sell the future privilege to another user.

In addition, this disclosure relates to a method of monitoring on a reward incentive system. The method comprises sending a notification to a user each time a solution opportunity is received for a reward page created by the user, the reward page being based on information received from the user and the received information including a description of a goal or need, receiving an acceptance or rejection selection for each of the received solution opportunities, monitoring the response of the user to each of the received solution opportunities, rating the user in comparison to other users based on monitoring the response of the user to each of the received solution opportunities, and determining at least one future privilege based on the rating in comparison to other users.

The method comprises rating the user includes rating the user based on how quickly the user responds to each of the received solution opportunities. The method also comprises rating the user includes rating the user based on how quickly a solution opportunity can be selected to achieve the goal or need. In addition, the method comprises rating the user includes rating the user based on how quickly at least one submitter of the solution opportunity selected can be paid a reward.

The method further comprises ranking a plurality of reward pages based on rating each of the users, and wherein the future privilege includes publishing the plurality of reward pages based on the ranking.

This disclosure relates to a method for providing a graphical user interface by a reward system on a communication network. The method comprises receiving log in information from a user and logging the user in to the reward system, displaying the graphical user interface window to the user, receiving a first content entered in a first field of the graphical user interface, the first content being a headline describing a reward, receiving a second content entered in a second field of the graphical user interface, the second content being a description of the reward, the description of a reward including a goal or need, receiving a third content entered in a third field of the graphical user interface, the third content being a number value representing an incentive for the successful submission of a solution opportunity, receiving a fourth content entered in a fourth field of the graphical user interface, the fourth content being a category selection for the reward, generating a reward page based on the received first, second, third, and fourth content; and posting the reward page to at least one communication platform.

The method further comprises receiving a fifth content entered in a fifth field of the graphical user interface, the fifth content being contact information of the user.

The method also comprises receiving a sixth content entered in a sixth field of the graphical user interface, the sixth content being an indication of a geographic location.

In the method, the fourth field includes a button that, when selected, opens a predetermined drop-down list of categories.

This disclosure also relates to an incentive system. The system comprises a user data component configured to receive and store user profile and activity information, a goal page configured to generate a user interface to allow at least one user of the user data component to publish a goal or need and an associated incentive, a distributor engine configured to allow the at least one user to post the goal page to a plurality of communication platforms, an opportunity processor configured to manage a plurality of solution opportunities received to fulfill the goal or need described in the goal page and the selection of at least one solution opportunity, and a payment system configured to collect a fund based on the associated incentive and distribute the fund based on the selection of the at least one solution opportunity.

In the system, the payment system can be further configured to retain a portion of the fund as a service fee.

The system further includes a reward splitting component configured to determine the allocation of the fund when multiple recipients are identified to receive the fund.

The system also includes a gift card splitter configured to determine the allocation of the fund as one or more gift cards.

In addition, the system further includes a marketplace component configured to display the goal place in an online market place for posting rewards.

Further, the system includes a dashboard configured to allow a user to view the contents of the published goal page and check status and progress of solution opportunity submissions.

In the system, the dashboard can be further configured to allow the user to check social networks the user used to share the goal or need, the number of contacts who have viewed goal or need, number of solutions received, and the number of contacts who have shared the goal or need.

The system further comprises a bounty system module configured to prompt the user to choose an incentive to offer based on at least the received goal or need information.

In the system, the bounty system module can be further configured to prompt a type of incentive and an incentive amount.

Also in the system, the type of reward can be at least one from a list consisting of monetary value, points, privilege, and virtual currency.

### BRIEF DESCRIPTION OF THE DRAWINGS

For a better understanding of the technology described in this document as well as any embodiments thereof, reference should be made to the description below, in conjunction with the following figures in which like reference numerals refer to corresponding parts throughout the figures.

FIG. 1A is a block diagram of an incentive system in a network, according to some embodiments.

FIG. 1B is a block diagram of a use case illustrating the functionality of a database schema in the incentive system of FIG. 1A.

FIG. 2A is a screenshot of an example of a user interface for creating a reward in the incentive system 150 of FIG. 1A, according to some embodiments.

FIG. 2B is a screenshot of an example of a reward category list in the user interface 200 of FIG. 2A, according to some embodiments.

FIG. 2C is a screenshot of various interfaces for gathering user data in the incentive system of FIG. 1A, according to some embodiments.

FIG. 2D is a screenshot illustrating a user interface for prompt a user to select from a list of preferences or features, according to some embodiments.

FIG. 3 is screenshots of user interfaces in the bounty or reward system of FIG. 1A, according to some embodiments.

FIG. 4A is a block diagram illustrating a system for sharing and splitting a reward, according to some embodiments.

FIG. 4B are screenshots illustrating various interfaces used for the distribution of a reward to contacts at a social network site, according to some embodiments.

FIG. 4C is a screenshot that illustrates a bounty or reward post on a social network site, according to some embodiments.

FIG. 4D are screenshots of user interfaces for posting on another social network site as another illustration of how a Reward Creator distributes bounties to contacts, according to another embodiment.

FIG. 4E is another screenshot example of posting a Reward Creator's bounty on another social network, according to some other embodiments.

FIG. 4F is a screenshot illustrating posting a reward on another social network, according to another embodiment.

FIG. 5A is a user interface illustrating a goal or need page, according to some embodiments.

FIG. 5B is a user interface illustrating another goal or need page, in this case to post a bounty for getting a job, according to another embodiment.

FIG. 5C is a screenshot of a posting of a bounty on a business's social network page, according to some embodiments.

FIG. 5D is a screenshot illustrating another example of a Reward Creator's reward page, according to some other embodiments.

FIG. 5E is a screenshot illustrating a pop-up window for submitting an opportunity, according to some other embodiments.

FIG. 5F is a screenshot example of a posting of the reward page on a social network site, according to some embodiments.

FIG. 5G is a screenshot example of a posting of the reward page on a social network user's page or a social network site, according to some embodiments.

FIG. 5H is a screenshot of another sample reward posting on another social network site, a LinkedIn site, according to some embodiments.

FIG. 5I is a screenshot of another example of posting a reward on yet another social network site, a Twitter site, according to some embodiments.

FIG. 6A is a user interface illustration of a contact user interface for the opportunity/lead processor of FIG. 1, according to some embodiments.

FIG. 6B is a user interface illustration of an agent user interface for a distributor engine of FIG. 1A, according to some embodiments.

FIG. 7A is a screenshot illustrating a Reward Creator's user interface, after a reward has been created, according to some embodiments.

FIG. 7B is a screenshot illustrating a sample submission page displayed when a user selects the submission tab, according to some embodiments.

FIG. 8 is a block diagram illustrating different scenarios for a bounty, according to some embodiments.

FIG. 9A is a screenshot illustrating a search interface where a user may search and sort all reward postings via the incentive system's marketplace of FIG. 1A, according to some embodiments.

FIG. 9B are screenshots illustrating how bounties may be sorted using the marketplace system of FIGS. 1A and 9A, according to some embodiments.

FIG. 9C is a screenshot of a user interface of a third-party marketplace that includes the posting of a reward, according to some embodiments.

FIG. 9D is a screenshot example of a market place user interface, according to some embodiments.

FIG. 10A is a sample integration interface for creating and posting a reward on a third party website, according to some embodiments.

FIG. 10B is a screenshot illustrating posting a reward on the third party site “The Question & Answer” after creating it on an integration interface of FIG. 10A, according to some embodiments.

FIGS. 11A and 11B show data tables of tracking reports of data collected by the incentive system of FIG. 1A, according to some embodiments.

FIGS. 12A-12E are illustrations of sample mobile devices configured to access various features and services of the incentive system, according to some embodiments.

FIG. 13 is a flow chart illustrating the operation of the incentive system of FIG. 1A, according to some embodiments.

FIG. 14 is a block diagram illustrating an embodiment of at least one server system according to embodiments.

FIG. 15 illustrates a block diagram of an embodiment of a client system, such as those used by the client devices of FIG. 1A, according to some embodiments.

### DETAILED DESCRIPTION

Reference will now be made in detail to the technology, examples of which are illustrated in the accompanying drawings. In the following description, numerous specific details are set forth in order to provide a sufficient understanding of the presented subject matter. But, it will be apparent to one of ordinary skill in the art that the subject matter may be practiced without all these specific details. Moreover, the particular described subject matter is provided by way of example and should not be used to limit the scope of any claims to these particular examples. In other instances, well-known methods, procedures, components, and structures have not been described in detail so as to not unnecessarily obscure aspects of the subject matter described.

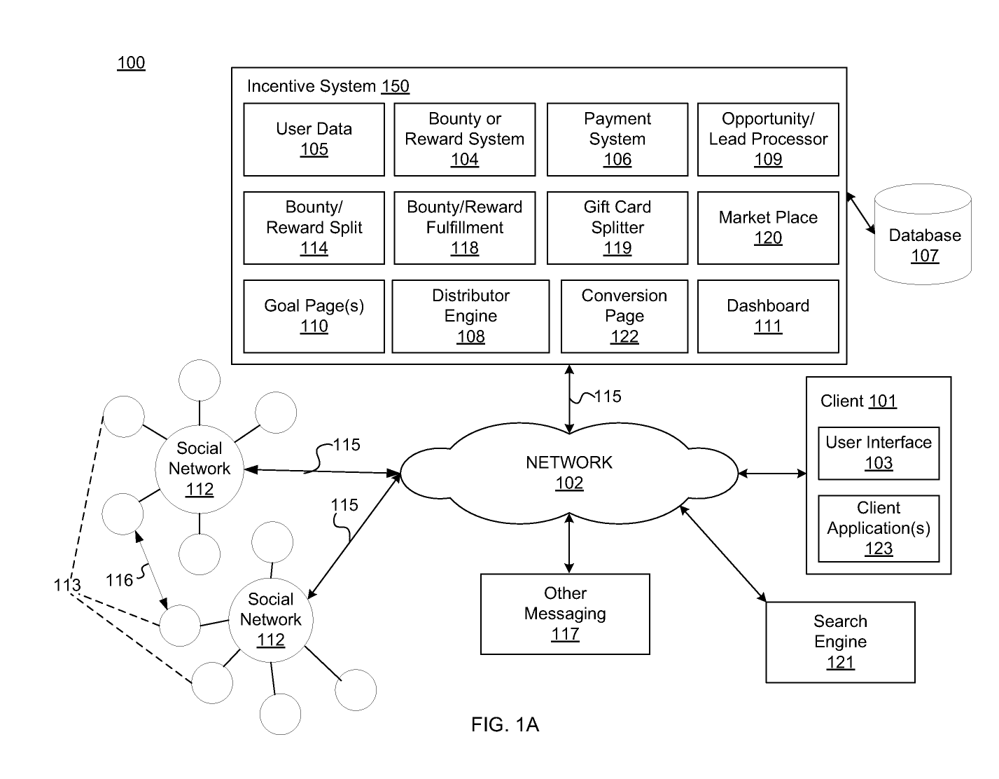

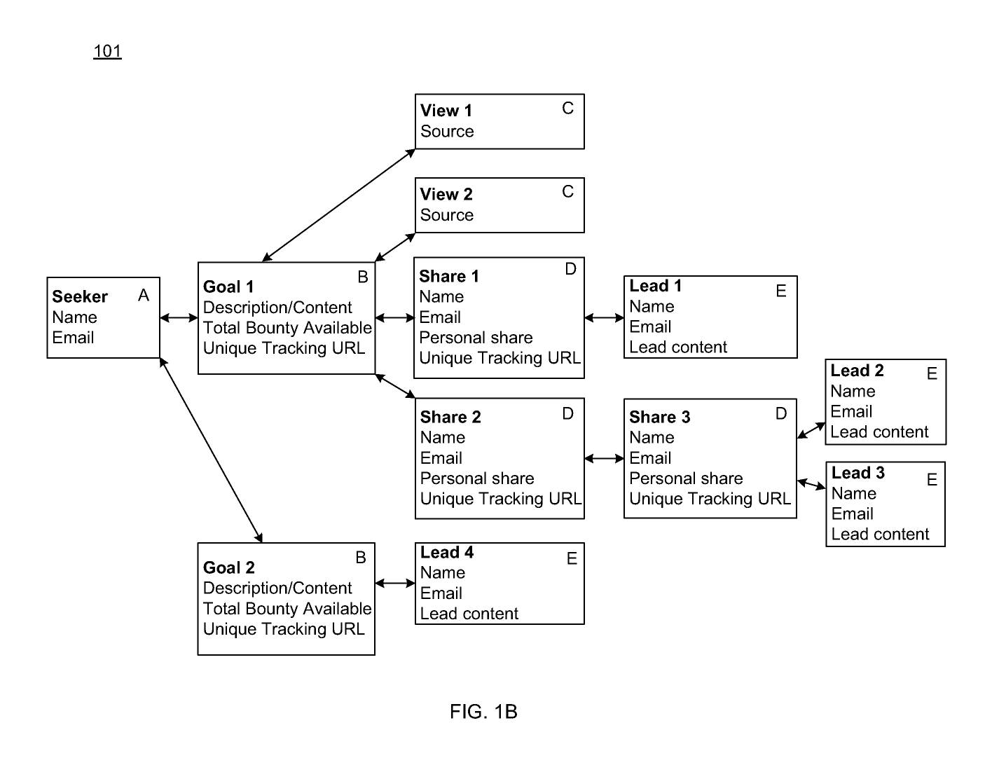

FIG. 1A illustrates an incentive system 150 in a network system 100. The system 100 includes the incentive system 150 and a plurality of other systems such as one or more social networks 112, search engine 121, and other messaging system 117, accessed by one or more users at one or more client devices, such as client device 101, over a network 102.

For ease of understanding the subject matter described below, the following definitions are provided:

A “reward” or “bounty”, which may be used interchangeable, describes a goal or need created and posted by a user of the incentive system 150 and the incentive being offered to have the goal or need fulfilled.

“Reward Creators” may be a person, company, organization, or any other entity that posts a reward with some incentive for people (or businesses or any entity) to help the Reward Creator fulfill a goal or need.

A “goal or need” may refer to what the Reward Creator wants to have accomplished. The goal or need may be any object, tangible or intangible, and/or any service.

An “incentive” may be the payment of the reward or bounty and holds some value. The incentive could be either financial (money) or non-financial (virtual currency, points, privileges, and so on).

“Reward Hunters” may be anyone or any entity that learns about, shares, or responds to a reward on the incentive system 150. It includes any contacts through the Nth degree in a chain for distributing the reward posting to others or associated with Reward Creators, first-time submitters, returning patrons, and so on.

“Agents” may be people or any entity that forward the reward to other people in hopes that one of those people can achieve the reward. The agent may also be compensated (financial or non-financial) either separately or from a portion of the won reward.

“Solution opportunity”, “opportunity”, or “solution”, which may be used interchangeably, describe any lead, solution, opportunity, suggestion, or the like that may fulfill or achieve (or has the potential to fulfill or achieve) a goal or need described in a reward or bounty. A solution opportunity may be submitted in response to a reward posting by a Reward Hunter, which can be a person or business.

The incentive system 150 allows users (who may also be a company, organization, or any other entity, collectively referred to as “Reward Creators”) to post a reward with some incentive for people to help the user fulfill a goal or need and disseminate the reward posting to various online communication platforms (e.g., social networks). This incentive allows for anyone who comes across the incentive posting, for example, people in a user's social network, to be rewarded for helping the user achieve the goal or fulfill the need. In some embodiments, the incentive may also provide for rewarding those people to share the goal or need with other people who could help.

This incentive system 150 provides a solution to the laborious effort one must undertake to manually post a goal or need in one's social network(s) or on classified advertisement sites, such as Craig's List or other posting options.

Through the incentive system 150, Reward Creators may create, manage, and track a bounty or reward to motivate contacts in their social networks or other online communication platforms to help the Reward Creator fulfill a goal or need. Social networks and online communication platforms include, but are not limited to, any website, mobile application, email, SMS, and so on, where information about a user may be distributed, accessed, and/or displayed, such as user profiles, contact information, status updates, newsfeeds, messages, comments, tweets, and so on. Information may be in any form of media, such as text, video, audio, and any combination thereof.

Reward Creators may use the incentive system to choose social networks and communication platforms through which the Reward Creator may share the Reward Creator's goal or need. Reward Creators may share their bounty through multiple social networks and communication platforms. Some of these networks and/or platforms include, but are not limited to: Facebook social network, MySpace social network, Twitter social network, Google Buzz social network, LinkedIn, Google+, Email, SMS, IM, and so on. Other examples of online communication platforms include Monster.com, iPhone apps, Foursquare, Gowalla, and the like.

Reward Creators may use the incentive system 150 to log into or authenticate these social network/communication platforms through which the Reward Creator can share the Reward Creator's goal or need. In some embodiments, a user may access and manage the posting of rewards on one or more social network/communication platforms via the incentive system 150, e.g., while logged in. In other embodiments, various features and services of the incentive system 150 may be accessed while a user is logged into a third party social network/communication platform. Reward Creator will likely publish the goal or need content through multiple social networks or communication platforms.

The incentive system 150 may publish various information about the bounty such as the goal or need category, goal or need description, bounty/reward, image, link to goal or need page, and the like on the selected social networks or communication platforms. The published or posted information may be in any form, shorthand or detailed, such as a headline, snippet, newsfeed, one or more words, an icon, an image, a button, and so on. The incentive system 150 may also associate a unique URL for the goal or need page each time it is shared. For example, the bounty or bounty content (e.g., goal or need content):
may be published in the social network (Facebook, MySpace and others) newsfeeds that are displayed to friends of Reward Creator.
may be published in the social network (Facebook, MySpace and others) public pages that are displayed to friends of Reward Creator.
can be published in the social network (Facebook, and others) marketplace that is displayed to all users.
may be published through the communication platforms that would distribute messages about the Reward Creators goal or need to the contacts of the Reward Creator.
may be published through email platforms that would distribute messages about the Reward Creators goal or need to the contacts of the Reward Creator.
can presented to other individuals through electronic advertisements.
may presented to other individuals through Search engine results by submitting the content in a feed to the search engines.
can be sent to specific social network contacts.

The unique URL may be associated with information about the bounty as it is distributed over the various communication platforms (social networks, email, mobile applications, and so on). For example, the unique URL link may indicate who created the reward and also who shared the reward with others (e.g., agents). The unique URL link may be a hyperlink, a button, a clickable icon, a clickable image, or the like.

The incentive system 150 may additionally include other links in the posting or publication of a reward so that viewers may, for example, indicate they like the reward posting, publish comments about the posting, or conveniently share the reward posting with other viewers or other websites.

The incentive system 150 may also publish the Reward Creator's goal or need in a marketplace 120, as will be described further below, so that independent agents and people or business interested in winning a reward can search and view these bounties.

The incentive system 150, also provide for incentives that give contacts of the Reward Creator the potential to earn part of a bounty or reward incentive if they share the Reward Creator's goal or need with other contacts in their own respective networks or other communication platforms and one of those contacts wins the reward. Thus, the contacts of the Reward Creator's contacts can be motivated by a bounty or reward to help the Reward Creator meet the goal or need. Additionally, these other contacts can also share (and potentially earn part of the bounty or reward incentive) the Reward Creator's goal or need with additional contacts in their networks or other communication platforms to broadcast a larger net of people who may partake in fulfilling the Reward Creator's need. Thus, the incentive system 150 allows for incentivizing the connectors along a chain that connects the Reward Creator to the eventual person who wins the reward by fulfilling the posted need.

It will be appreciated that anyone who learns about, shares, or responds to a reward can be a “Reward Hunter”, and includes any contact through the Nth degree of association with a Reward Creator, first-time submitters, returning patrons, and so on.

A goal or need may be any goods or services. Some examples of goals or needs include, but are not limited to, seeking a job, buying a house, purchasing a product such as a car, seeking unique or rare items, getting a customer referral, and so on.

Individuals and businesses are limited in their ability to seek solutions, post requests, or post advertisements about goals or needs using traditional methods. The process of posting such request could be a massive undertaking since one has to know where to post and then monitor and track the posting at the various sites. Furthermore, the payment for the classified posting or advertisement is not tied to an actual result. The payment is made regardless of whether the classified posting or advertisement was resolved or whether it attracted any individuals responding to the posting. Some methods may be free, such as free classified ads on certain websites, but none of these methods include functionality where the user may submit an incentivized posting and one that can be broadcast through the Reward Creator's network (connections) and beyond. The details of this and other features are discussed in further detail below.

The described system(s) and method(s) provide a means, such as incentive system 150, for people to use bounties, rewards or other incentives through online networks and other communication platforms, so that they can broadcast to people in their network to help them fulfill their needs. Those who assist are compensated by some reward or partial reward. This peer to peer networking platform provides an opportunity for people, businesses, organizations, or the like (“Reward Creators” as previously noted) to more easily get what they are seeking from other individuals by using an incentive. The incentive is shared by contacts through social networks or other communication platforms (email, SMS, IM, mobile applications such as mobile phone applications, and so on) to motivate other individuals to help the Reward Creator attain the desired goal or need. The system also facilitates cross network personal commerce, so that the influence of the incentive is not constrained to any single network or communication platform. Reward Creators may utilize incentives and reward others within their network connections and/or outside their network connections to help the Reward Creator achieve the goal or need. Incentives may be any type of incentive, reward, for example, it may hold monetary value, in the form of cash value or gift cards. It may also be non-financially based, such as special privileges, points, credits, community status, or some type of virtual currency, as will be described in further detail in later sections.

The incentive system 150 also allow for mechanisms to motivate people who may not know the Reward Creator but are connected by a contact(s) in the Reward Creator's network chain, where without the reward platform provided by incentive system 150, those people would not have participated.

The incentive system 150 is configured to provide services or a platform to help Reward Creators use the reach of the Internet to communicate a goal or need and to offer a reward or bounty to contacts across network connections, such as the Reward Creator's social networks, or other communication platforms, and to motivate those contacts to provide the solution to the goal or need. The incentive system 150 also makes it possible to incentivize those contacts to act as agents by sharing the Reward Creator's goal or need with their contacts to help the Reward Creator with the Reward Creator's goal or need.

Additionally, the incentive system 150 makes it possible for the Reward Creator to provide an incentive to the Reward Creator's contacts' contacts to motivate them to help the Reward Creator with the Reward Creator's goal or need. Thus, the Reward Creators contacts may be contacts within the first degree, the contacts of the Reward Creators contacts may be regarded as contacts within the second degree, and so on, such that the posting of the need and the incentive may be reached by contacts of the Nth degree.

For example, assume the user at client device 101 is an individual (a Reward Creator) looking for something. The Reward Creator may be looking for anything, say a job, rental space, a rare or unique item, a house, a part in an antique car, and so on. Through the incentive system 150, the Reward Creator can post a “reward” incentive for motivating others to help attain the Reward Creator's item or service.

The client device 101 may be any one of a number of devices (e.g., a computer, an Internet kiosk, a personal digital assistant, a cell phone, a gaming device, a desktop computer, a tablet, or a laptop computer) that allows the Reward Creator access to social networks 112 and other network communication platforms over the network 102. The client device 101 may include client applications 123 and other software that permit a user at the client device 101 to interact with the network resources via network 102 and perform one or more tasks, such as engaging in the incentive system 150. For example, the client device 101 may allow a user to access a user interface 103, such as a web browser, window, viewer, or any other type of application (e.g., a search engine application) that permits the user to view content and/or participate in the incentive system 150. Client applications 123 includes any application that may be accessed via the client device 101, such as, but not limited to, mobile applications (e.g., iPhone applications) if client device 101 is a mobile device. In some embodiments, the user interface 103 and the client application 123 may be the same or combined. The user interface 103 and other applications 123 on client device 101, may also track the Reward Creator's activities while engaged with the incentive system 150. Tracking information, client applications 123, and any other data on the client device 101 may be stored on memory (not shown) at the client device 101 or may be accessed remotely from an external site via network 102.

The Reward Creator uses the client device 101, such as a computer or mobile device, to connect to the network 102 and access the incentive system 150. The network 102 can be any wired or wireless local area network (LAN), metropolitan area network, and/or wide area network (WAN), such as an intranet, an extranet, or the Internet, or it may be a combination of such networks. The network 102, for example, may be the Internet and through the Internet the Reward Creator connects to the incentive system 150.

On the client device 101, the Reward Creator may access the system via user interface 103 to connect to the incentive system 150 (host site). The user interface 103 may be a web-based application that is accessed via the Internet using a computer or mobile device, such as client device 101. In some embodiments, the user interface 103 may be used to access a native application, such as client application 123 that resides on or is downloaded to the computer or mobile device, such as client device 101.

The incentive system 150 provides a channel for people, who may or may not be directly connected to the Reward Creator, or are connected (directly or indirectly) through the Reward Creator's social or personal network. These people are provided the opportunity by the incentive system 150 to earn rewards, by helping the Reward Creators meet their goals or fulfill needs. Additionally, these people may also act as agents of the Reward Creators by sharing Reward Creators' goals or needs with their own network of contacts. By acting as the Reward Creators' agents, even more people may be exposed beyond the Reward Creators' own contacts, thus increasing the likelihood that someone could help, thereby improving the rate of success in fulfilling the need(s) of the Reward Creators.

The incentive system 150 includes several modules or applications and tools that allow a Reward Creator to set up, monitor, and administer a posting of a reward and requested goods or services. The incentive system 150 may also monitor the Reward Creator's activities and store data about the Reward Creator, the Reward Creator's activities, responses to the reward, the Reward Creator's network(s), and so on. The stored data may be used, for example, for enhancing future services, collect statistical data on Reward Creators, and collect other analytics to improve the Reward Creator experience and/or update accounts.

Data may be stored on memory or database, collectively “database 107”, which may be an integral part of the incentive system 150, or which may be accessed remotely. In some embodiments, database 107 may additionally be managed or provided by a third party service provider.

The incentive system 150 includes a bounty or reward system 104, which functions to automatically help the Reward Creator choose an appropriate incentive for a bounty or reward to offer based on the Reward Creator's goal or need or other relevant criteria. The bounty or reward system 104 may recommend a type of reward incentive (e.g., monetary, points, virtual currency, or any other option that defines some value or incentive) and a reward amount. In some embodiments, a user may manually select, indicate a preference, or be prompted to select a reward incentive type and/or amount which the bounty or reward system 104 may consider in determining the type and reward amount.

In some embodiments, the type and amount of the reward may be determined based on one or more criteria from a plurality of factors. The plurality of factors may be any factor relevant to the Reward Creator or for the Reward Creator to be successful. For example, the bounties or rewards of the Reward Creator's history, user profile, or preferences may be considered. In some embodiments, the history, profile, and preferences of other Reward Creators may also be considered. This is because the bounty or reward system 104 monitors the types and amounts of bounties that have been successful for other Reward Creators.

Other factors may include the location of the Reward Creator (to help them select the right type of bounty/reward and the right amount and also to help them decide if they want to target local, regional or national contacts and Reward Hunters), the type of goal or need they are seeking to fulfill, and how quickly the Reward Creator needs the goal or need fulfilled.

The bounty or reward system 104 may compare the Reward Creator's goal or need to goals and needs from other Reward Creators. Appropriate bounties or rewards may be suggested based on what other Reward Creators have offered as bounties or rewards. Reward Creators may select from these suggestions, enter a custom bounty or reward, or do a combination of both.

In helping the Reward Creator select a bounty or reward, the bounty or reward system 104 may utilize one or more of these factors to calculate an appropriate bounty or reward to suggest to the Reward Creator. In this manner, the bounty or reward system 104 may facilitate, particularly new Reward Creators, to offer appropriate rewards as incentives for improving the likelihood of a successful outcome.

In some embodiments, the bounty or reward system 104 may display or provide to a Reward Creator historical or background information, such as what rewards have been offered by people who the Reward Creator knows or is affiliated in some manner with the Reward Creator or the object of desire. For example, the bounty or reward system 104 may display the bounties or rewards from contacts that are connected to Reward Creator through the social networks where they are members, so that the Reward Creator can compare their goal and bounty or reward with the goals and bounties and rewards of their contacts or friends. When appropriate bounties or rewards are suggested to the Reward Creator, the Reward Creator can either choose one of the bounties or rewards that are suggested or create a different bounty or reward to offer.

In some embodiments, the products and services of the incentive system 150 may be integrated with a social network or communication platform. For example, the bounty and reward system 104 could be integrated directly into a social network, such a Facebook or Twitter, or any communication platform that has access to social, personal, or business contacts. This integration may either be completely integrated into the social network or be an embedded or framed integration with the social network, like Facebook applications. This may allow the user to never leave the social network or social communication platform to create a bounty or reward. Also, the bounty and reward system 104 could guide the Reward Creator from within the social network or social communication platform to select or create the best bounty or reward for that specific goal or need.

The incentive system 150 includes user Data 105. Through, for example the user Interface 103, the user Data System 105 collects user information from the Reward Creator and helps the Reward Creator (or the bounty or reward system 104) choose a category or create their own category for what they are seeking. The user Data System 105 also makes it easy to add more details to describe what the Reward Creators are seeking. The user Data System 105 helps the Reward Creator enter or upload content such as background information about the Reward Creator, information about the desired goods or services, information about the reward, a resume in the case of a job-seeking request, status updates, a photograph, and so on, any information that helps the Reward Creator illustrate what the Reward Creator is seeking.

Additionally, the user Data System 105 may suggest a category or other suggestions, such as geographic location meta data, that would be beneficial for the Reward Creator to support the Reward Creator's goal or need request. In some embodiments, the user Data System 105 may work in conjunction with the bounty or reward system 104 to provide suggestions or recommendations to help Reward Creators create effective rewards. For example, the bounty or reward system 104 may utilize past user data or the collected data of other Reward Creators, e.g., in the same category, accessible via the user Data System 105 to generate or suggest rewards for the Reward Creator. In some embodiments, the user Data System 105 and bounty or reward system 104 may be a single server or unit that provides the functionality of both.

User data may be collected on anyone or any entity accessing the incentive system 150, and includes information on Reward Hunters, business subscribers, Reward Creators, agents, and so on. For example, information stored on Reward Hunters may include which rewards were viewed, which rewards they tried to win, and which rewards were successfully won. The system 150 may then use that data to choose which rewards will proactively be shown to that Reward Hunter in the future.

As with the bounty and reward system 104, the user Data System 105 can be integrated directly into a social network or any communication platform having access to social, personal, or business contacts. This integration could either be completely integrated into the social network or be an embedded or framed integration with the social network (like Facebook applications). This may allow the user to never leave the social network or communication platform and for the data to be sourced directly into/from the social network or social communication platform. Also, through the integration, the social network or communication platform could supply additional content that can be used to help illustrate what the Reward Creator is seeking.

The payment system 106 provides the Reward Creator different ways to pay for a bounty or reward. Payments include, but are not limited to currency (e.g. dollars), virtual currency, a gift card, an item or service points, and so on. The payment system 106 also helps the Reward Creator increase the bounty or reward by having the Reward Creator pay additional funds directly or to complete advertiser or merchant offers, so additional funds (or amounts of non-financial payments) will be added to the bounty or reward. Payment can be made in any form that expresses value to one responding to the Reward Creator's request. For example, for different scenarios several different options are provided for Reward Creators to be able to pay for the bounty or reward they are offering. In some situations, the Reward Creator may be allowed to make a promise to pay the bounty or reward when an individual helps them fulfill their goal or need. In other situations the Reward Creators, or an interested third party, may be required to pay the bounty or reward upfront prior to the time they use incentive system 150 to distribute their respective goals or needs to their contacts.

The interested third party may be other people/organization who fund or sponsor an individual's reward for that individual receiving a good or service. In some embodiments, the interested 3^{rd} party may fund or sponsor the reward on behalf of the Reward Creator. In some embodiments, the interested third party may modify or supplement the reward. For example, if the individual/Reward Creator lost a pet, e.g., a dog and created a reward that is shared over Facebook, twitter, email, and the like, some of the Reward Creator's friends or possibly someone that does not even know the Reward Creator may decide to add to the reward. This would increase the overall size of the reward.

In some embodiments, a third party may offer to pay for a matching reward. For example, if a Reward Creator offers an amount as a reward for a ride from San Francisco to Los Angeles, and this reward is posted through social networks, email, and the like, a friend who sees the posting may decide that he also wants a ride to Los Angeles. The friend, who is a third party, may match the Reward Creator's reward by offering a similar amount. Now someone can win both rewards by giving both of the Reward Creator and the friend a ride to Los Angeles.

In yet another example, a company may offer to match or increase a reward offered by the Reward Creator, who is an employee of the company. The third party may not know the Reward Creator or many not have come across the reward posting via channels of the Reward Creator.

The incentive system 150 may provide for ways to indicate to users of the bounty or reward if all, none, or part of a bounty is currently funded. It will be appreciated that the users of the incentive system 150 may be Reward Creators, reward seekers, hunters (collectively “Reward Hunters”, or both. Users may also be people who are either agents or those trying to win the reward. The incentive system 150 can display (e.g., on the goal page 110, in the marketplace 120 or search results displayed via user interface 103) whether the reward has been funded, partially funded or there is a promise to pay.

The Reward Creator is given many ways to pay for their bounty or reward as shown in the following examples:

(1) Cash equivalent payments—These payments can be made by credit card, PayPal, Amazon payments, electronic check, phone carrier charges like Boku, and so on.

(2) Offer payments—Reward Creators can earn money that will be applied toward their bounty or reward by fulfilling advertiser or merchant offers. These offers may require the Reward Creator to fulfill the advertiser or merchants requirements and then the advertiser or merchant will provide the payment system 106 with funds to be applied to the Reward Creator's bounty or reward.

(2) Credit or partial credit from merchants—When the Reward Creator completes an offer from an advertiser or merchant then the advertiser or merchant will notify the system 150 that the offer has been completed. Either before or after the payment system 106 receives the funds from the advertiser or merchant, the system 106 will then apply all or part of the funds toward the Reward Creator's bounty or reward, so that the total amount will be increased. These offers can be sourced by integrating with a partner like Sometrics or Offerpal to source these offers. The system 150 may also source these offers directly from the merchants or advertisers through direct integration with the merchants and advertisers themselves.

(3) Gift Cards—Reward Creators may set up a gift card fund as a reward payment instead of some monetary value.

(4) Future or Frequency Credit, Privilege Points—Reward Creators or even the inventive system 150 may provide an incentivized reward program where users may earn privilege credits a variety of successes within the incentive system 150. For example, getting a certain amount of credits might allow Reward Hunters to user credits as the payment amount for rewards they are offering. A privilege might be getting the opportunity to try to win restricted or special rewards. Or maybe a privilege would be to get to see new rewards being offered before they are shown to the public.

(5) The incentive system 150 may also allow the Reward Creator to defer paying until later.

(6) Payment can be made by fulfilling advertiser offers. For example, when the Reward Creator completes the offer, then the advertiser or merchant (or the offer platform partner) will provide our system with funds to be applied to the Seeker's bounty or reward. An example of completing an offer might be taking a survey from a research company or completing a task presented by an advertiser.

Payment of the reward can be made in any number of ways. Payment can be made with cash equivalent payments, Credit Card, PayPal, Electronic Check, Phone Bill Payment (e.g. Boku), and so on.

If the Reward Creator is required to pay up front, the funds for the bounty or reward may be held in escrow or applied to the bounty or reward (for example: a gift card). The escrow account may be managed by the incentive system 150 or management may be outsourced.

The Reward Creator may also be allowed to increase the bounty or reward by having the Reward Creator pay more funds directly or to complete more advertiser or merchant offers, so additional funds will be added to the bounty or reward.

As with the other components of the incentive system 150, the payment system 106 can be integrated directly into a social network or communication platform for accessing social, personal, and business contacts. This integration could either be completely integrated into the social network or be an embedded or framed integration with the social network (like Facebook applications). This integration could provide additional functionality such as to allow the Reward Creator to automatically pay the bounty or reward using the funds that might already be in an account with the social network or social communication platform. Such integration may also allow the Reward Creator to offer special features or functionality from the social network (such as credit for games) as a reward or bounty.

The incentive system 150 also includes a relational database 107, which is structured so that different data can be tracked back to a specific user. Additionally, data can be tracked back from its origin and the relationships with other users who were involved with a user. This is useful when the bounty or reward is shared and the system needs to determine the amount that a specific individual is eligible to collect for helping the Reward Creator fulfill the Reward Creator's goal or need, so that the correct amount will be shown on the Reward Creator's goal or need page 110 when that individual visits it. The incentive system 150 also has the ability to determine (or display on the Reward Creator's goal page 110 whether a reward is fully funded, partially funded, or if there is a promise to pay the reward if it is won.

The incentive system 150 also includes an Opportunity/Lead Processor 109, which allow individuals to send solution opportunities to the Reward Creator. The Reward Creator may determine from the solution opportunity submissions which solution opportunity wins the reward (e.g., because it satisfies the desired goods or service). In some embodiments, the opportunity/lead processor 109 may control the number of solution opportunity submissions in any number of ways, such as limiting the submissions or varying the limits among Reward Hunters. For example, the Opportunity Processor 109 may allow Reward Hunters to send a limited number of submissions. When a Reward Hunter makes a good submission, the Reward Hunter may acquire new or additional privileges to, for example, be permitted to submit to more rewards in the future. The quality of the submission(s) may be rated by the Reward Creator, by incentive system 150 based on the background or activities of the Reward Hunter, or by a combination of both feedback from the Reward Creator and data from the incentive system 150.

The Opportunity/Lead Processor 109 manages the solution opportunities sent to the Reward Creator. The Reward Creator can either accept or reject the solution opportunity. If the Reward Creator accepts the lead, the Reward Creator may designate a status for that lead. Some example status selections can be “pending verification”, “in process”, or “successful”.

If the goal or need involves selling an item(s) or service(s) then the system may use a conversion page such as conversion page 122. A contact has the ability to reduce the price of the item(s) or service(s) up to the amount of the bounty or reward when sharing with the Reward Creator's contacts. The contact may share the Reward Creator's goal or need to sell the item(s) or services(s) along with the unique URL of the conversion page 122. If an individual wants to purchase the item(s) or service(s) that the Reward Creator has as a goal or need to sell then the system helps with the conversion. In some cases the service may also handle the payment transaction.

The reward or bounty payment may be triggered when, for example:
Reward Creator changes status to success
Reward Creator triggers the bounty/reward fulfillment System to send the bounty or reward payment to a specific contact
Reward Creator triggers the bounty/reward fulfillment System to send a split bounty or reward payment to more than one contact
Agent triggers the bounty/reward fulfillment System by sending a request to be compensated

The Reward Creator may then either confirm or reject the request as an additional step. The individual who provided a solution opportunity may trigger the bounty/reward fulfillment System 118 by sending a request to be compensated. Additionally, the Reward Creator may also be required either confirm or reject the request.

The Reward Creator may use the Opportunity/Lead Processor 109 to accept or reject the solution opportunity. Data from the process of accepting or rejecting a submission to a specific reward may be utilized to add value to either or both the Reward Creator and the Reward Hunter trying to win the reward for the purposes of computing privileges or statuses within the incentive system 150. For example, even when a submission is rejected, the Reward Creator may still have the capability to rate the submission. This provides feedback to the incentive system 150 about the Reward Hunter. Such data may be stored and tracked to cumulatively grade the Reward Hunter, which may be used to determine one or more privileges or change in status (which may or may not be publicly shown to others). Also, when the Reward Creator rejects a submission, the Reward Creator still provides a rating for the submission. These rating may determine if the Reward Creator and/or Reward Hunter gets more privileges in the future. For example, the ratings may affect the quality of the Reward Hunter's submissions and/or the frequency of activity of the Reward Creator in the incentive system 150. Additionally the Reward Hunter may also be able to rate the Reward Creator based on the responses or lack of a response to a submission or even a question.

In some embodiments, Reward Creators may be rated based on any number of factors, such as how quickly they respond to submissions or questions. They may also be rated based on how quickly they select a solution opportunity or pay a reward winner. Based on the Reward Creator's performance in these such areas may determine the visibility of the current or future rewards they are permitted to offer. Or, goal pages may be ranked based on these ratings or partially based on these ratings, which may affect the appearance of the goal pages on websites (e.g., on a marketplace, search result, and so on) or how responsive the incentive system 150 is to certain Reward Creators. For example if Reward Creators are not responding to submissions then their rewards may fall to less visible areas (toward the bottom) of the marketplace 120.

In some embodiments, if the Reward Creator does not rate or respond to a submission that inaction could impact both their current reward they are offering and other future rewards they may offer. For example, if a Reward Creator does not respond to a submission, the nonaction may show on their reward page that they are being unresponsive or their reward may, for example, become less visible in the Marketplace 120.

The Opportunity/Lead Processor 109 may also be used to trigger payments to agent(s) and contact(s), which are further described in later sections. The Opportunity/Lead Processor 109 helps Reward Hunters submit solution opportunities and also manages the triggering of the bounty or reward payments.

When a Reward Hunter wants to submit a solution opportunity to a Reward Creator, the Reward Hunter may click on a button, for example a “send an opportunity” button or “win this reward” button of the Reward Creator goal or need page 110. This launches the Opportunity/Lead Processor 109. The Opportunity/Lead Processor 109 may then send solution opportunities to the Reward Creator by sending a description of the solution opportunity and then submitting it through the Opportunity/Lead Processor 109. The Opportunity/Lead Processor 109 may also sends a notification (email, SMS or other communication platform) to the Reward Creator and display the details on the Reward Creator's dashboard 111. The Reward Creator may access the details of the solution opportunity by viewing the dashboard 111. The incentive system 150 may present a messaging interface so the individual can send an opportunity to the Reward Creator via the Opportunity/Lead Processor 109. When the individual sends a solution opportunity to the Reward Creator, the incentive system 150 requests the individuals contact information (email address, SMS, social network contact info, etc.), to be used for payment of the reward to the individual. The Opportunity/Lead Processor 109 additionally sends a message to the individual thanking the individual for submitting a solution opportunity to the Reward Creator. When the individual receives a message, the message may include instructions and a link for making a future request to collect the bounty or reward being offered by the Reward Creator.

The dashboard 111 may be used by Reward Creators, agents and Reward Hunters who submitted solution opportunities to check status and progress. Reward Creators may access dashboard 111 to check information such as social networks the Reward Creator used to share a goal or need, number of contacts who have viewed goal or need, number of solutions received, number of contacts who have shared a goal or need, and so on. Contacts who have acted as agents may access dashboard 111 to check data such as social networks the contact used to share a goal or need, number of the contact's contacts who have viewed goal or need, number of contact's contacts who have provided potential solutions, number of contact's contacts who have shared a goal or need, and so on. For Reward Hunters who have submitted solution opportunities they may access the dashboard for data such as number of solutions submitted, status of solutions submitted, and so on. Reward Hunters will also be able to use the dashboard to submit their preferences for the types of rewards that they would like to be notified about so they can have an opportunity to win them.

In some embodiments, the dashboard 111 may also be integrated into a mobile application on a mobile device or with a social network account of the Reward Creator. The dashboard 111 may additionally allow the Reward Creator to see the details of the solution opportunity submission in an email, SMS or other text messaging, mobile application, or social network account. The incentive system 150 may also allow the Reward Creator to rate and respond to the solution opportunity submission directly in the email, SMS or other text messaging, mobile application, social network interface, and so on.

The Reward Creator can either accept or reject the lead, solution opportunity. If the Reward Creator accepts the lead, solution opportunity then the Reward Creator will be able to designate a status for that lead. Some example status selections can be:
Pending verification
In process
Successful
Not successful, but good submission
Not successful and bad submission
Other status which can be added or customized, and so on.

In some embodiments, the Reward Hunter receiving a status of “Not successful, but good submission” could earn points that would give that Reward Hunter more privileges, as previously described.

The incentive system 150 additionally includes several interface tools. A distributor engine 108 provides a very simple interface to help Reward Creators distribute (“share”) their bounty or reward along with their request for help for what they are seeking to their contacts through social networks and other online communication platforms. The distributor engine 108 may also be used to help contacts who are acting as agents to distribute (“share”) the Reward Creator's goal or need to their respective contacts. Thus, the distributor engine 108 helps Reward Creators easily distribute their goal or need and associated reward to their contacts and also to the contacts of their contacts.

The distributor engine 108 may post the reward on the social network page(s) or other communication platforms of the Reward Creator. The distributor engine 108 may include content such as photos and graphics when the social network or communication platform allow for that content to be included in the posting. The distributor engine 108 may also include a unique URL for the Reward Creator's goal or need 110 page in those posts.

In some embodiments, the distributor engine 108 may additionally allow the Reward Creator to select specific contacts, groups of contacts (e.g., contacts in a specific physical area or a specific group of contacts based on one or more attributes), or to all the Reward Creator's available contacts to notify about a reward and need. In other embodiments, the distributor engine 108 may automate the process of selecting a group of contacts to notify based on information about the reward, the Reward Creator, Reward Hunters/contacts, or any combination of data that the incentive system 150 has access to or tracks.

The distributor engine 108 may provide the Reward Creators' bounty content along with other content from the Reward Creator to location based service providers like FourSquare, Gowalla, Facebook Places, and so on. This allows location-based service providers to post rewards or bounties that are relevant to a local area. For some rewards or bounties, users who “check in” to a location-based platform and view these rewards or bounties may have the best resources to satisfy the goal or need or locally share the rewards or bounties with contacts who can fulfill the local request. Users who visit these local platforms may be the best contacts to satisfy the bounty and win the reward.

The distributor engine 108 automatically distributes the reward and the description of the Reward Creator's goal or need along with the unique URL for the Reward Creator's goal or need page 110 across those social networks and other online communication platforms to the Reward Creator's contacts, such that the Reward Creator's contacts are notified about the Reward Creator's bounty or reward and goal or need. In some embodiments, the unique URL will be exposed to the Reward Creator's contacts. The unique URL may be visible as a web address in the post. In some embodiments, the reward, the description of the Reward Creator's goal or need and possibly other content (e.g., photo, graphics, video, etc.) from the Reward Creator will be clickable, so that when clicked the contact will be directed via the unique URL to the Reward Creator's goal or need page 110. In some embodiments, the posting of the bounty or reward and the description of the Reward Creator's goal or need may be a unique clickable link that may be the unique URL or associated with the unique URL, such as a hyperlink or an icon, that when clicked the contact will be directed via an associated unique URL to the Reward Creator's goal or need page 110. The unique link can be configured to be clickable across multiple social networks or other communication platforms (e.g., mobile applications, email, and so on).

In some embodiments, if the communication platforms allow it, the distributor engine 108 may include content such as photos and graphics along with the bounty or reward and goal or need when distributing to the Reward Creator's contacts.

With the integration of other online communication platforms, the incentive system 150 may also allow for instant reward submissions when recipients respond to the reward, e.g. by clicking a reply hyperlink or replying to the email, SMS, mobile app, and so on. This allows the incentive system 150 to quickly response to the reward and forward or process a submission to the reward or forwarding request to other people who can help. This may be achieved without having to leaving the application, email or social network the respondents are using. The incentive system 150 may automatically update reward information across all platforms, e.g., in real-time, so that the Reward Creator's goal page 110 and postings on any other platform may contain the most updated information.

The distributor engine 108 may also post the Reward Creator's reward or bounty in a Marketplace 120 of the incentive system 150, which is described in detail in later sections. The Marketplace 120 allow individuals who are not connected to any Reward Creator to find current reward or bounties and also forward the bounty or reward to others. Individuals can earn rewards by helping Reward Creators fulfill their bounty posted in the Marketplace 120. These visitors to the marketplace 120 may also act as agents and share the rewards or bounties with their contacts. Any user may create an account with the incentive system 150 and access the Marketplace 120. Thus, an individual does not need to have any connection to the Reward Creator in order to either win the reward or to act as an agent by sharing the reward.

Additionally, the distributor engine 108 may feed the bounty to partner marketplaces within other communication networks, such that individuals who are browsing those other marketplaces will be able to browse the bounties of the Reward Creators' of the incentive system 150. For example, these other market places may have access to view any Reward Creator's goal page 110. Examples of these other marketplaces include, but are not limited to, marketplaces on Facebook, Amazon.com, eBay, Monster.com, CareerBuilder.com, LinkedIn, Google Base, Google+, Craigslist, or any other marketplace on the web.

In some embodiments, the distributor engine 108 may also supply the Reward Creators' reward or bounty along with other content about the Reward Creator or the reward or bounty in data feeds to search engines to increase the visibility of the reward or bounty or the Reward Creator's goal page 110. For example, search engine 121 may use various parts of the data feed in their search engine results and the incentive system 150 may work with the search engine 121 to maximize the visibility of our Reward Creators' bounty or reward to the users of the search engine 121. Search engine 121 may also be utilized to obtain data from the search engine 121 as to how the users of the search engines 121 are viewing and interacting with the Reward Creator's bounty or reward or other content of the incentive system 150, for example, in the search engines results and listings.

The distributor engine 108 is also used to help contacts become agents who distribute or share the Reward Creator's goal or need with their own contacts through their own social networks and other communication platforms. The distributor engine 108 also allow these agent-contacts to select the specific contacts, groups of contacts (like contacts in a specific physical area or a specific group of friends) or send to all the contact's contacts on the social networks and communication platforms. The distributor engine 108 then corresponds with the bounty/reward split System 114 (the contact could adjust this) to share the amount of bounty or reward.

There are many ways that either the Reward Creator or the Reward Creator's contacts could have the bounty/reward split System 114 allocate the bounty or reward. The splitting of the reward may be automated by the bounty/reward split System 114. However, Reward Creator may decide the splitting of the bounty or reward or the splitting may be determined by a combination of manual input from the Reward Creator and automated processes of the incentive system 150.

In one scenario, the Reward Creator may select to have the bounty/reward split System 114 split the potential bounty between the Reward Creator's contact, who is acting as an agent and the contact's contacts based on a percentage allocation determined by the Reward Creator.

In another scenario, the Reward Creator may select to have the bounty/reward split System 114 split the potential bounty between the Reward Creator's contact who is acting as an agent and the contact's contacts based on a numeric dollar amount allocation determined by the Reward Creator.

In another scenario, the Reward Creator may select to have the bounty/reward split System 114 allocate the entire bounty or reward to a charity.

Additionally, contacts acting as an agent may decide the splitting of the bounty or reward. In yet another scenario, the contact acting as an agent may select to have the bounty/reward split System 114 allocate the entire bounty or reward to the contact's contact.

In yet another scenario, the contact acting as an agent may use the bounty/reward split System 114 to adjust the potential bounty between the contact and the contact's contacts.

In yet another scenario, the contact acting as an agent may select to have the bounty/reward split System 114 allocate the entire bounty or reward to the contact and then the contact may still share the Reward Creator's goal or need with the Reward Creator's contacts with no remaining bounty or reward available to those contacts.

The bounty/reward split System 114 may show the correct potential bounty for each individual on the Reward Creator goal or need page that each individual sees.

If a Reward Creator changes the bounty or reward, then the incentive system 150 may help the Reward Creator redistribute the updated bounty or reward to the Reward Creator's contacts. When a Reward Creator adjusts the Reward Creator's bounty or reward, the incentive system 150 adjusts the reward or bounty being offered on the Reward Creator's goal or need pages based on the bounty or reward split adjustment that has been made in the past. Also, the bounty and reward Distributor 108 is enabled to send out updated posts with the updated bounty or reward to all of the Reward Creator's contacts and to any of the contacts' contacts who received the previous bounty or reward and job goal or need from the Reward Creator.

The functionality of the distributor engine 108 and bounty/reward splitter 114 includes the functionality of helping agents and facilitators share the reward with their contact and also compensate them when one of those agent-contacts solves or satisfies the reward or bounty. The distributor engine 108 may automatically distribute the description of bounties and rewards along with any associated unique URL to the Goal page 110 across those social networks and other communication platforms of the agent-contacts. Thus the contact's contacts can view the Reward Creator's bounties or rewards and/or updates to the bounties or reward, such as if the incentive amount is adjusted. In another embodiment, the distributor engine 108 can be integrated directly into a social network or a communication platform.

This integration could either be completely integrated into the social network or be an embedded or framed integration with a social network (like Facebook applications or mobile applications for portable handheld devices). This may allow the Reward Creator to distribute easily the Reward Creator's bounty or reward to the Reward Creator's contacts within the social network without having to ever leave the social network or to access the bounty or reward anywhere and by any device. Additionally, integrating directly into the social network or communication platform or gaining access via any device including portable handheld devices may optimize the placements of the Reward Creator's bounty posting. It would also facilitate the inclusion of the Reward Creator's bounty into the newsfeed or other communication opportunities within the social network or communication platform on any device. Additionally, the integration could facilitate incorporating some of the Reward Creator's goal or need page 110 functionality directly into the Reward Creator's bounty posting itself. This may facilitate incorporating the Reward Creator's bounty “Share” button directly into the posting itself (rather than on the goal or need page 110), so individuals who view the posting could immediately share the Reward Creator's bounty with their contacts. Similarly in this iteration, with the social network, other communication platform, or from mobile applications, the posting could have buttons that will allow someone to immediately endorse or contact the Reward Creator with an opportunity. Also, in this embodiment when an individual views the Reward Creator's posting on a social network page, the social network could provide the user ID or some other data that would identify the individual from the social network, so the incentive system 150 could track whether the individual in turn shared the Reward Creators' bounties or rewards directly from the posting.

In another scenario, the button or link to share and distribute the Reward Creator's bounty with other individuals is incorporated into the web pages hosted by the communication platform or social network. The System communicates the bounty amount with the communication platform or social network, so that the social networks and communication platforms can automatically facilitate the sharing and distributing by integrating functionality that works with the system. This functionality makes it easier and automatic for a user to share the goal or need of the Reward Creator with other individuals across the various network or communication platforms (this could also include sharing and distributing across multiple networks). In this scenario, the incentive system 150 may also reserve a percentage of the bounty that would be paid to the social network or communication platform in payment for their facilitation efforts. It will be appreciated that the sharing of bounties or rewards in this integrated manner across communication platforms include platforms that may be accessed via mobile applications or on other portable devices.

Once an agent-contact and any subsequent agent contacts are identified and a bounty or reward is satisfied, the bounty/reward splitter 114 may split the reward and allocate the partitions to the contacts and agent-contacts. The incentive system 150 gives the Reward Creator the option to use the bounty/reward split System 114 to designate the way a bounty or reward may be split if shared by more than one Reward Hunter.

A Reward Creator's goal or need page 110 is a web page with a unique URL that is created from the content received from the Reward Creator. The Reward Creator goal or need page 110 also displays the current bounty or reward being offered by the Reward Creator. Additionally, the Reward Creator goal or need page 110 has a “share” button which launches the distributor engine 108 and a “Send an Opportunity” or “Win this Reward” button that launches the Opportunity/Lead Processor 109.

Additionally, a dashboard 111 allows the individuals who use the incentive system 150 to see the results from their efforts and the status of the bounty or rewards they are involved with. The dashboard 111 is provided for contacts and for contact's contacts to allow them to see the results of their effort and the status of the bounty or reward they are involved with. The dashboard 111 may display any of its data publicly. For example, data about the Reward Creator may be displayed on the Reward Creator's goal or need page 110. Some examples of data being tracked and maintained by the dashboard 111 include, but is not limited to, the following:

For Reward Creators:
Social Networks the Reward Creator used to Share a bounty or reward
Number of contacts who have viewed a bounty or reward
Number of Solutions Received for a bounty
Number of contacts who have shared a bounty or reward

For contacts acting as agents:
Social Networks the contact(s) used to Share a goal or need
Number of the contact's contacts who have viewed a goal or need
Number of contact's contacts who have provided potential solutions
Number of contact's contacts who have shared a goal or need

For Individuals who have submitted opportunities to the Reward Creator:
Number of solutions submitted
Status of solutions submitted

Some Reward Creators may use the incentive system 150 for multiple bounties or rewards they are running concurrently. Some contacts may concurrently act as agents for multiple Reward Creators or multiple bounties. Some contacts or contact's contacts may provide multiple solutions to multiple Reward Creators concurrently. Some Reward Creators may also provide solutions to other Reward Creators or act as agents for other Reward Creators. Some contacts who are agents for some Reward Creators could provide direct solutions for other Reward Creators as well. The dashboard 111 may display the appropriate data and status for each of these concurrent situations.

In some embodiments, Reward Creators, Reward Hunters, agents, contacts and other individuals who submit an opportunity or have tried to win rewards may be prompted to create or update “profiles” that can be displayed. These profiles may include additional information about the Reward Creators or the types and quality of the Reward Hunters, agents, and other individuals who tried to win rewards. Such information may include data and rating based on the passed usage of the incentive system 150.

In another embodiment, the dashboard 111 can be integrated directly into a social network or communication platform. This integration could either be completely integrated into the social network or be an embedded or framed integration with Social networks (like Facebook applications). This integration could provide additional functionality such as to allow an individual to have the dashboard integrated into the individual's profile page of the social network. Thus, individuals may promote their bounties and rewards within a web page hosted by a third party and link back to the Goal page 110 of the individual.

A system conversion page module 122 enhances the functionality of the Opportunity/Lead Processor 109, and helps with conversions when the Reward Creator's bounty involves selling an item(s) or service(s). This enhancement to the Opportunity/Lead Processor 109 will help Reward Creators who have a goal or need which involves selling goods or multiple quantities of some goods.

For example a Reward Creator may be trying to sell multiple tickets through their network of contacts. To assist the Reward Creators with converting solution opportunities the incentive system 150 may provide a conversion page that the Reward Creator's contacts and the contacts' contacts can use to convert individuals for the Reward Creator (i.e. help the Reward Creator sell something to those individuals in order to earn the bounty or reward). In the scenarios where the Reward Creator's goal or need involves selling multiple quantities the Reward Creator may be paying a reward or bounty for each unit sold.

In another example, a reward or rewards may be offered for a service instead of for goods, such as for multiple customer referrals. In this case, the incentive system 150 allows for multiple winners to earn a reward for each customer referral. The conversion page 122 may be designated to allow for Reward Creators to designate ongoing winners for any specific reward. The ongoing rewards with multiple winners may be offered by businesses and/or individuals.

Each conversion page 122 may include one or more links or unique URLs, so that contacts can use the unique URL to attract their contacts to the conversion page. The unique URL may be displayed in the form of a button. The links may also be utilized to facilitate the tracking of goals and needs being fulfilled for the Reward Creator, so that the distribution of bounties or rewards can be enabled. In another iteration, the conversion page 122 could also be linked from the Reward Creator's Goal page 110 to help facilitate the conversions. A payment processing service may also be incorporated into the conversion page 122 to facilitate financial transactions as a part of the conversion.

If the Reward Creator has a goal or need to sell items or services then the conversion page 122 facilitates those transactions. Additionally, the contacts of the Reward Creator may apply part or all of their reward to lower the price of the service or item being sold when that contact shares the bounty with the contact's contacts.

For example a Reward Creator may use the incentive system 150 to share and distribute, with the Reward Creator's contacts, a bounty for selling an item or service “XYZ”. In this example the Reward Creator may provide a $20 reward to be awarded if a contact helps sell the item or service “XYZ”. When one of those contacts views the Reward Creator's bounty, the contact will have the ability to use the Reward Creator's $20 bounty to lower the price of “XYZ” by as much as $20 when the contact shares the Reward Creator's goal or need to sell “XYZ” with the contact's network of contacts. The system would also allow the contact of the Reward Creator to distribute the conversion page 122 with the lowered price of “XYZ” for the Reward Creator's goal or need to all of the contact's contacts in the contact's social network by using the distributor engine 108.

The incentive system 150 includes a bounty/reward split System 114, which appropriately divides the bounty between the agents and their contacts with which they shared the bounty or reward. When an individual is able to successfully help the Reward Creator fulfill the bounty, that individual and any contact acting as an agent who helped the Reward Creator to satisfying the bounty or reward, will be correctly compensated with the appropriate allocation of the bounty or reward by the bounty reward split System 114.

In some embodiments, an integration with online communication platforms allow the bounty or reward to be forwarded or redistributed to contacts of the contacts. In such cases, the reward splitter 114 can automatically adjust the reward split when the reward is forwarded onto additional contacts.

Additionally, a bounty/reward fulfillment System 118 automatically handles the payment or delivery of the bounty or reward to the individual(s) that helped the Reward Creator. When a status is changed to “successful” by the Reward Creator, indicating the goal was successfully met and a winner is selected, it triggers the bounty/reward fulfillment System 118 to automatically pay or deliver the reward. The bounty/reward fulfillment System 118 simplifies the fulfillment of the bounties when it is satisfied.

The bounty/reward fulfillment System 118 may simplify the fulfillment of bounties and rewards. When a Reward Creator has confirmed the request for the bounty or reward the bounty/reward fulfillment System 118 may automatically handle the distribution of the bounty or reward to the individual(s) who helped.

The Fulfillment System 118 may provide the dashboard 111 or another component of the incentive system 150 with information about the submissions so that the Seeker/Reward Creator may manage and respond to all the submissions receives from people trying to win the reward.

In some embodiments, in order to ensure that the Seeker/Reward Creator does not cheat the system by not paying the “Reward Hunter” who submitted the winning solution for the bounty, a trust and reputation system may display the level of credibility that a Seeker/Reward Creator has based on their past actions with other rewards and the current reward they are offering.

The system may recognize the winner in some manner and provide a “braggable moment” for the Reward Creator and the winning Reward Hunter when a reward is won. This can be automatically distributed (via social networks, email or other communication platforms) to their contacts letting them know that the reward was won.

In addition to triggering the reward payout when the status of the lead or opportunity is changed to a “successful” status, there are several other ways that can start the process of payment by the bounty/reward fulfillment System 118. All these payment methods may be designated to manually trigger or automate the payment process. Some examples are:
Reward Creator designates the bounty/reward fulfillment System 118 to pay or deliver the bounty or reward to a specific contact.
Reward Creator triggers the bounty/reward fulfillment System 118 to pay or deliver the bounty or reward to more than one contact. For example, the pay out of the reward may be split between multiple people who helped fulfill the need.
Agent triggers the bounty/reward fulfillment System 118 by sending a request to be compensated then the Reward Creator will either confirm or reject the request.
An individual or agent who provided a solution opportunity triggers the bounty/reward fulfillment System 118 by sending a request to be compensated, then the Reward Creator will either confirm or reject the request.
One or more individuals or agents add to the reward for a bounty that may, for example increase the original reward. When a group of individuals add to the reward, the reward may be increased by an aggregate of the group's contribution.

In some situations, a bounty or reward may not be paid out. For example:
Reward Creator promised a bounty, and either chooses to retract the promise or it is automatically canceled after some period of time.
Reward Creator paid a bounty upfront, and then either chooses to request a refund (potentially minus a service fee) or bounty is automatically refunded (potentially minus a service fee) after some period of time.
Reward Creator earned a bounty through some third party system, (i.e. advertiser offers) and the bounty is not disbursed. After a set period of time, the bounty may expire.

When an individual helps the Reward Creator fulfill the Reward Creator's bounty and the Reward Creator has confirmed the submission, the bounty/reward fulfillment System 118 automatically handles the payment or delivery of the reward to the individual(s). In some cases, the person who helped the Reward Creator fulfill the Reward Creator's bounty may have received notification of the Reward Creator's bounty or reward directly from the Reward Creator. In this scenario, the contact will be entitled to the full amount of the bounty or reward. In other cases, the individual who helped the Reward Creator fulfill the Reward Creator's bounty or reward could have received notification of the bounty or reward indirectly from one of the Reward Creator's contacts who acted as an agent. In this scenario, the Reward Creator's contact who acted as an agent by forwarding the Reward Creator's bounty and the individual who helped the Reward Creator fulfill the Reward Creator's bounty or reward may get a split the bounty or reward based on the previously determined allocations being stored in the bounty/reward split System 114.

The bounty/reward fulfillment System 118 may handle the payment or delivery of the bounty or reward. Some examples of how the reward or bounty can be paid or delivered include, but are not limited to:

Bounty or reward Electronic payment—Payments can be made through electronic payment systems like PayPal, echecks, Amazon payments, Google payments, cell phone payments (Boku) or direct deposit into a bank account. These payments could also be made in multiple international currencies.

Bounty or reward Gift Cards—In this scenario the bounties or rewards would be delivered by gift card or gift certificate (electronic or physical). The gift cards can be preselected by the Reward Creator or the recipients of the bounty or reward could have the option of selecting from a list of potential merchant gift cards or gift certificates. The bounty/reward fulfillment system 118 could fulfill the delivery of the gift cards or gift certificates by using a third party partner for the fulfillment or the reward fulfillment system 118 could use its own Electronic gift card splitter and Distributor 119.

Bounty or reward physical delivery—Delivery of the bounty or reward can be physically mailed to the recipient in the form of a paper check. In some embodiments, the bounty or reward is a physical item and would need to be physically delivered. Additionally, in some embodiments the bounty or reward is a service that would need to be awarded or performed.

Virtual Currency bounty or reward—Delivery of the bounty or reward can be made in virtual currency that can be used in the various virtual communities (Facebook credits, Zynga currency, IMVU money etc.). The virtual currency may be translated in anything that can express value, such as points, dollars, privileges, and so on.

The incentive system 150 may also give the individuals who earn a bounty or reward choices as to how they can collect or redirect the bounty or reward. Examples include:
Rejecting the bounty and giving it back to the Reward Creator.
Directing their bounty to a charity.
Splitting the bounty with another contact.
Other redirecting possibilities.

In another embodiment, the bounty/reward fulfillment System 118 can be integrated directly into a social network or social communication platform. This integration could either be completely integrated into the social network or be an embedded or framed integration with Social networks (like Facebook applications). This integration could provide additional functionality such as to allow an individual who helped the Reward Creator fulfill the Reward Creator's bounty to be automatically paid through the social network or social communication platform. This could include having the funds directly deposited into the account of the individual who resides on the social network or social communication platform. Another possibility would be for the funds to immediately be converted for the individual into the virtual currency of the social network or communication platform.

Optionally, the incentive system 150 may include an Electronic gift card splitter and Distributor 119, which is a system and repository of gift card numbers from various merchants. The Electronic gift card splitter and Distributor 119 can simplify the splitting of gift cards into small amounts for cards by the same or different merchants. The system then handles the fulfillment of the gift cards to the correct individuals.

More specifically, the Electronic gift card splitter and Distributor 119 is a system and repository of gift card numbers from various merchants. The Electronic gift card splitter and Distributor 119 simplify the splitting of gift cards into smaller amounts and for cards by the same or different merchants. Gift cards can be used as an incentive by an individual (offerer) or business (offerer) to motivate contacts to help. In this example the Reward Creator is the offerer and wants to offer a gift card as a reward for a bounty. The Reward Creator as the offerer pays the amount that the Reward Creator wants to offer as a reward. The system processes the Reward Creator's order for the gift card and then notifies the Reward Creator that the gift card may be used (in the amount paid) as reward. When the Reward Creator indicates that an individual (the gift card recipient) has earned the gift card reward then the individual is notified by the system that the desired gift card may be selected. The gift card recipient then selects the merchant from which the recipient wants the gift card. The system then selects a gift card number from that merchant who is stored in the repository and then notifies the merchant who the gift card number has a value equal to what the Reward Creator paid. The funds from the Reward Creator's payment are then transferred to the merchant (minus any transaction fee that has been negotiated between our system and the merchant). The system then delivers an electronic or physical gift card from the merchant to the gift card recipient.

If there are multiple gift card recipients for the same bounty or reward then the system divides the gift card values into the two or more separate quantities based on the allocation determined by the bounty/reward split System 114. Each gift card recipient may then select the merchant from which the gift card is to be issued. The incentive system 150 may select the gift card numbers from each merchant the gift card recipients selected and that are stored in the repository. The incentive system 150 then notifies each merchant who the gift card number has a value equal to what the gift card split was for that gift card recipient. The funds from the Reward Creator's payment are divided based on what was determined by the bounty/reward split System 114. The appropriate funds are then transferred to each merchant (minus any transaction fee that has been negotiated between the incentive system 150 and the merchant). The system then delivers the appropriate electronic or physical gift card from the appropriate merchant to each gift card recipient.

In yet, another embodiment, instead of the incentive system 150 storing all the merchant gift card numbers in a repository, the gift card numbers can be stored by systems of the merchants. In this scenario, when a Reward Creator has paid for the gift card(s) an order is sent to the merchant(s). The merchant then generates the number for the gift card and connects the number to the necessary dollar amount. The incentive system 150 then provides the gift card to the individual who earned the reward of bounty from the Reward Creator. The funds may be transferred from the incentive system 150 to the system of the merchant.

The incentive system 150 provides one or more platforms to reach the social networks 112 of the Reward Creator via the network 102. The bounty arranged by the incentive system 150 on behalf of the Reward Creator is distributed to members 113 of the Reward Creator's social networks 112. Examples of social network websites 112 accessed include Facebook, MySpace, Twitter, Google Buzz, Google+, LinkedIn, and the like.

The proliferation of social networking has made the broadcasting of bounties to large numbers of contacts instantaneous. The incentive system 150 provides a convenient and efficient way for anyone to distribute and manage bounties and rewards with a person's extended network and the extended networks of the person's contacts.

For example, social networks can be used by individuals to stay connected with friends, family, others with similar interests, and business associates. As a result many users use at least one social network every day. Some use several social networks hourly. These networks are available on a variety of network platforms which can be accessed via any networked device (e.g., mobile applications on hand-held devices). As a result, people are very aware of what their friends and business associates are broadcasting or messaging through these networks. Also, since people have been growing their network connections over the years, currently the average individual on a social network has over a hundred connections. It is not unusual for some users to have over a thousand direct connections. As a result, an individual using a social network has a very engaged audience of friends (close network) and contacts (extended network) who will be receptive to updates and recommendations from that individual.

In accessing the social networks 112, the process through which the Reward Creator shares and distributes the Reward Creator's bounty or reward with the Reward Creator's contacts is enabled via paths 115 and by the incentive system 150 may be known as “Reward Creator Sharing”. The process through which another individual shares and distributes the Reward Creator's bounty or reward with the particular individual contacts may be known as “Agent Sharing,” and is represented by path 116. The “Agent Sharing” 116 can be within one specific social network or across multiple social network or communication platforms.

It will be appreciated that other communication platforms 117 such as email, SMS, mobile apps, and so on, may be used or included to share a Reward Creator's bounty or reward. In addition, a Search Engine 121, such as Google, Yahoo, Bing, and so on, may be utilized by the Reward Creator or the incentive system 150, as described in other sections.

To illustrate the potential for “sharing” and distributing a bounty or reward, consider the following example. If a Reward Creator notified the Reward Creator's 150 contacts on a specific social network by sharing the bounty, then the Reward Creator now has 150 individuals who could help fulfill the Reward Creator's bounty. At the same time if the Reward Creator offered a financial reward that may motivate the Reward Creator's 150 social network contacts to share and distribute the Reward Creator's bounty with each of their 150 contacts. The Reward Creator now has another 22,500 individuals who could fulfill the Reward Creator's bounty. Even better, if there is also an incentive for the additional 22,500 individuals to share what the Reward Creator is seeking with each of their 150 contacts then the Reward Creator would have an additional 3,370,000 individuals who could fulfill the Reward Creator's bounty. As you can see the potential of using social networks through varying degrees to promote what the Reward Creator is seeking by sharing and also motivating individuals to share what the Reward Creator's is seeking, significantly enhances the Reward Creator's potential opportunity that someone will help fulfill the Reward Creator's bounty.

The challenge for individuals “sharing” and distributing a bounty or reward over social networks is the difficulty in tracking and financially rewarding the specific individuals who successfully helped fulfill what the Reward Creator is seeking. The challenge becomes even more significant when considering that many individuals might use multiple social networks to help fulfill what the Reward Creator is seeking by sharing and distributing across multiple social networks and/or other Internet platforms. Thus the reporting and the sharing and distributing of the financial reward may be enabled to automatically work across those different social networks by the incentive system 150.

The incentive system 150 also provides a Marketplace 120 so that Reward Hunters that are individuals or independent agents can choose which bounties or rewards to pursue or share and distribute to their contacts. The Marketplace 120 is a searchable and sort-able directory of the various Reward Creators' goals and needs and the bounties and rewards being offered. The marketplace 120 may be sort-able in many ways including by Reward Creator location (state, city, zip code, distance from a geo location or an individual will be able to get a list of goals or needs and bounties or rewards provided by Reward Creators that the individual is connected to in a social network.), by bounty or reward type/category, by bounty or reward amount, and so on. Individuals may be able to browse Reward Creators' bounties and rewards that interest them. These bounties and rewards may be presented in the marketplace 120 in any manner, such as links, newsfeed, gallery, and so on. Additionally individuals may be able to browse or look up Reward Creator's goal or need pages 110.

Also, individuals may be able to register and create a profile in the Marketplace 120. Once registered, the user may indicate that they would like to be notified about new Reward Creator bounties and rewards postings. By registering, Reward Hunters may receive future information about new bounties and rewards that could be of interest to them or updates to the status of current bounties and rewards. Many factors can be used to determine which potential rewards may be presented to registered users. Some factors include, but are not limited to location, amount of the reward, demographics of the Reward Hunter, demographics of the Reward Creator, reward type, past interest in similar rewards, unique privileges of the Reward Hunter, and so on. The process of sending the reward notifications may also be via the same communication platforms described previously including social networks, email, mobile applications, and other communication platforms.

From the marketplace 120 or the Reward Creator's goal or need page 110, an individual may be able to use the Opportunity/Lead Processor 109 to send opportunities to the Reward Creator in hopes that the individual earns the bounty or reward. The distributor engine 108 may also allow an individual to share the Reward Creator's bounty with the Individuals contacts in hope that one of those contacts help the Reward Creator with the bounty. The individual may be eligible to receive a part of the bounty or reward in such case. In some embodiments, the incentive system 150 may place limitations on users or on user activities. For example, the bounty or reward system 109 of the incentive system 150 may restrict who may submit solutions to rewards. The bounty or reward system 109 may restrict who can create rewards. The incentive system 150 may also restrict certain individuals from submitting to or creating certain types of rewards. The opportunity/lead processor 109 incentive system 150 may also limit the number of submissions a Reward Hunter can make, for example, within a specific time period. Reward Hunters may be able to gain privileges to submit to more rewards, where they may be rated and have good score ratings based on past submissions, by performing acts that the incentive system 150 may request or may rate, and so on. Having restriction control may change the quality of one's experience with the incentive system 150. For example:
Restricting the number of submissions a Reward Hunter can make may be to incentivize higher quality submissions. Restricting the number of submissions forces Reward Hunters to submit quality solution opportunities since they will initially only be able to submit to a few rewards.
These restrictions may deter spammer risks, motivate good users, and encourage quality submissions.
Reward Hunters could earn more submissions per day with good quality ratings of the past submissions.
A quality rating system may be implemented as a check off or a drop down menu by the Reward Creator.
Reward Hunters may have the option to buy extra submissions or a higher quality rating to offer more.
Certain Reward Hunters may be permitted to or incentivized to sell the right to do more submissions.
Getting more submissions can also be designated as a reward, the incentive for winning a specific reward is that the winner would get the right to do more submissions to other rewards being offered.

The system's Marketplace 120 provides a channel for individuals who are not connected to the Reward Creator, to have the opportunity to earn bounties or rewards by helping Reward Creators fulfill their bounties or by acting as agents and sharing or distributing Reward Creators' bounties with their contacts. As described previously, there are multiple ways in which an “Agent” could be compensated. For example, the agent could be compensated for sharing or distributing the reward with others whether or not the reward is won by any of those contacts. The agent could also be compensated for sharing or distributing the reward with others only if the reward is won by one of those contacts.

When a Reward Creator creates a bounty and chooses a reward, the distributor engine 108 posts the Reward Creator's bounty or reward in the system's Marketplace 120. Because the Marketplace 120 is searchable, individuals who want to earn bounties or rewards will be able to find Reward Creators' goals or needs and rewards that meet the criteria that they would like to help fulfill or that they would like to share or distribute with their networks. The individual will also be able to search the Marketplace 120 to be able to find Reward Creator's goals or needs and bounties or reward within geographical area.

When an individual at the Marketplace 120 becomes interested in a Reward Creator's bounty or reward, then the individual may click on the posting in the Marketplace 120 to be able to view the Reward Creator's goal or need page 110 to get more details. The individual would be able to click the “send an opportunity” or “win this reward” button on the Reward Creator's goal or need page to use the Opportunity/Lead Processor 109. The individual may alternatively click the “share” button on the Reward Creator's goal or need page 110 to use the distributor engine 108 to act as an agent and share or distribute the Reward Creator's bounty or reward with the contact's contacts or specific groups of the contact's contacts (like contacts in a specific physical area or a specific group of friends), the details of which as will be described further.

FIG. 1B is an example of the database scheme 101 of the incentive system 150, according to some embodiments. Each Reward Creator (label A) has a database record containing personal info such as name, email, and so on. The Reward Creator may use a computer, mobile device, other portable device, or some other Internet connected device to access the incentive system 150. The Reward Creator registers with the user Data System 105 by providing personal information, such as name, email, and so on. The Reward Creator creates a goal or need (what the Reward Creator is seeking) and enters it in the incentive system 150. The Reward Creator may also choose or create a goal or need category. Examples of such categories include, Get a new job, Rent an apartment, Sell a house, Sell a car, perform a service, seek unique or rare item, and so on. The Reward Creator may also add more details about the goal or need, including photos, resume, geographic location requirements, video, links, and other descriptive information. In some embodiments, the system may suggest category specific meta data to add and/or the Reward Creator may add additional content to support and further describe a goal or need.

A Reward Creator is associated with records for any number of goals and needs. Each respective goal or need (label B) has a category, a description, a designated reward, and other relevant content to the bounty (e.g. a resume for a job Reward Creator, a photo of a house for a realtor, an item for sale, an item being sought, a service, and so on). It also has a unique identifier to allow the creation of a unique URL in order to reach the appropriate goal or need webpage. Each bounty (label B) may be associated with any number of View records (label C) that represent a single view of the associated goal page along with the source of the view (e.g. which social network) and, in some cases when available, who viewed the goal page.

Each bounty may have any number of share records (Label D) that capture the identification of who shared and distributed the bounty or reward (e.g. name, email), and the amount of the incentive that they reserve for themselves (e.g. 10% of bounty, $25 of bounty, etc.) in case someone in their network satisfies the Reward Creator's bounty. The share records also include a unique identifier that allows access to a unique version of the Reward Creator's goal or need page, which contains the same goal or need information and calls to action around submitting an opportunity, adding an endorsement, or sharing and distributing again, in addition to the smaller bounty amount that subtracts the sharer's reserved award amount or share.

Each share record can have relationships with any number of Leads (Label E), as well as any number of additional share records. The Leads (Label E) may be submitted by others, including content that may allow the Reward Creator to satisfy the Reward Creator's bounty or reward, as well as the name, email or other identifying information of the person who provided the lead or other type of submission.

In the case of a bounty or reward that is shared multiple times before a solution is submitted, a doubly-linked list, represented by database records, captures the chain of shares connecting the Reward Creator with the person who provides a successful solution, and allows correct bounty or reward disbursement to all the parties who earned part of the reward upon successful fulfillment of the bounty or reward. In summary, when a Reward Creator creates a bounty or reward the Reward Creator becomes associated with that bounty or reward. A Reward Creator can be associated with records for any number of goals or needs. Each bounty or reward has a category, a description, a designated incentive, and other relevant content to the bounty or reward (e.g. a resume for a jobseeker, a photo of a house for a realtor, geo location restrictions etc.). The bounty or reward also has a unique identifier to allow the creation of a unique URL for the appropriate goal or need webpage. Since that goal or need webpage will be viewed by other users, each bounty or reward has associated data for any number of views by users that is stored in the database. Some of those views will result in those users to send solution opportunities to the Reward Creator, so the database keeps a record for each bounty or reward as to the number of leads submitted by others, including content that may allow the Reward Creator to satisfy their bounty or reward. Each bounty or reward has any number of share records in the database that capture the identification of who share the bounty or reward (e.g. Name, email), and the amount of the bounty that they reserve for themselves (e.g. 10% of bounty, $25 of bounty, points etc.) in case someone in their network satisfies the Reward Creator's bounty or reward. The share records also include a unique identifier that allows access to a unique version of the Reward Creator's goal or need page which contains the same goal or need information and calls to action around submitting an opportunity, adding an endorsement, or sharing again, in addition to the smaller bounty or reward amount that subtracts the sharer's reserved share. Each share record can have relationships with any number of Leads (Label E), as well as any number of additional share records. Leads can be any submission made to try to win a reward that is being offered. In the case of a bounty or reward that is shared multiple times before a solution is submitted, a doubly-linked list represented by database records captures the chain of shares connecting the Reward Creator with the person who provided a successful solution, and allowing correct bounty or reward disbursement to all the parties who are owed part of the reward upon successful fulfillment of the bounty.

In an alternative iteration, a “user” database record (not shown) may take on any or all of three different roles:
1. A Reward Creator record, indicating a bounty or reward.
2. A contact agent record, indicating another's goal to their contacts has been shared.
3. A lead or solution provider record, indicating a Lead for another's goal has been submitted.

In this alternative case, goal records, share records, and lead records are all associated with relevant user records instead of containing any user information themselves. The user records contain the user information.

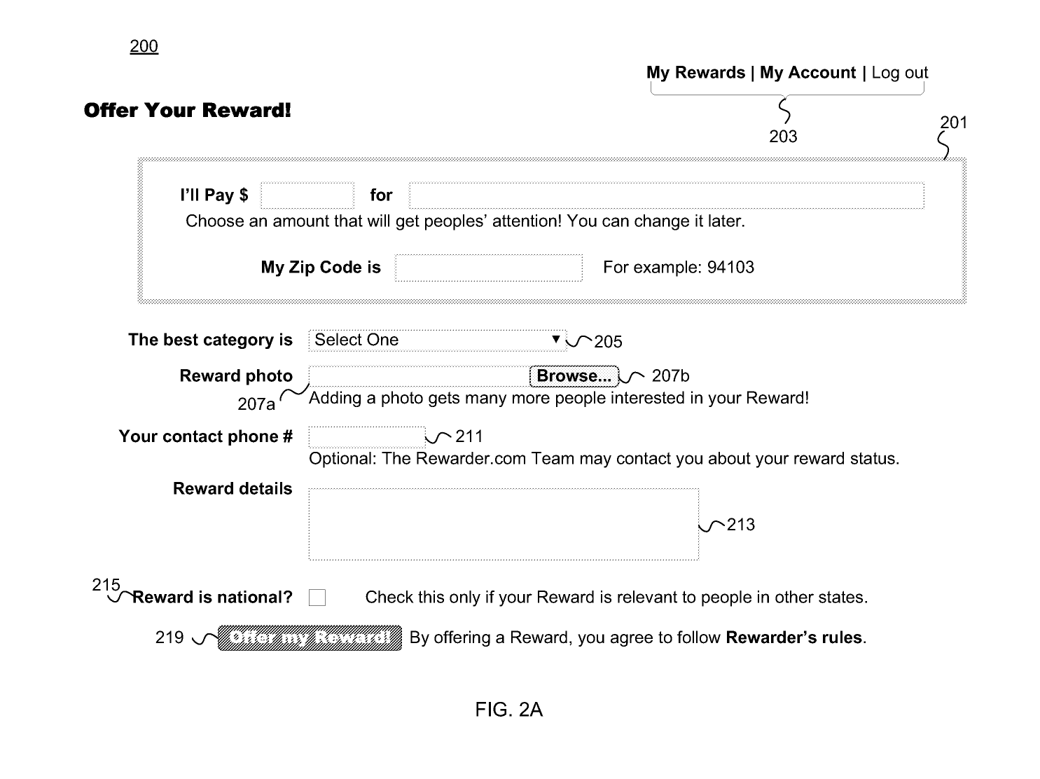

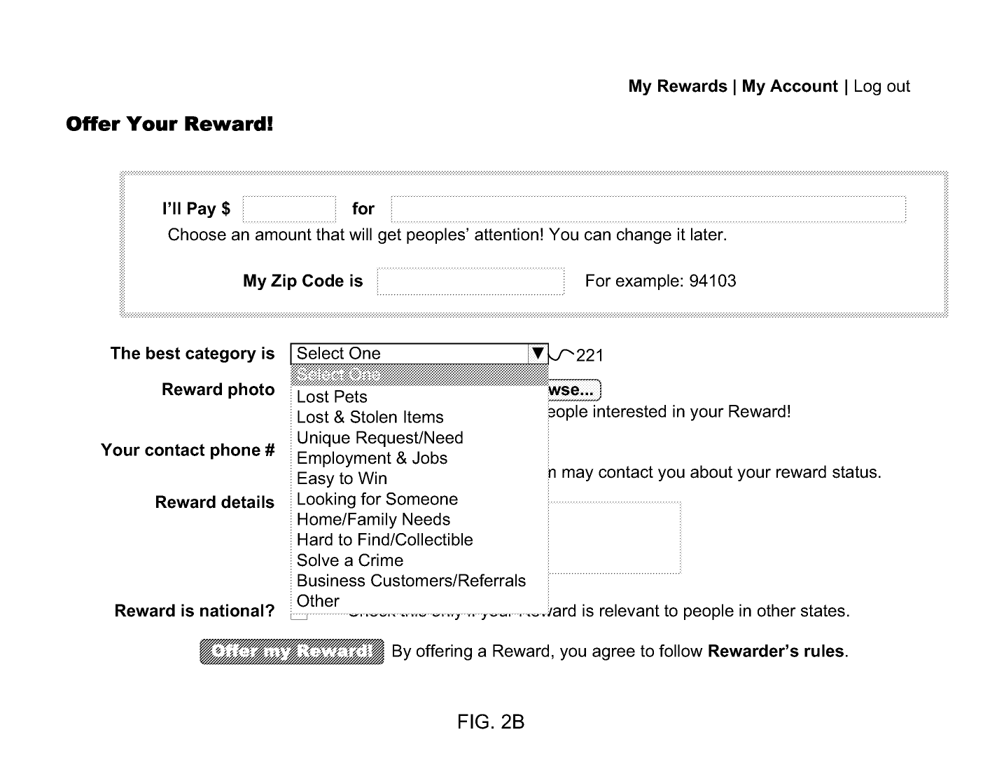

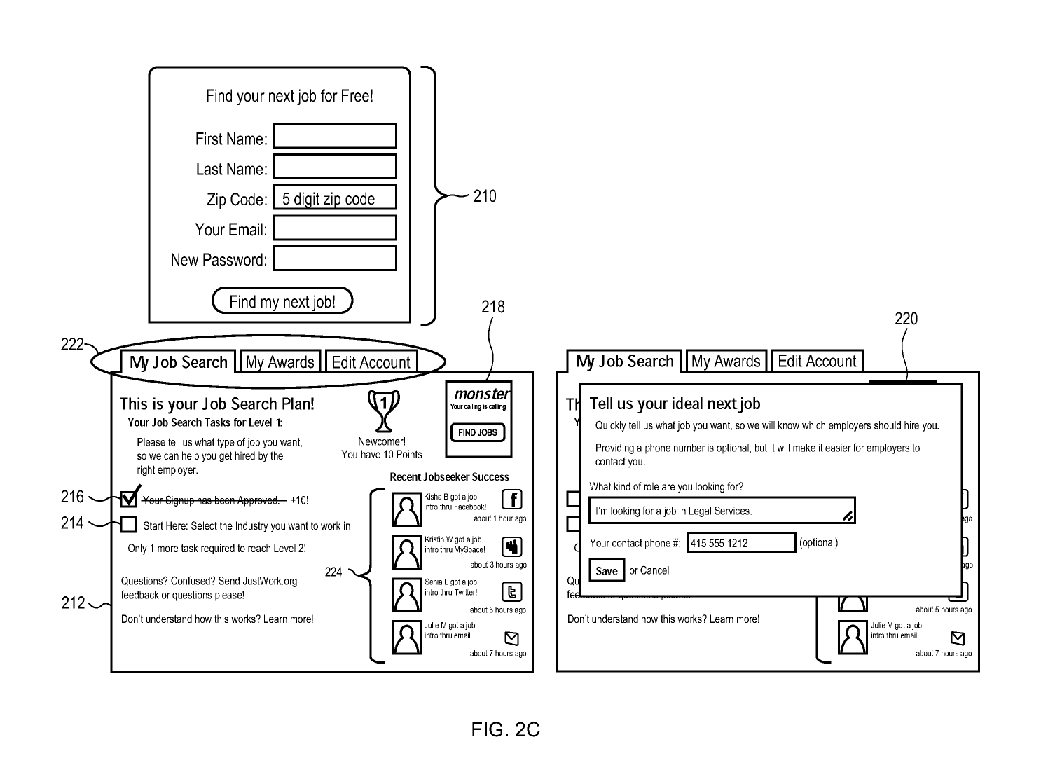

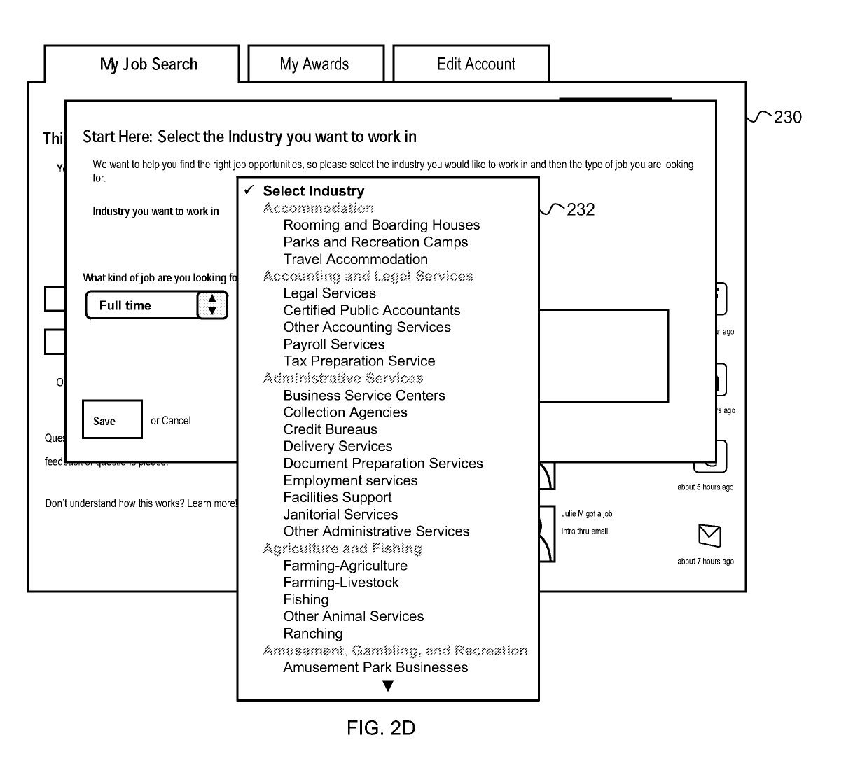

FIG. 2A illustrates an example of a user interface 200 for creating a reward in the incentive system 150 of FIG. 1A, according to some embodiments. The incentive system 150 may require a user to log into a user account or create a user account. Once the user is logged in, the user interface 200 may be displayed. The user can begin by indicating a reward amount and a goal or need or title for the goal or need in the field 201. Additional identifier information for the reward may be requested, such as a zip code in field 201. The user may provide additional information about the user or to help others to better understand the goal or need. For example, the user may indicate a category 205 or add a photo 207a. The photo may be selected by using the browser button 207b. The user may also indicate a contact phone number 211, which may be included in the reward posting or used internally by the incentive system 150. The user may also provide a more detailed description of the goal or need in field 213. The user interface 200 may also include a location indicator 215 that determines whether the reward posting is relevant to people in other states. In some embodiments, the location indicator 215 may prompt whether the reward should be distributed locally, e.g., within a state, a city, a region, and so on. Once the user has entered all information about the reward, the user creates the reward and enters the reward data by clicking a button, such as an “Offer my Reward!” button 219. The user may additional access other services on their incentive system 150 account via account links 203. It will be appreciated that other variations of the user interface 200 may apply. For example, additional fields may be included or some fields may be omitted.

FIG. 2B illustrates an example of a reward category list 221 in the user interface 200 of FIG. 2A, according to some embodiments. A reward may be for any category. An example of a predetermined category list is shown as category list 221. Alternatively, the user may manually enter a category in an editable field, or the category list 221 may include an option to enter a category.

FIG. 2C illustrates examples of various interfaces 210, 212, 220 for gathering data that may be stored in database 107 through the user Data System 105, according to some embodiments. For illustration purposes, user data being collected for a Reward Creator whose bounty or reward is to get a job is demonstrated at interfaces 210, 212, 220. It will be appreciated that the user Data System 105 could be used for many different goals or need categories. To get started the Reward Creator enters user contact information, identification data, and passwords at interface 210 to set up an account. At interface 212, additional information may be collected including any notifications or updates to the user or user's account, as shown in line 216. The user may also select an option to enter additional information about the type of job the user is seeking, as shown in line 214. Upon clicking on the link of line 214, another interface pops up for further data-collecting functions in interface 220 related to the job or goal the user is seeking.

Additionally, the main data interface 212 may include additional tab features 222 associated with the user's account, such as the option to view a user's reward plan or to edit account information.

Optionally, the main data interface 212 may display latest news, information or updates related to the user account, other users of the system, or any other information related to the user's goal or use of the system. The main interface 212 may also feature advertisement displays, such as advertisement data 218.

FIG. 2D illustrates another interface 230 that may be displayed to prompt the user to select from a list 232 of preferences or features about the user. In this case, the user is prompted to select a desired industry to work in while the system collects data for the user's Job Search goal.

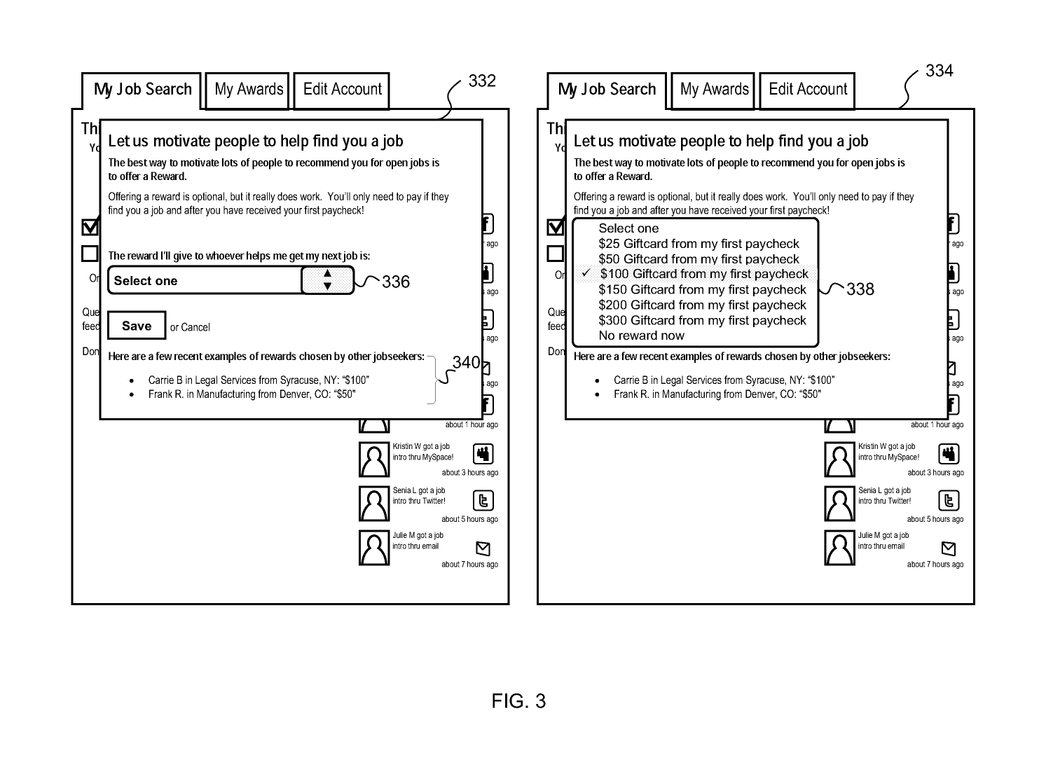

FIG. 3 is an example of interfaces 332, 334 for the bounty or reward system 104 of FIG. 1A, according to some embodiments. A Reward Creator may designate a bounty or reward by defining one or selecting one from a group. Reward Creators may be prompted to select from a predetermined group of reward amounts or payment types (e.g., financial, points, virtual currency, and so on.) In some embodiments, the Reward Creator may be prompted to first define a bounty or reward type. In some embodiments, the Reward Creator may create a custom bounty or reward.

In the example illustrated in FIG. 3, the bounty or reward system 104 allows the Reward Creator to select from a set number of gift cards to offer as a reward or bounty. The Reward Creator may select the desired gift card or reward from a “Select one” field 336. Upon selection, the “Select one” field 336 expands into a list of rewards 338 to choose from bounties or rewards could be cash/credit, gift-cards/gift-certificates, an item, points or service, etc. Also, they could be in set amounts or variable amounts. The system automatically helps the Reward Creator choose an appropriate incentive to offer based on the Reward Creator's bounty or reward. The system may also make suggestions for an appropriate incentive based on what other Reward Creators have offered as a bounties or rewards, as shown in sample reward lines 340. The system 104 may also show what other people have offered as a bounty or reward and will also allow the Reward Creator to see what the Reward Creator's friends or contacts have offered as a bounty or reward when they have been Reward Creators.

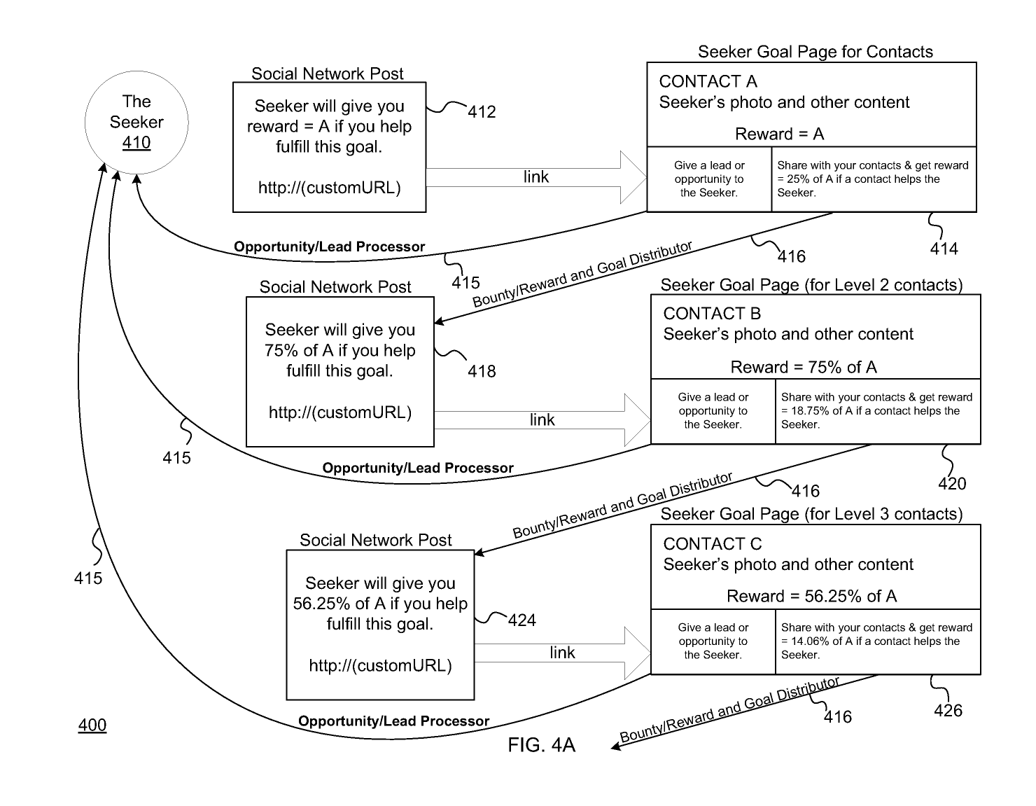

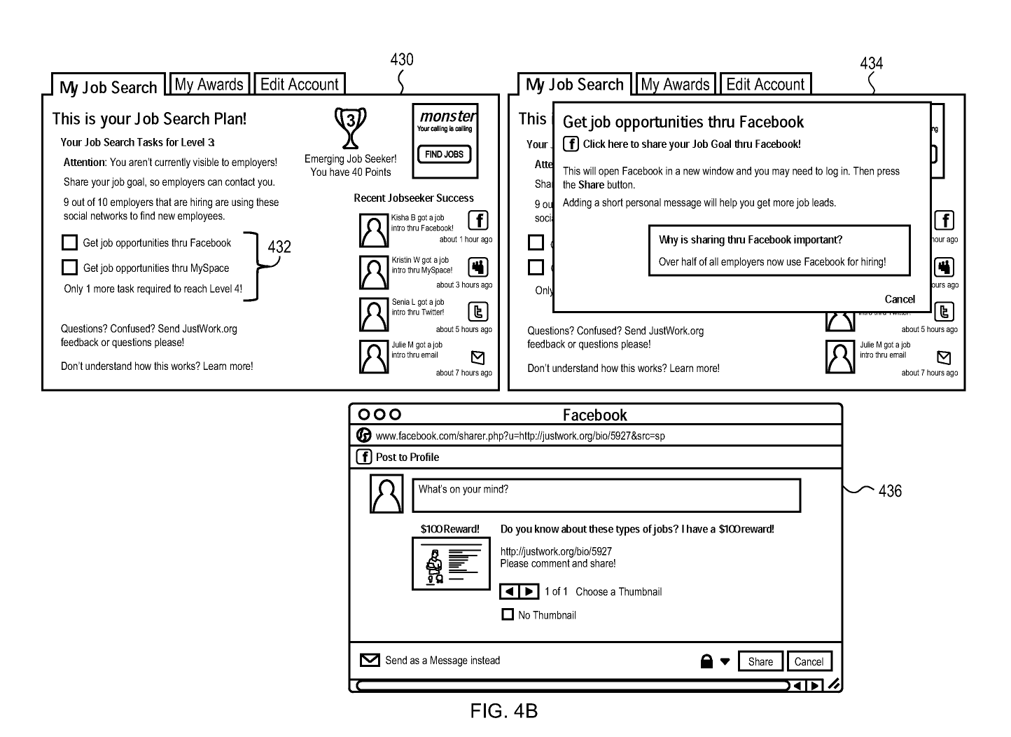

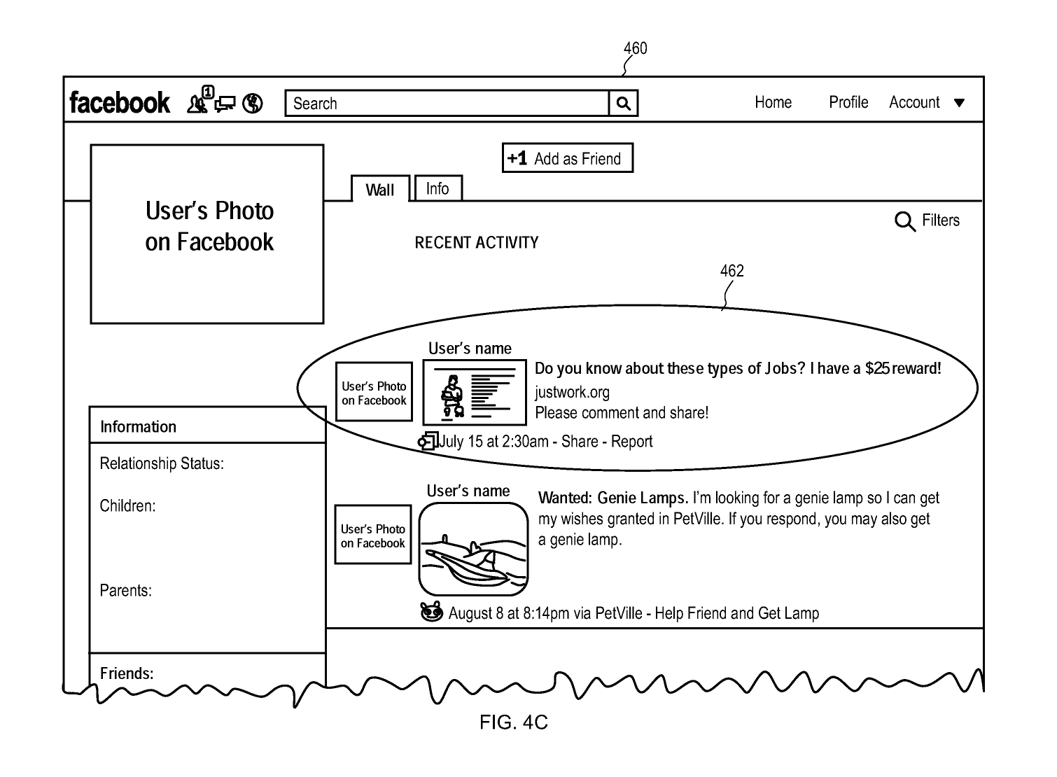

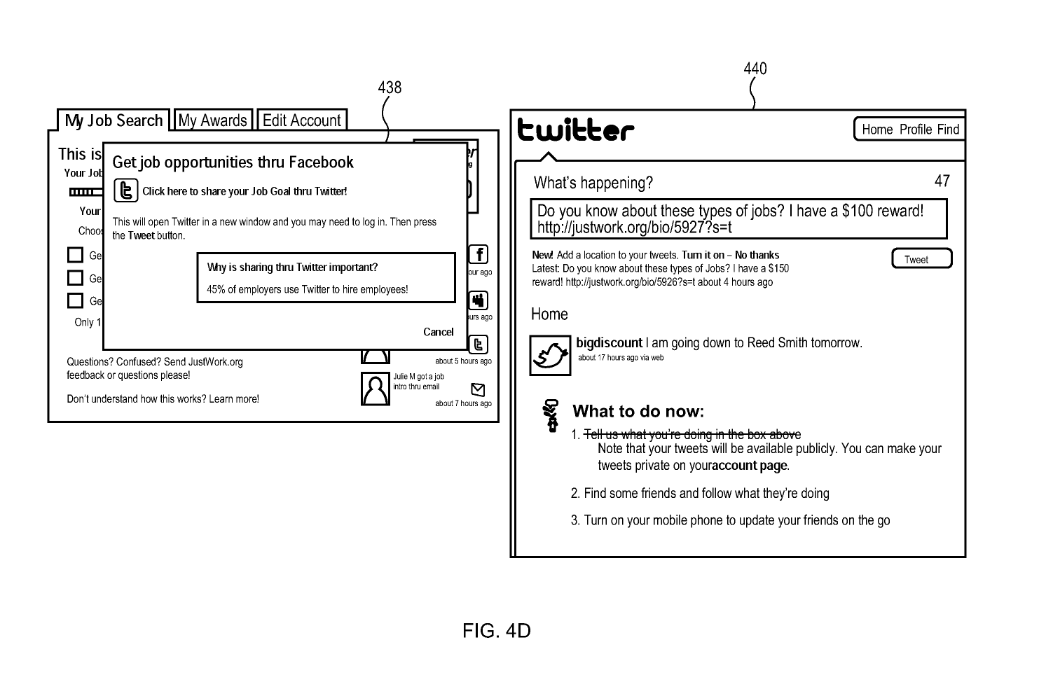

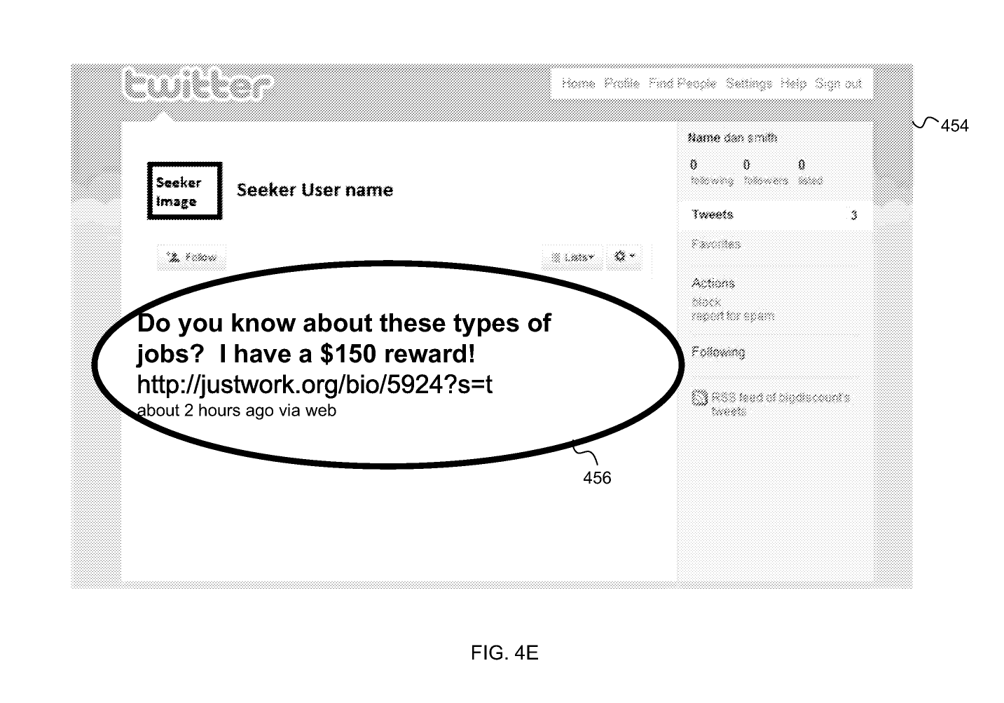

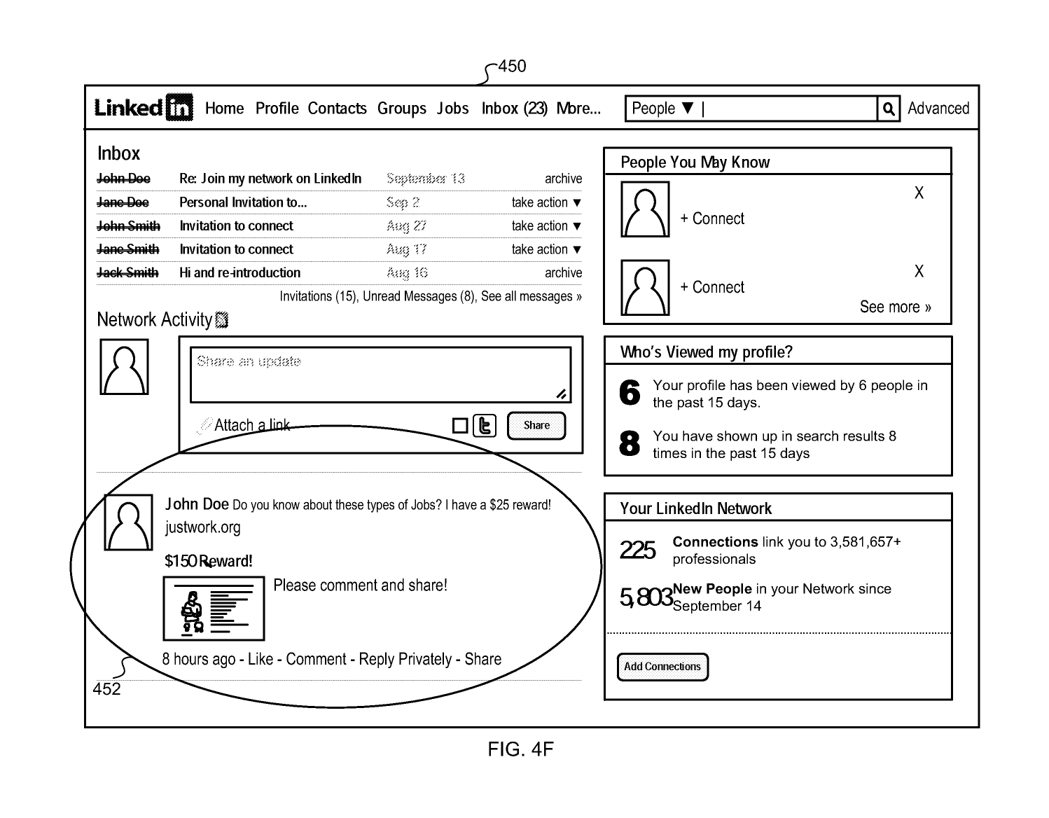

FIG. 4A illustrates a system 400 for Sharing and Splitting a reward, according to some embodiments. The system 400 for Sharing and Splitting a reward helps the Reward Creator manage, for example, the financial incentives that get others to help with the Reward Creator's bounty. It will be appreciated that the shared reward may be a non-financial incentive such as points, privileges, virtual currency, and s on. The system 400 manages the bounty or reward for the Reward Creator, so the Reward Creator's contacts will be motivated to help the Reward Creator with the Reward Creator's bounty or reward. In some scenarios it takes the successful effort of both a contact acting as an agent and the contact's contact providing the solution opportunity to the Reward Creator that fulfills the Reward Creator's bounty or reward. In these scenarios the bounty/reward split System 400 appropriately divides the incentive between the agents and their contacts who they shared with. Thus, when an individual is able to successfully help the Reward Creator with the Reward Creator's bounty or reward that individual and any contact acting as an agent who shared the Reward Creator's bounty or reward with that individual will be correctly compensated with the appropriate allocation of the incentive.

In the example illustrated in FIG. 4A, the splitting of the reward is shown as a goal or need 412 posted by a Reward Creator 410 that is shared and then shared again. Contact A clicks on post 412 to view the goal page 414 the Reward Creator shared with the Reward Creator's contacts. In this example, contact A is a contact from the Reward Creator's 410 social network. Contact A may submit a solution opportunity to the Reward Creator 410 to invoke path 415 to initiate an opportunity/lead processor operation. Contact A may also act as an agent by clicking the “Share” button on the Reward Creator's goal or need page to initiate a bounty/reward and goal or need Distributor operation 416 to share the Reward Creator's bounty or reward with other contacts. When the Reward Creator's bounty or reward is shared and distributed by contact A, a new post 418 is distributed to contact A's contacts. This new post has a custom URL generated by the bounty/reward split System 400 determines the appropriate bounty or reward that would potentially be paid and how it will be split between the contact acting as an agent, contact A, and the contact's contact, contact B. When contact B clicks on the post 418 the customer URL directs contact B to the Reward Creator goal page 420. From the Reward Creator goal page 420 contact B can provide an opportunity to the Reward Creator 410 to invoke path 415 to initiate an opportunity/lead processor operation. In this example, the potential split for a shared reward is that contact A, acting as the Reward Creator's agent and who shared with contact B, gets 25% of the available incentive. Contact A's contact, contact B, the one who fulfills the Reward Creator's reward or bounty, gets 75% of the available incentive.

If contact B decides to share the Reward Creator's reward or bounty with contact B's contacts, contact B may initiate a secondary bounty/reward and goal or need Distributor operation 416 to further split the incentive. The bounty/reward split System 400 again determines the appropriate incentive split by generating a new posting 424 and a new custom URL to allow contact B's contact, contact C in view the Reward Creator's goal page 426. In this allocation example, if contact C uses the Opportunity/Lead Processor to provide an opportunity and then that opportunity succeeds, contact C gets 56.25% of the incentive, contact B gets 18.75%, and contact A gets 25%. If contact C decides to share Reward Creator's bounty or reward with its own contacts, the process is repeated and if contact C's contact is successful, contact C's portion is indicated by the bounty/reward split System 400, e.g., 14.06%, and so on.

There are many ways that either the Reward Creator 410 or the Reward Creator's contacts down the contact chain (contacts A-C) could have the bounty/reward split System 400 allocate the incentive.

In another scenario, the Reward Creator 410 may select to have the bounty/reward split System 400 split the potential bounty or reward incentive between the Reward Creator's contact, contact A, who is acting as an agent and the contact's contacts based on a percentage allocation determined by the Reward Creator 410.

In one scenario, the Reward Creator may select to have the bounty/reward split System 400 split the potential incentive between Reward Creator's contact, who is acting as an agent, and the contact's contacts based on a numeric dollar amount allocation determined by the Reward Creator 410. It will be appreciated that the reward incentive amount may be an allocation of a non-financial incentive such as points, privileges, virtual currency, and so on.

In another scenario, the Reward Creator 410 may select to have the bounty/reward split System 400 allocate the entire bounty or reward incentive to a charity.

In one scenario, the contact who is acting as an agent (contact A) may select to have the bounty/reward split System 400 allocate the entire bounty or reward incentive to contact A's contact.

In yet another scenario, the contact who is acting as an agent (contact A) may use the bounty/reward split System 400 to adjust the potential bounty or reward incentive between contact A and contact A's contacts.

In yet another scenario, the contact acting as an agent (contact A) may select to have the bounty/reward split System 400 allocate the entire bounty or reward incentive to contact A and then share the Reward Creator's bounty or reward incentive with contact A's contacts with no available bounty or reward incentive available to the contacts.

The potential bounty or reward incentive for each individual is displayed on the Postings (views 412, 418, 424) and the Reward Creator goal or need page (views 414, 420, 426) that the each individual contact sees. Since a Reward Creator's bounty or reward can be shared from one contact to another contact, each contact could share it with subsequent third, fourth, fifth contacts and so on. The bounty/reward split System 400 is designed to calculate splitting the bounty or reward an infinite number of times since it is conceivable that the Reward Creator's bounty or reward can be shared an unlimited number of times.

In another scenario, communication platforms, such as social networks or other third party services, may perform a service that helps facilitate the sharing of the Reward Creator's bounty or reward with more contacts. In this example, the bounty/reward split System 400 may allocate an amount (percentage, numeric, etc.) of the bounty or reward incentive that can be allocated as payment to the social network, communication platform, or other third party service.

If the Reward Creator 410 changes the bounty or reward incentive, then the system 400 will help the Reward Creator 410 redistribute the updated bounty or reward incentive to Reward Creator's contacts. When the Reward Creator adjusts the bounty or reward incentive the system 400 will adjust the reward or bounty incentive being offered on the Postings (views 412, 418, 424) and the Reward Creator's goal or need pages (views 414, 420, 426) based on the bounty or reward incentive split adjustments that have been made in the past. The distributor engine 108 of FIG. 1A is able to send out updated posts with the updated bounty or reward incentive, as illustrated by paths 416, to all of the Reward Creator's contacts and to any of the contacts' contacts who received the previous bounty or reward from the Reward Creator 410. The Reward Creator 410 can have the system 400 automatically update a changed bounty or reward incentive with contacts or the Reward Creator 410 could select only specific contacts with whom to share the updated bounty or reward incentive. The Reward Creator 410 can also indicate different bounties and rewards incentive for different contacts.

In another embodiment, the bounty/reward split System 400 can be integrated directly into a social network or social communication platform. This integration could either be completely integrated into the social network or be an embedded or framed integration with the Social networks (like Facebook applications). This integration could provide additional functionality such as to allow the Reward Creator 410 to change a reward or bounty in real-time.

FIG. 4B shows various screenshots to illustrate how a Reward Creator's bounty or reward may be distributed to contacts at a social network site, according to some embodiments. In main interface 430, the user/Reward Creator is given a checklist of options 432 to select. The checklist of options 432 include various social networking sites or any website that accesses or contains the user/Reward Creator's contacts. The user's bounty or reward is displayed or distributed to the user/Reward Creator's contacts at the selected sites. Upon selection of one social network site, a second interface 434 is displayed where the user enables the sharing and distributing of user's bounty or reward through the selected site(s). Once the sharing function is enabled for the selected network or web site, a confirmation interface 436 may be presented before the posting is shared. The posting of the bounty or reward is shared once the user clicks on the share button of the interface 436.

FIG. 4C is a screen view example of a Reward Creator's bounty or reward Posting 462 posted on a social network interface 460. The Posting 462 may be generated when the user confirms the posting on confirmation interface 436. The Reward Creator's bounty or reward Posting 462 links to the Reward Creator's goal or need page. The Reward Creator's bounty or reward could be stated in the Posting 462. The Posting 462 is made available to all contacts associated with the user's social network account and who have access to the interface 460. In other embodiments the integration of the Posting 462 allows for the Post 462 to be embedded within the social network interface or browser 460. The Reward Creator's bounty or reward could be stated in the Posting 462. The Posting 462 is made available to all contacts associated with the user's social network account and who have access to the interface 460. The Reward Creator is thus able to distribute the Reward Creator's bounty or reward to the Reward Creator's contacts within the social network without having to leave the social network site. Additionally, integrating directly into the social network or social communication platform may optimize the placements of the Reward Creator's bounty or reward posting.

The distribution of the Reward Creator's goals or needs and reward payouts for helping the Reward Creator fulfill the Reward Creator's bounty are made possible by the incentive system's 150 ability to monitor and track the success of the individuals on the social networks and other social communication platforms that are acting as agents while tracking the individual who successfully fulfills the Reward Creator's bounty or reward.

This process of posting the bounty or reward can be repeated for selection of other social network sites to share and distribute through. In this example, the user has selected Facebook for illustration purposes. As a result, the user's contacts will see the goal and reward displayed at the respective site, as shown in the final approval interface 436. An alternate iteration is the Reward Creator would be able to select multiple social network sites in a second window and then the Reward Creator would be able to share and distribute the bounty or reward through all of the selected social network sites.

FIG. 4D shows various screenshots of another social network site as another illustration of how a Reward Creator distributes goals or needs to contacts, according to another embodiment. In this example, the user has selected Twitter at interface 438, which opens an interface 440 that is customized to distribute user's goal to share with user's contacts in user's Twitter account. Interface 440 may be presented as a confirmation page before the posting is shared and distributed. The user may click on the “Tweet” button to initiate the sharing on the user's Twitter account. Once submitted the posting is displayed as shown in example 454 in FIG. 4E, as described below. In another iteration the system will handle the action of tweeting the posting automatically.

FIG. 4E is another example of posting the Reward Creator's bounty or reward on another social network, according to some other embodiments. In this example this posting could be the result of the user clicking (or the system could do this automatically) on the “Tweet” button at interface 440 of FIG. 4D, and is distributed to any contact who follows (i.e. is connected to) the Reward Creator at interface 454. The posting may appear as a newsfeed, snippet, headline or the like (collectively a Twitter posting 456). The Twitter posting 456 may be associated with a unique URL to access information about the reward, the Reward Creator, users who share the reward, and so on. By clicking on the unique URL in this posting, a member, follower or visitor on the social network or social communication platform may be directed to the goal or need page 110. Again, the Reward Creator could be an individual, a company or an organization.

FIG. 4F is yet another example of a social network site that a Reward Creator may share goals or needs with contacts, according to another embodiment. The reward goal and the incentive is posted on a business professional social network site displaying a LinkedIn interface 450. The Reward Creator's bounty or reward Posting 452 can be displayed to the Reward Creator's contacts in the activity feed or any other part of the social network that displays user content. By clicking on the unique URL in this posting, a member, follower or visitor on the social network or social communication platform will then be directed to the goal or need page. Again, the Reward Creator could be an individual, a company or an organization.

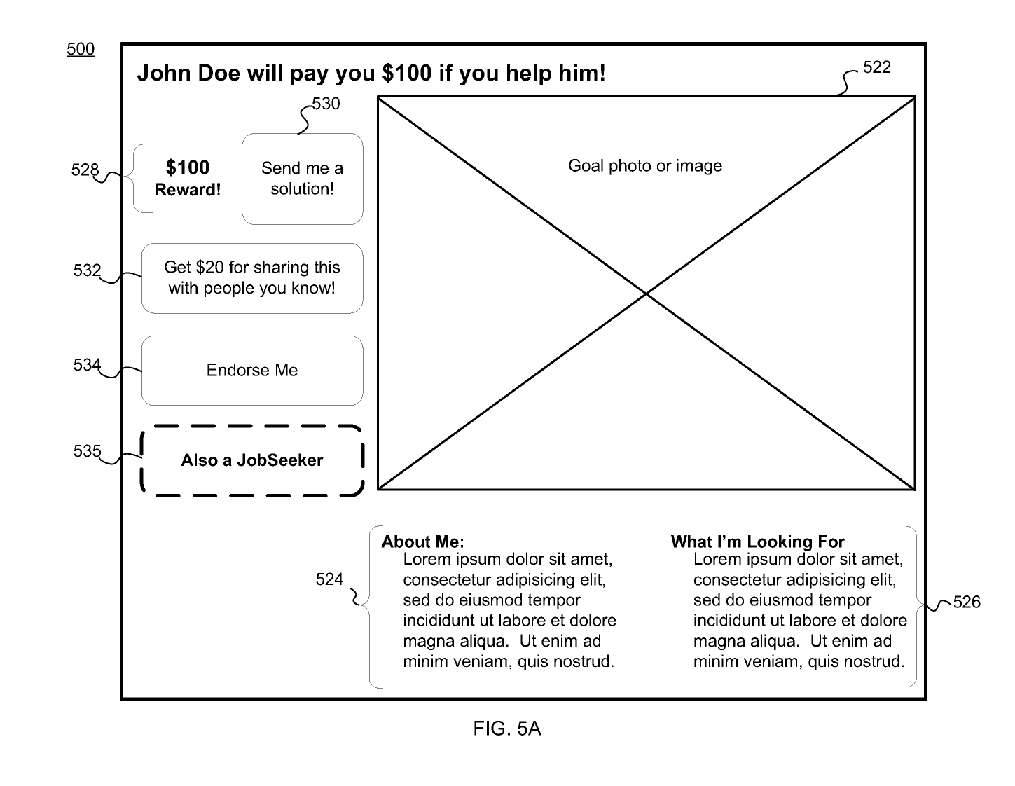

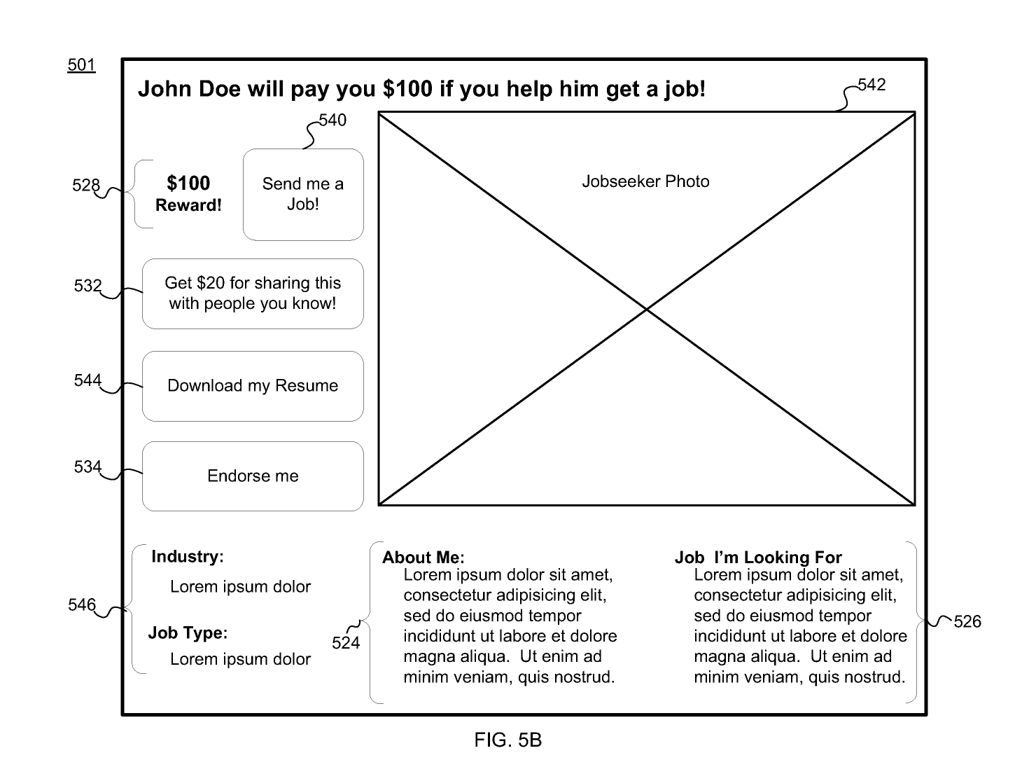

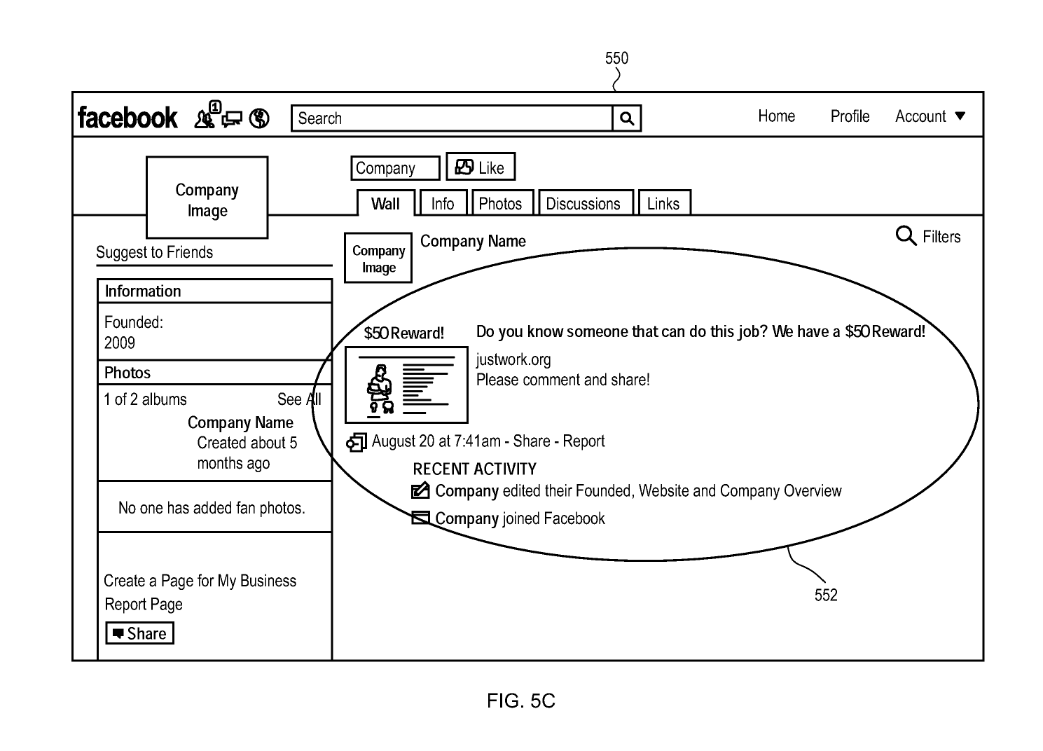

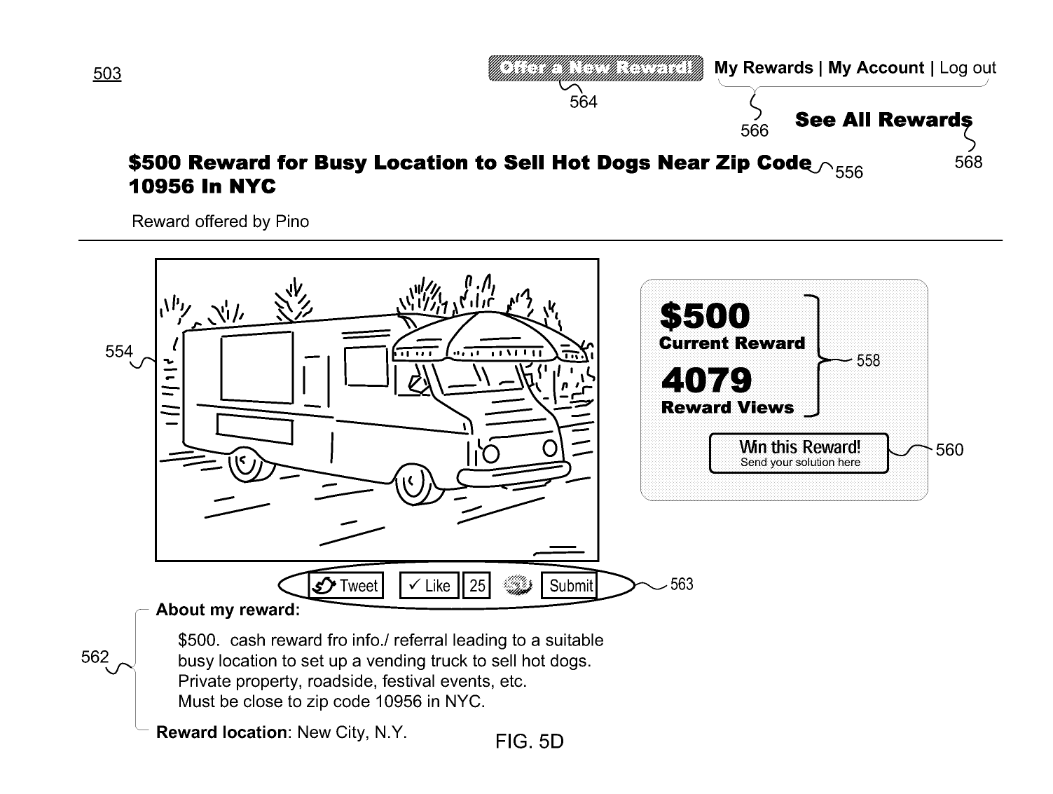

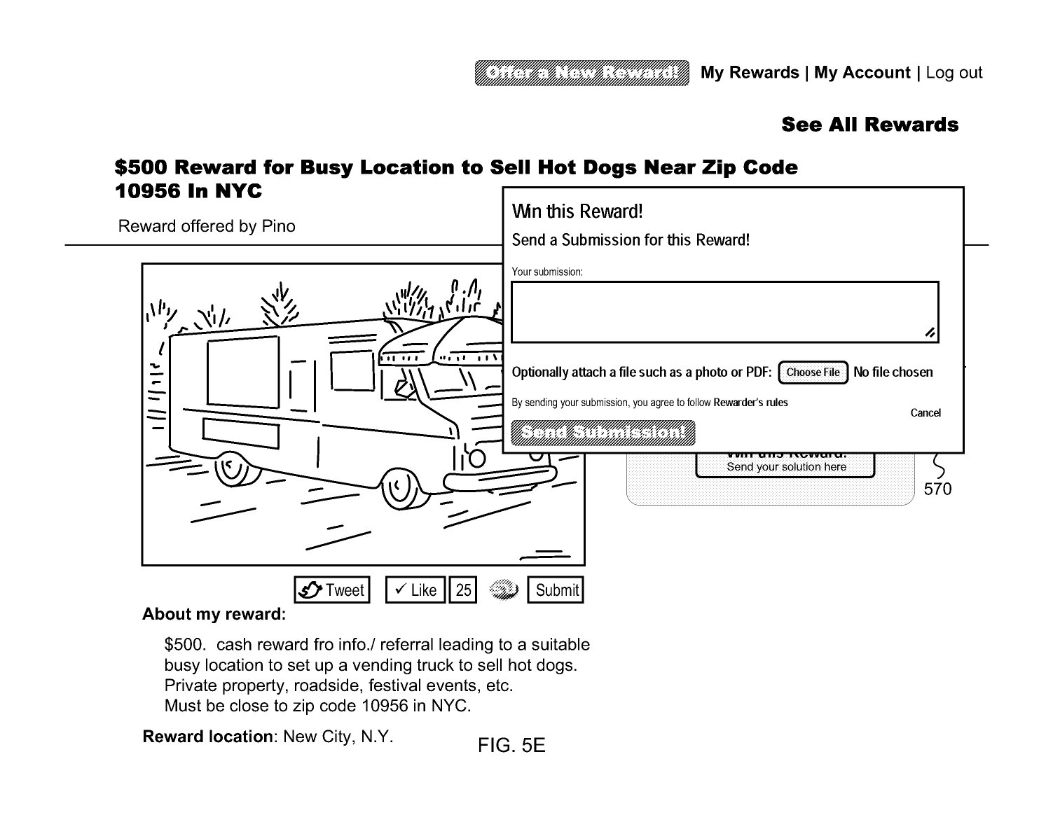

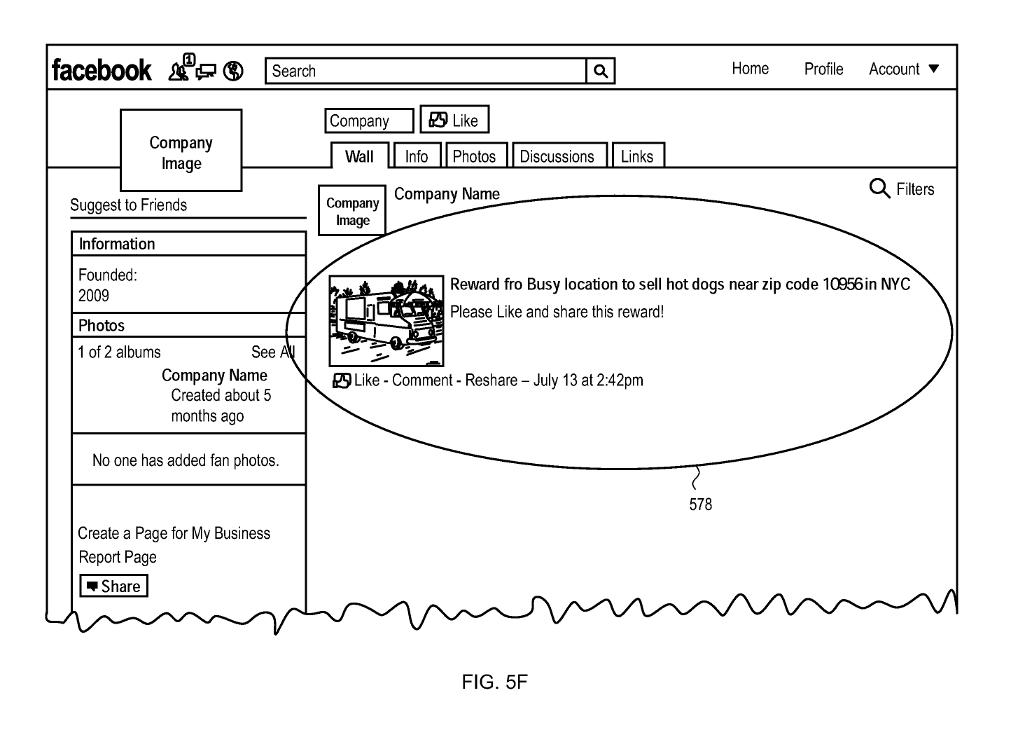

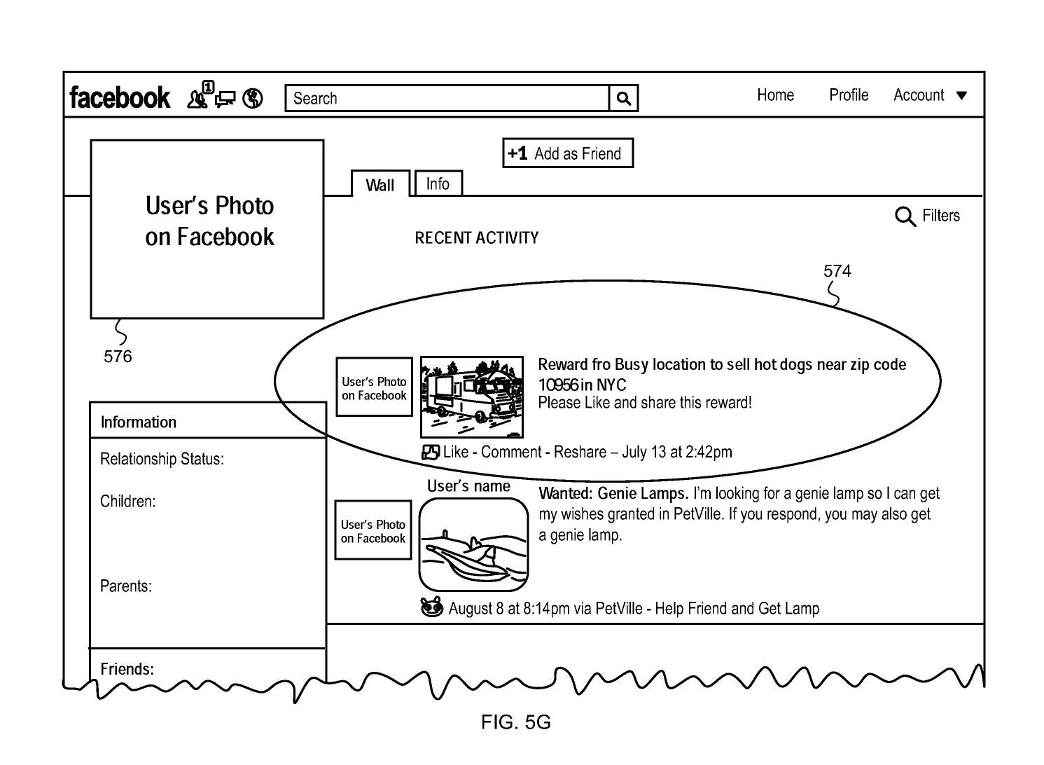

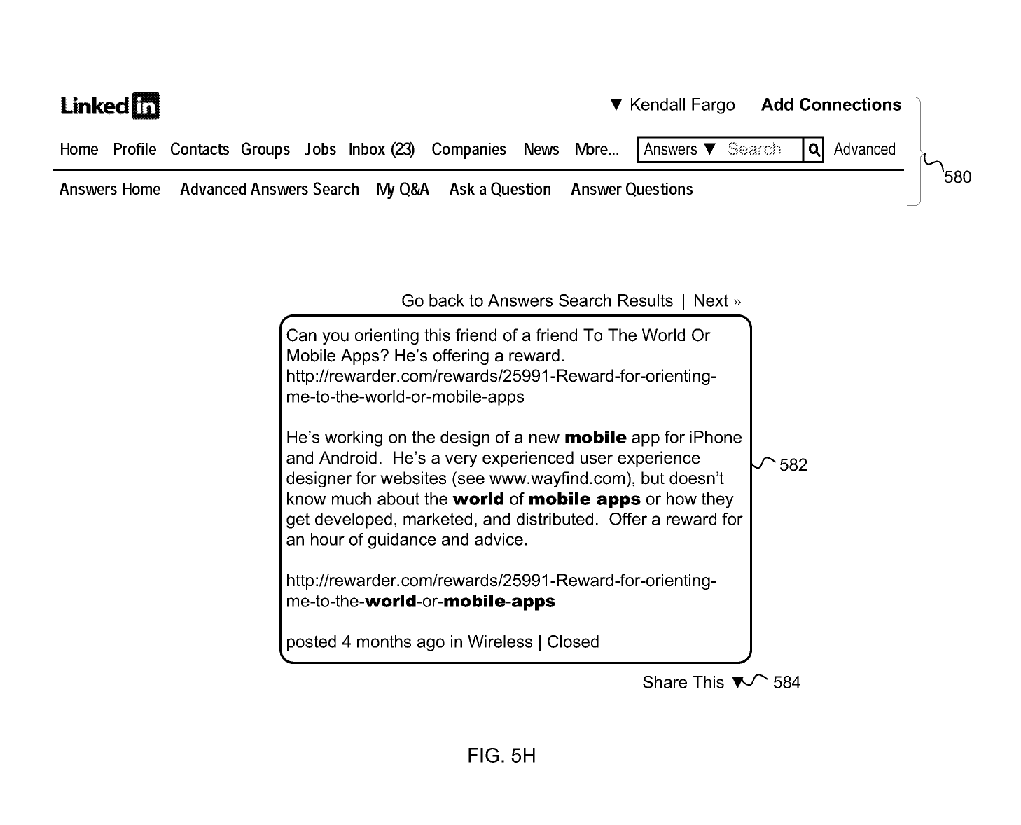

FIG. 5A is an example of a Reward Creator's goal or need page 500, according to some embodiments. The incentive system 150 uses the content supplied by the Reward Creator to create the goal or need page 500. The Reward Creator goal or need page 500 assists Reward Creators to best communicate the bounty or reward they are seeking along with reward they are offering to their contacts. The goal or need page 500 may include, but is not limited to, the following information: Reward Hunter signup information, goal or need category, goal or need details, Photo(s), Video(s), reward/bounty, Other content entered by the Reward Creator, Geo location requirements, customized requirements, and so on.

Content received from the Reward Creator (signup info, bounty category, bounty description, photos, etc.) is used to create the Reward Creator goal or need page 500 for each Reward Creator. The incentive system 150 may also create a unique URL for each Reward Creator goal or need page 500, so that a unique page can be provided for each Reward Creator. Additional custom URL(s) may be created for the goal or need page 500 every time the goal or need page 500 is shared.

This unique URL can be integrated in many different ways to attract the attention of potential agents or people who may be interested in winning the reward. Some examples include, but are not limited to:

A) The unique URL can be integrated into a widget of software code that can be incorporated into a website of the Reward Creator or any other website. The widget would be able to display the reward amount and details and, when clicked, can direct the individual to the goal or need page 500.

B) The unique URL may be incorporated into an email or other messaging platform, so it can easily by forwarded. Anyone would be able to click the link to be directed to the goal or need page 500.

C) The URL could be incorporated into an application like a mobile application or social network application that would display the reward amount and details and then direct any individual back to the goal or need page 500.

The system may additionally track any activity or interaction with the Reward Creator's goal or need page 500 when individuals other than the Reward Creator view it. Additional information about the bounty may also be displayed on the Reward Creator's goal or need page 500. If feasible, a goal or need photo or image 522 may be displayed on the goal or need page 500. Information about the Reward Creator may also be provided as illustrated by example in the “About Me” section 524. The goal or need page 500 may additionally provide further information or description of the bounty or reward in, for example, a “What I'm Looking For” section 526.

The Reward Creator goal or need page 500 also displays the current bounty or reward incentive 528 being offered by the Reward Creator. The Reward Creator goal or need page 500 also has functionality built into the page that makes it easy for anyone who views the Reward Creator goal or need page 500 to help the Reward Creator with the Reward Creator's bounty. The Reward Creator goal or need page 500 includes a button for trying to win the bounty or reward, e.g., “Send an Opportunity”, “Send me a solution” or “Win this Reward” button 530 which connects to the easy-to-use messaging platform of the opportunity/lead processor, so that people can send messages about solution opportunities to the Reward Creator. This button on the goal or need page 500 along with messaging lets people know that they can earn the bounty or reward by helping the Reward Creator fulfill the posted goal or need. If an individual decides to send the Reward Creator a solution opportunity then the system uses the Opportunity/Lead Processor 109.

If an individual wants to send an opportunity to the Reward Creator then they will click on the goal or need page's “Send me a solution”, “Send an Opportunity”, or “Win this Reward” button 530 which connects the individual to the Opportunity/Lead Processor 109.

The goal or need page 500 also allows anyone viewing the Reward Creator's goal or need page 500 to “share” and distribute the Reward Creator's bounty or reward with their contacts. The incentive system 150 displays the “share” button on the goal or need page 500, and, along with messaging, lets people know that they can potentially get a piece of the bounty or reward incentive by sharing. The individual who shares the Reward Creator's goal or need and reward may be allocated a percentage of the bounty payout if one of those contacts helps the Reward Creator achieve the Reward Creator's goal or need. In some embodiments, the incentive system 150 may use a new custom URL that is associated with the individual who shared, so that the individual can be rewarded with a percentage of the bounty incentive if any of the individual's contacts help the Reward Creator fulfill the Reward Creator's goal or need. When the individual chooses the communication platforms through which the individual will share the Reward Creator's goal or need and bounty incentive, the system then uses the bounty/reward split System 114.

In some embodiments, the button or link to share with other individuals may be incorporated into the web pages hosted by the communication platform or social network. The incentive system 150 may communicate the bounty incentive amount with the communication platform or social network, so that the social networks and communication platforms can automatically facilitate the sharing by integrating functionality that works with their system. This functionality makes it easier and automatic for a viewer to share the goal or need of the Reward Creator with other individuals across the network or communication platform (this could also include sharing across multiple networks). Additionally, the system may also reserve a percentage of the bounty incentive that would be paid to the social network or communication platform in payment for their facilitation efforts.

In order for the individual to share the Reward Creator's goal or need with the Reward Creator's contacts, the incentive system 150 may provide further instructions, e.g., via an interface, to request the contact or contact's contact to choose one or more communication platforms (many individuals will use multiple communication platforms to share) through which the Reward Creator's bounty may be shared.

The Reward Creator's goal or need page 500 may motivate the contacts who view the Reward Creator's goal or need page to share the Reward Creator's bounty with their contacts (either through the social network they are currently using or other social networks or communication platforms) by promising the contact a percentage of the bounty or reward incentive if one of the contact's contacts helps fulfill the Reward Creator's bounty. When the contact decides to share the Reward Creator's bounty with respective contacts the Reward Creator clicks the “share” button 532 on the Reward Creator's goal or need page 500. If an individual decides to share the Reward Creator's goal or need with the Reward Creator's contact, then the incentive system 150 uses the bounty/reward Distributor 108. The bounty/reward Distributor (not shown) is then used to allow the contact to choose to share and distribute the Reward Creator's bounty with respective contacts across social networks and social communication platforms that the contact uses. When the system distributes the Reward Creator's bounty to the contact's contacts and if the reward or bounty incentive is a different amount (as determined by the bounty or reward split Calculator), the Reward Creator's goal or need page 500 being shown to the contact's contacts will reflect the different bounty or reward.

Different unique URL's may be used for the Reward Creator's goal or need pages 500 that the contact's contacts will see. This allows for the display of unique or customized content (e.g., different bounty or reward amount, an endorsement from the contact who shared with the Reward Creator's contacts, unique reward content, customized reward amounts, and so on) on the Reward Creator's goal or need page 500 that the contact's contacts will see.

Additional functionality may be incorporated into the Reward Creator's reward page 500. An example of additional functionality includes, but is not limited to:
allow others to be able to publically endorse the Reward Creator, by submitting a recommendation that will be hosted by the system 150 and can be linked from the Reward Creator's goal or need page 500
display total amounts paid by the Reward Creator in past rewards
display the number of received submissions to win that reward
list all or some of the submissions that did not win the reward (to prevent repeats)
allow other people, businesses or organizations to also fund the reward
allow other people or businesses to also offer a similar or exact same reward
display Reward Creator's reputation, rating, status, such as displaying a score or response rate
display how much of the reward has been prepaid.

The incentive system 150 also allows people to publicly endorse the Reward Creator by entering a text description that will be linked to the Seeker's goal or need page 500. In order to make an endorsement, the user can click on the “Endorse Me” button 534. The incentive system 150 opens up a screen so that endorsement can be written. The system may also make the goal or need pages 500 easily indexed by search engines, so that they can be included in search engine results. The goal or need page 500 may additionally include an “Also a JobReward Creator” button 535 for users who are also looking for a job. When the “Also a JobReward Creator” button 535 is selected, the user may optionally set up an account or be directed to the user's own (new or existing) goal or need page. In some embodiments, the individual may be able to make an endorsement using Facebook's “like” button to show that they like the Reward Creator, the goal or need or reward.

Individuals who view the Reward Creator's goal or need page 500 may be able to interact with the goal or need page 500 by, for example:
sharing the Reward Creator's goal or need with other contacts through the social networks or communication platforms
sending a solution for the goal or need to the Reward Creator
endorsing the Reward Creator
asking a question to the Reward Creator
rating the performance of the Reward Creator

In another embodiment, the Reward Creator's goal or need page 500 can be integrated directly into a social network or other communication platforms. This integration could either be completely integrated into the social network or be an embedded or framed integration with a social network (like Facebook applications). This could allow the Reward Creator's goal or need page 500 to be hosted within the social network or social communication platform, so that members of the social network or the social communication platform would never have to leave the social network or social communication platform to view and interact with the Reward Creator's goal or need page 500. This integration may also allow the functionality of the Reward Creator's goal or need page 500 like the goal or need page Share button 532 that is linked to the distributor engine 108 of FIG. 1A and the “Send me a solution” button 530 which connects to the easy-to-use messaging functionality of the opportunity/lead processor 109 of FIG. 1A to be incorporated into the social network or social communication platform to facilitate the ability for other users to help the Reward Creator.

FIG. 5B is another example of a Reward Creator's goal or need page 501 that illustrates a page displaying a goal or need of getting a job, according to some other embodiments. The goal or need page 501 includes some of the same features as the goal or need page 500. In the interest of brevity, these same features have the same reference numerals and are not described again. The goal or need page 500 is customized for a Reward Creator's goal or need of obtaining a job. Instead of a solution to some specific goal or need, since the goal or need here is to get a job, the goal or need page 501 includes a “Send me a Job!” button 540. When a user/contact finds a job to recommend to the Reward Creator, and to collect the bounty, the user clicks on the “Send me a Job!” button 540. As in the goal or need page 500 of FIG. 5, the Reward Creator may display a photo of the particular Jobseeker 542. To facilitate the job hunt, the Reward Creator may provide a resume, which the view may download by clicking on the “Download my Resume” button 544. The Reward Creator may provide addition information about the particular job being sought by include information 546 such as “Industry” or “Job Type” on the goal or need page 501.

FIG. 5C is another example of a posting of a goal or need 552 on a social network site 550, according to some embodiments. FIG. 5C illustrates that a Reward Creator may also be a business or an organization seeking an item or service, such as filling a job position, instead of an individual seeking the same. Thus, the social network site 550 is an example of a business' Facebook page. The business or organization can use bounties or rewards to motivate members, followers or visitors to its page(s) on a social network to help with a goal or need. A member, follower or visitor who sees the bounty or reward posting can follow the link to the goal or need page (not shown) of the business or organization.

Other examples of how businesses may utilize the services of the incentive system 150 to offer rewards include, but are not limited to:
Reward for help filling a job opening
Reward for getting referrals for specific types of customers
Rewards for finding unique items that the business needs

FIG. 5D is a screenshot illustrating another example of a Reward Creator's reward page 500 that describes a need for a business location, according to some other embodiments. A reward page 503 describes, in a title field 556, a reward of $500 to anyone who can help this Reward Creator find a location for the Reward Creator's food truck business selling hot dogs. In this example, the Reward Creator is requesting locations near a particular zip code. It will be appreciated that the reward page 503 is constructed differently from reward page 500 because the goal or need requested by the Reward Creator for reward page 503 is different from the goal or need of the Reward Creator for reward page 501.

This reward page 503 also includes a photo 554, in this case, the photo of the food truck. Instead of a description about the Reward Creator in reward page 501, a detailed description 562 is provided about the food truck business, reward information 558 is also provided indicated the current value of the reward incentive ($500) and the number of views of this reward (4079). If a viewer, such as a Reward Hunter, has a potential business opportunity that may meets this need, the Reward Hunter can submit the solution opportunity by clicking a “Win this Reward!” button 560. A viewer may also forward this reward to other websites or comment on this reward to other people by selecting one or more website icons 563. Other combinations of website links 563 may be displayed.

If the viewer is accessing this reward after logging into the incentive system 150, the viewer may have the option of accessing additional account services 566 to, for example, view his or her own account information, status of other rewards that they tried to win and rewards created. The viewer also has the option of seeing more or all rewards by selecting a “See All Rewards” link 568. Selecting the link 568 may display any group of rewards that may be determined by the incentive system 150. For example, a group of rewards based on a category or a range of time. The viewer has the option of creating another reward by selecting a “Offer a New Reward” button 564. Selecting this button 564 may redirect the viewer to a page similar to the user interface 200 of FIG. 2A.

FIG. 5E is a screenshot illustrating a pop-up window 570 for submitting an opportunity, according to some other embodiments. Selecting the “Win this Reward!” button opens and displays window 570 for submitting an opportunity to a Reward Creator. The window 570 includes a field for describing the solution opportunity and attaching additional documents that may provide more details about the solution opportunity. The window 570 also includes a button for submitting the opportunity. In this manner, the opportunity submission can be correlated to the reward page 503 and submitted to the appropriate Reward Creator.

FIG. 5F is a screenshot example of a posting of the reward page 503 on social network site 550, according to some embodiments. The social network site 550 is that of a business Facebook page that includes a posting of information from the reward page 503 seeking a location for selling hot dogs. The information from the reward page 503 may be a headline, a news feed, a snippet, or any information about the reward, collectively a reward headline 578. The reward headline 578 may include URL links to the reward page 503, and other links for posting comments and/or sharing the reward on this website or another website.

FIG. 5G is a screenshot example of a posting of the reward page 503 on a social network user's page or a social network site 574, according to some embodiments. In this example, the Facebook page belongs to a Facebook user, not a business. The reward page 503 was forwarded on to the Facebook page 574, for example by selecting from the group of links 563 on the reward page 503. Details from the reward page 503 can now be displayed to Facebook contacts of the viewer who forwarded the reward like reward posting 576 in Facebook page 574.

FIG. 5H is a screenshot of another sample reward posting 582 on another social network site, a LinkedIn site 580, according to some embodiments. The sample reward posting 582 in this case is a text announcement of a reward posting on LinkedIn. In other embodiments, photos and other media content may be utilized in the posting 582. The LinkedIn posting 580 may included additional features unique to LinkedIn, but useful to a Reward Creator, such as a “Share This” link 584 to further distribute the reward posting.

FIG. 5I is a screenshot of another example of posting a reward on yet another social network site, Twitter site 586. In this example, a twitter-like text posting 588 is displayed containing details of a reward.

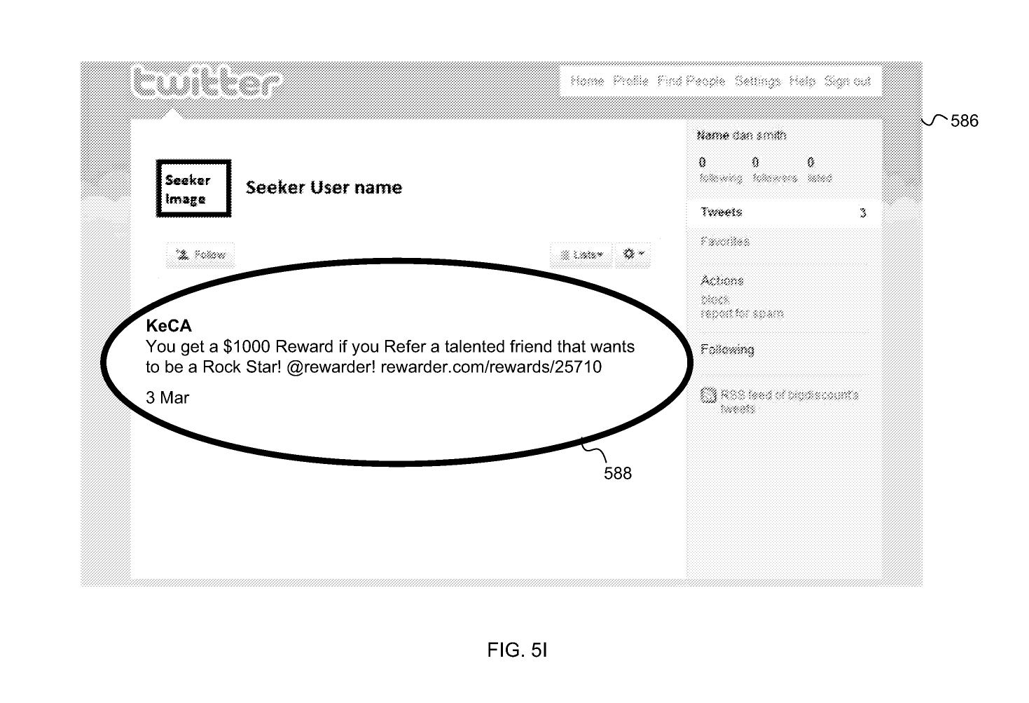

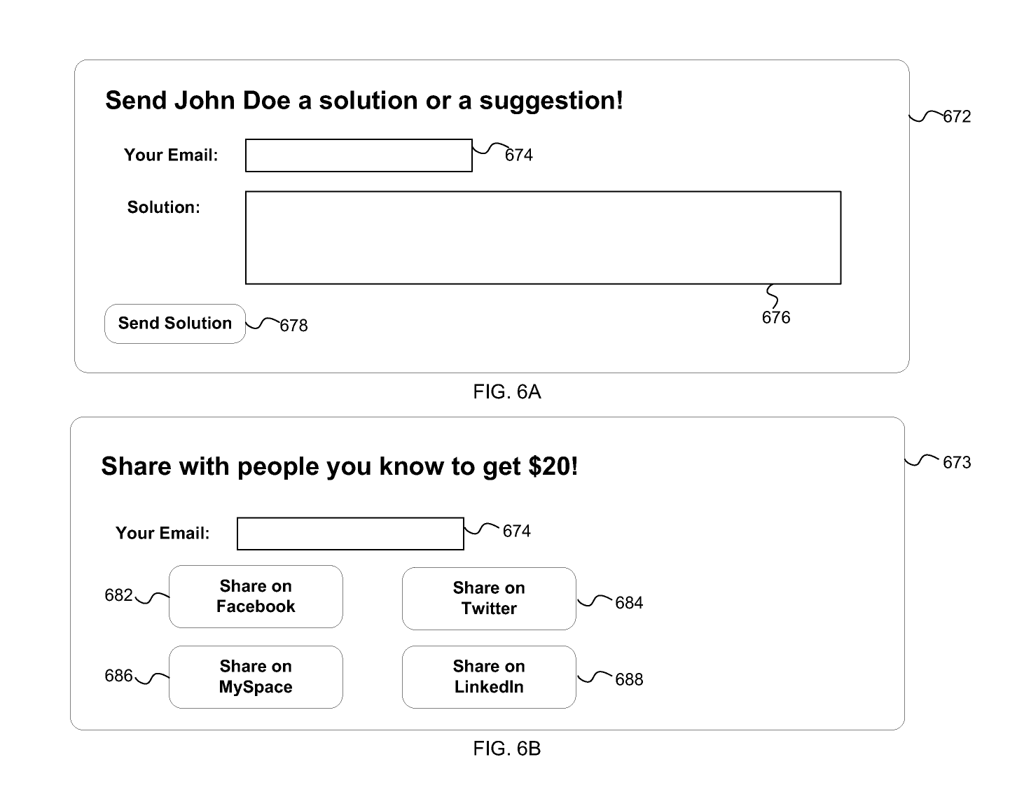

FIG. 6A illustrates a contact user Interface (“UI”) 672 for the Opportunity/Lead Processor 109 of FIG. 1A, according to some embodiments. The UI 672 includes a “Solution” filed that a contact would use in providing a solution opportunity o the Reward Creator. The UI 672 also includes an email (or other communication platform like SMS, social network user name, etc.) field 674 so that the Reward Creator or the system 150 may respond to or communicate with the contact. Once the solution field 676 has been completed, the contact clicks on the “Send Solution” button 678 to send the message to the system 150 for further processing. The UI 672 could also have a button (not shown) for uploading a file. This would allow people trying to win the reward to upload documents, photos or other files that would then be delivered by the Opportunity/Lead Processor 109 to the Reward Creator.

FIG. 6B illustrates an agent UI 673 for the distributor engine 108 of FIG. 1A, according to some embodiments. The agent UI 673 is used by a contact acting as an agent, who desires to share the Reward Creator's goal or need and a bounty or reward with the incentive with the contact's contacts using the distributor engine 108. The contact/agent provides the system with an email address in the email field 674 (or this could be another other communication platform like SMS, social network user name, etc.) for tracking and other purposes of the incentive system 150. The contact/agent has the option of selecting one or more communication platforms such as social network sites 682, 684, 686, and 688 to which the contact/agent belongs to such that the distributor engine 108 may disseminate the Reward Creator's goal or need and bounty information.

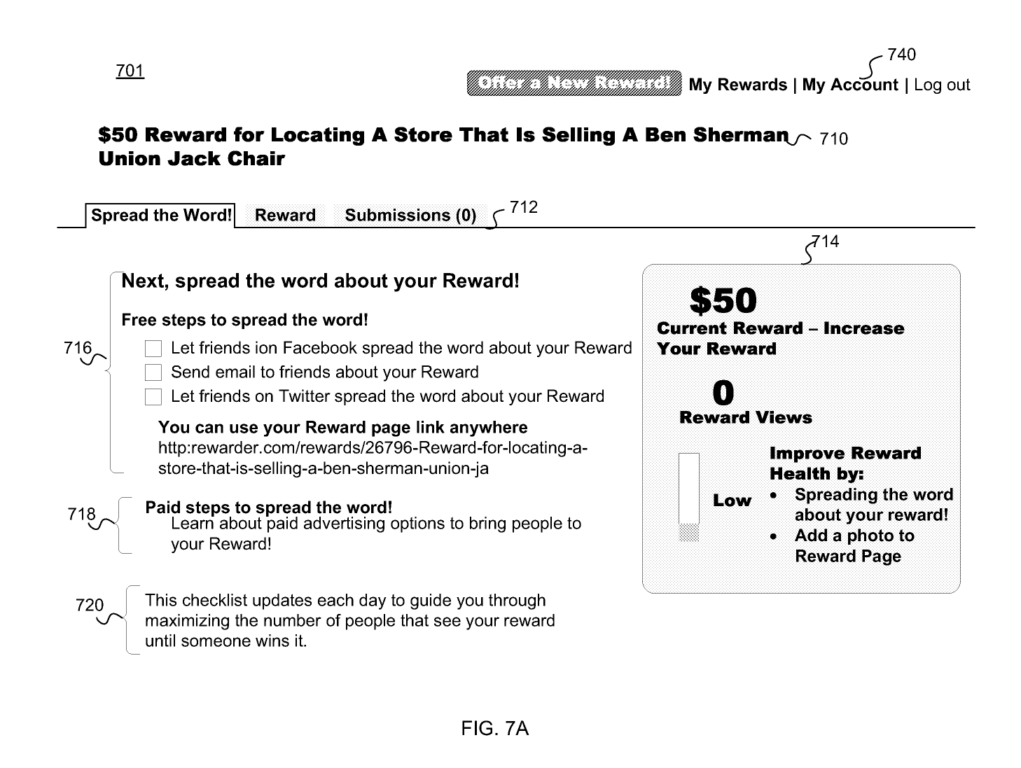

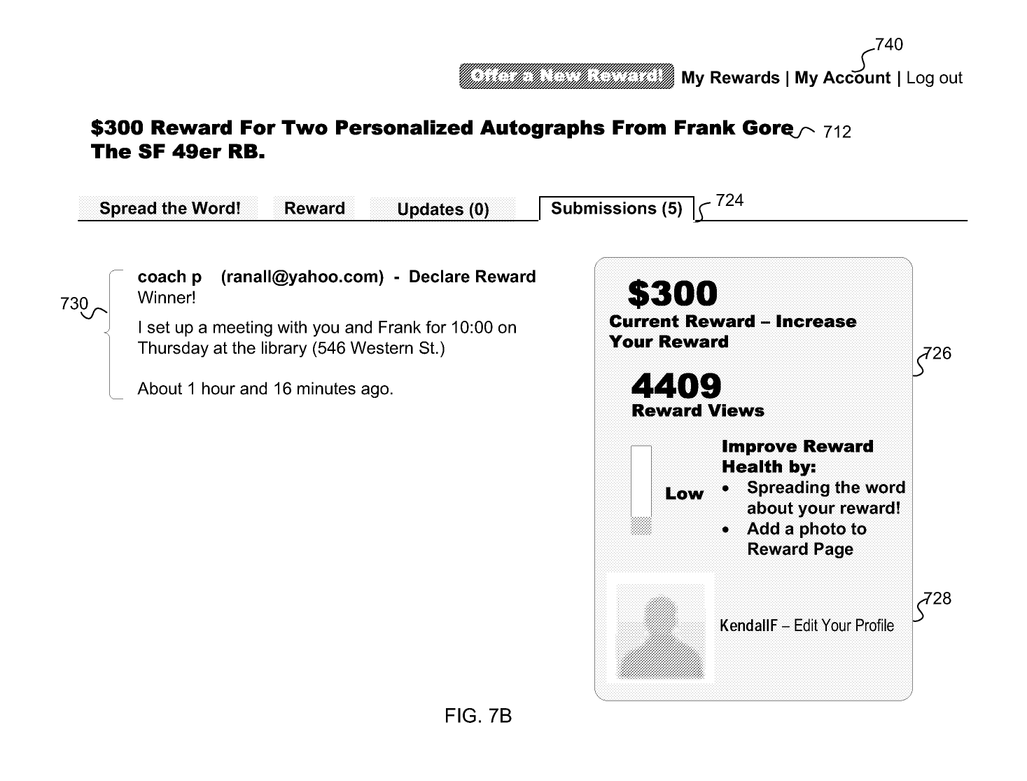

FIG. 7A illustrates a Reward Creator's user interface 701, after reward 710 has been created, according to some embodiments. The Reward Creator may manage the status of the reward 710 and sharing the reward 710 from the user interface 701. The user interface 701 may include several tabs that, upon selection, directs the user to different pages for managing different aspects of the user's account. For example, a Spread the Word! Tab directs the user to a page 712 for distributing the reward posting to various platforms. These distribution channels may be subdivided into different categories such as free distribution option 716 and paid distribution grouping 718. In the free distribution option 716, the user can select to pass on the reward posting to one or more platforms without having to pay a service fee. These options include social network sites, such as Facebook and Twitter, or by email. Other options may be listed. From the paid distribution option 718, the user has the option of paying for the reward posting to be distributed as an advertisement to select websites, such as for example businesses who subscribe to services of the incentive system 150. This page 712 may include other information for the user, such as comments and instructions 720 and a reward status box 714. In the reward status box 714, options to view the status of one's reward, change the reward value, edit the reward and see the number of people who viewed the reward are displayed. Other account services may be accessed via links 740.

FIG. 7B illustrates a sample submission page 724 that is displayed when a user selects the submission tab. On this page 724, the user may review and manage received submissions. From the submission page 724, the user may view submissions and select a winner, which may then be posted on this page, such as winner posting 730. Detailed information about the opportunity submission may be provided on the winner posting 730. Like the Spread the Word! page, the submission page 724 includes a reward Status box 726. A user profile box 728 may also be provided in any of the tabs to allow the user to update his or her profile.

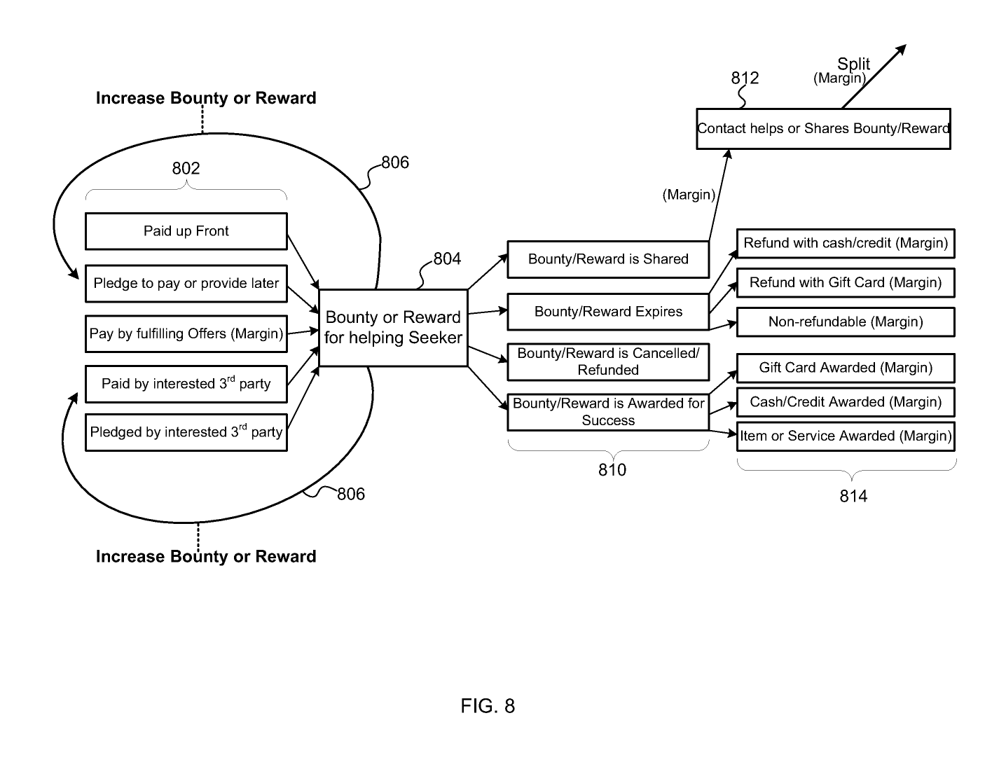

FIG. 8 illustrates different scenarios for a bounty or reward in the system 150, according to some embodiments. The bounty or reward 804 can be funded many different ways as shown by the various payment methods in list 802. The Reward Creator may pay the bounty or reward 804 upfront, the Reward Creator could pledge to pay or provide it later 0 and the Reward Creator could pay the bounty or reward 804 by fulfilling offers from merchants or advertisers. The status and/or character of the reward may be displayed on Reward Creator's goal or need page 110, 500, for example, indicating whether the reward amount has been fully funded, partially funded or promised to pay later.

The bounty or reward 804 may also be paid by an interested third party or the interested third party could pledge to pay or provide the bounty later (if bounty/reward is an item or service). In some embodiments, third party interest holders may be people who fund, sponsor, or enhance an individual's reward in any manner or for any reason. For example, if the bounty is a reward for a lost dog, and reward is shared over a social network (e.g., Facebook, email, mobile apps, and so on) some of the Reward Creator's friends may decide to add to the current reward. This would increase the overall size of the reward, instituting a larger incentive for anyone to submit to this bounty or reward. In other embodiments, an interested third party may offer a matching reward, thus increasing the number of Reward Creators associated with a reward or creating duplicates of the reward. For example, a first Reward Creator may offer a reward amount for a ride from San Francisco to Los Angeles. That bounty is then sent out through various social networks (e.g., Facebook, email, mobile apps, and so on). One or more friends/contacts may see the posting and decide that they also wants a ride to Los Angeles and then matches the initial reward by offering a similar incentive amount. Thus, a Reward Hunter can earn the initial reward and any matching rewards by giving the Reward Creator and co-Reward Creator(s) a ride to Los Angeles. Furthermore, one of the co-Reward Creators may offer a ride to everyone else in the pool. The incentive system 150 in this case could discount the reward posted by this co-Reward Creator and also award the co-Reward Creator all the other matched rewards.

In yet other embodiments, third parties could participate in a reward fund, for example to solve a crime. In one scenario, if a Reward Creator sets up a reward fund, others may be able to contribute to the fund. The reward may be increased by an aggregate of all the contributions. The incentive system 150 may facilitate setting up a fund with a Bank, create a trust, and so on. In the case of a crime, the reward may be for the arrest and conviction of the person or persons who are responsible for the crime.

The Reward Creator may decide whether the reward they are creating is something that other people care about and also let other people add money to the reward. This allows those other individuals to make the reward bigger and also promote it to other people who can help. The Reward Creator will determine on behalf of everyone involved whether the reward was won.

In some embodiments, all the people who decided to sponsor the reward may have the opportunity to vote on whether the reward was won. However, the Reward Creator may have certain controls being the one who created the reward. For example, the Reward Creator may create the reward and choose the option to let other people also add to the reward. The Reward Creator may also pick an end date for the reward to be won. If the reward is not won by the specific date then the funds are returned to the people who contributed the money. The Reward Creator may share the reward with others (through social networks, through the marketplace 120, and so on.) The Reward Creator oversees the submissions to the reward and responds to them.

In some embodiments the Reward Creator may select the winner. If the Reward Creator decides that there is a winning submission the Reward Creator declares that individual to be the winner (which gives the winner the funds from everyone who contributed money (sponsored) to the reward).

Additionally, individuals who sponsor a reward may be given limited privileges in the incentive system 150. A third party individual may click the “Sponsor this Reward” button. The sponsorship of the reward by adding more funds helps ensure that the reward will be accomplished. When someone sponsors a reward they also become an insider. As an insider to the reward, they get to see all the submissions to the reward by everyone who is trying to win the reward. The funds from the reward Sponsor could be processed through a payment system like PayPal or Amazon Payments.

In some embodiments, people who sponsor the reward may be able to use the incentive system 150 to get the word out to other people by leveraging the tools provided by the incentive system 150 that facilitate the communication of the reward through social networks and other communication platforms. This helps them spread the word about the reward as widely as possible.

Some of the functionality that a reward sponsor will have access to include, but are not limited to:
Get exclusive insight into the efforts to win the reward: When someone sponsors a reward they get to see all the responses to the reward by everyone who is trying to win the reward.
Be Publicly Recognized for your Sponsorship: The sponsor will be publicly recognized for the reward sponsorship (unless the sponsor decides to sponsor the reward anonymously.)
Modify or Cancel support for a reward: A reward sponsor can modify or cancel sponsorship of the reward anytime up until a winner has been chosen. Once the Reward Creator declares a winner all the funds from the Reward Creator and the reward Sponsors will be distributed to the reward Winner.

When a Reward Creator creates a reward and decides to allow other people to be able to also contribute to the reward then the incentive system 150 may provide some additional unique functionality. The incentive system 150 may require an end date for the reward to be won. If a winner is not declared by the end date then the rewards will be returned to anyone who sponsored the reward. When someone sponsors the reward our system will hold the funds in escrow (or a similar situation). We may allow the reward sponsors to adjust or cancel the amount they are contributing to the reward if a winner has not yet been declared. There is also a possible scenario where we only take payment information (like a credit card number or the Amazon account number) from the reward Sponsor and we will only use the payment information to withdraw the funds when a winner has been declared for the reward.

Bounties or rewards 804 can be increased 806 at anytime through any of these options. This includes the scenario where a Reward Creator may pledge to pay or provide the reward at a later time or upon the occurrence of some condition. Additionally, a Reward Creator may condition the incentive system 150 to automatically increase the reward over time (e.g., the reward could increase a specific amount or a percentage each day, week, upon the occurrence of one or more conditions or repeat conditions, and so on, or based on any other factors like increasing the reward after each wrong submission. It will be appreciated that the reward, as described previously, may be in any form that represents value, such as points, privileges, virtual currency and so on.

A number of different scenarios 810 may result. The bounty or reward 804 may be shared by the Reward Creator through social networks or other communication platforms with contacts or other individuals 812. Those contacts or individuals can then provide solution opportunities to the Reward Creator with the intent of earning the bounty or reward 804. The contacts or individuals can also share the Reward Creator's goal or need with their contacts across the various social networks they use. In this scenario the system 150 splits the bounty or reward 804, so the correct amounts can potentially be awarded to the individual who successfully helps the Reward Creator and also to the agent who shared the Reward Creator's goal or need with the individual who helped. In some cases if the Reward Creator's goal or need is not fulfilled within a specific period of time, then the bounty or reward 804 will expire.

The distribution 814 of the bounty or reward 804 may also vary. Depending on the terms of the bounty or reward 804, may be refunded with cash or credit, refunded with a gift card or it will not be refunded because the terms were non-refundable. In other cases the Reward Creator may decide to cancel the bounty or reward before the specific time period to receive a refund has expired. If an individual does fulfill the Reward Creator's goal or need, the individual and any agent who shared with that individual will be awarded their split of the bounty or reward incentive. This bounty or reward could be awarded as a gift card, as cash/credit or as an item, points or service. The bounty actions that are labeled with “(margin)” are actions where the system 150 could charge a portion of the transaction or receive a service fee.

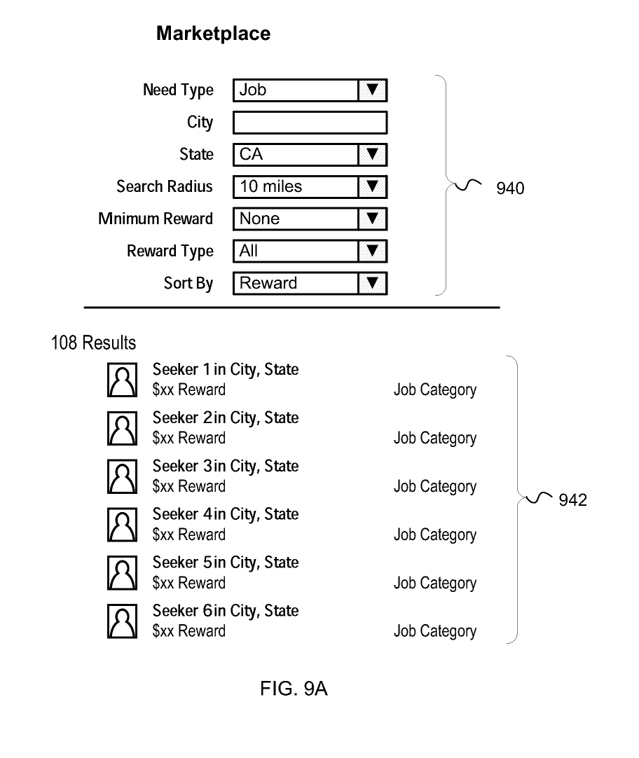

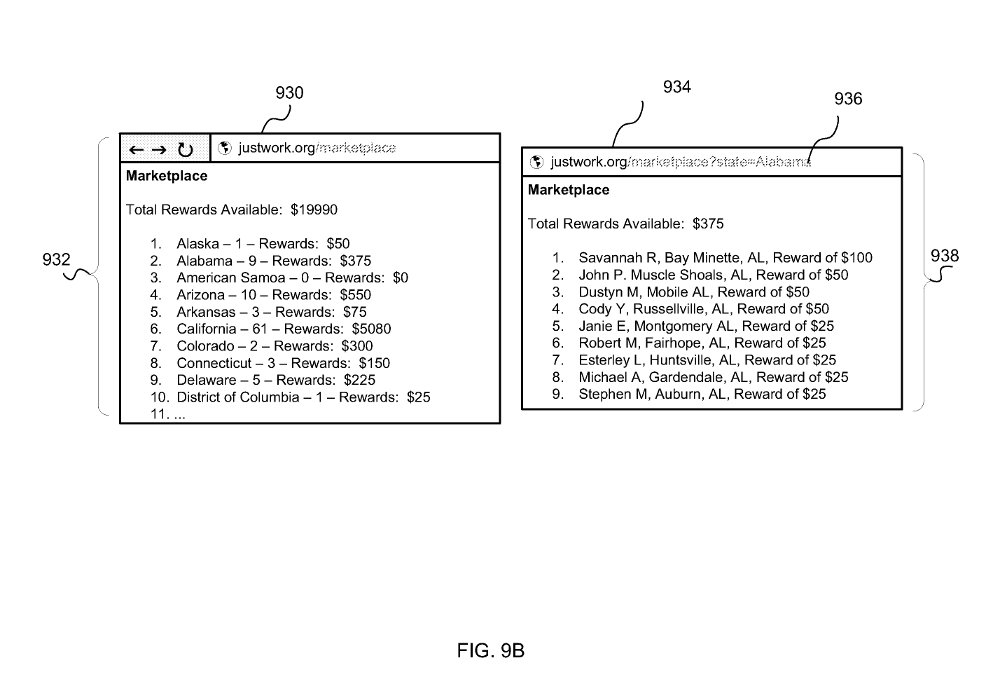

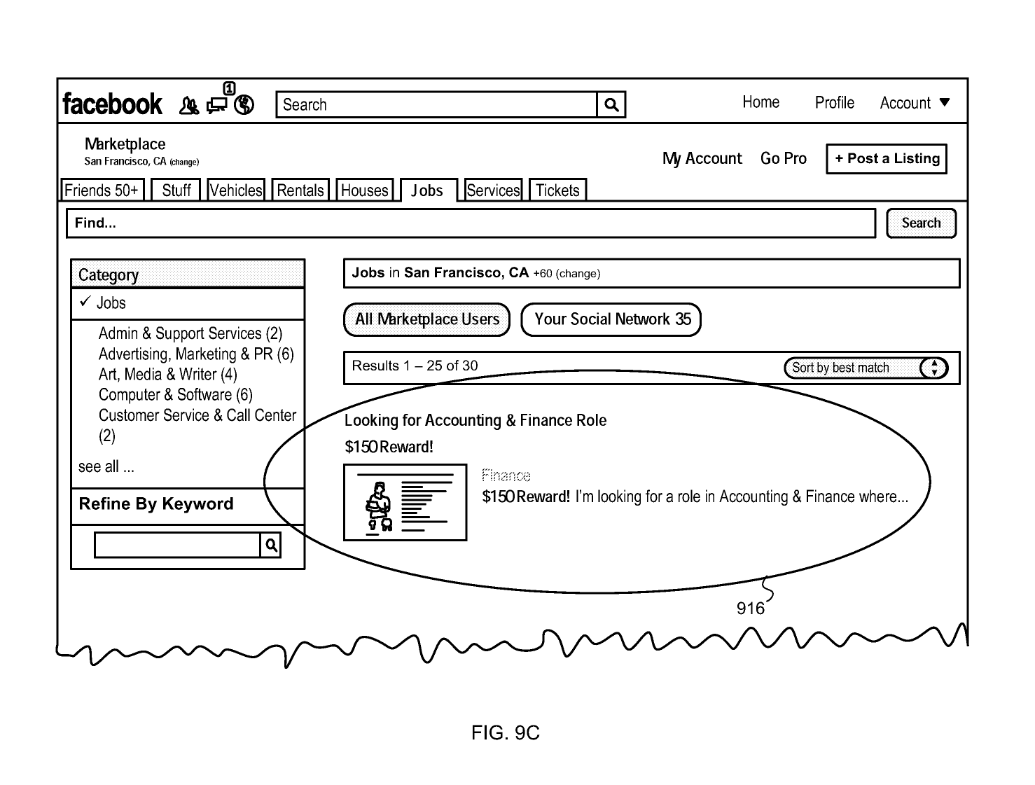

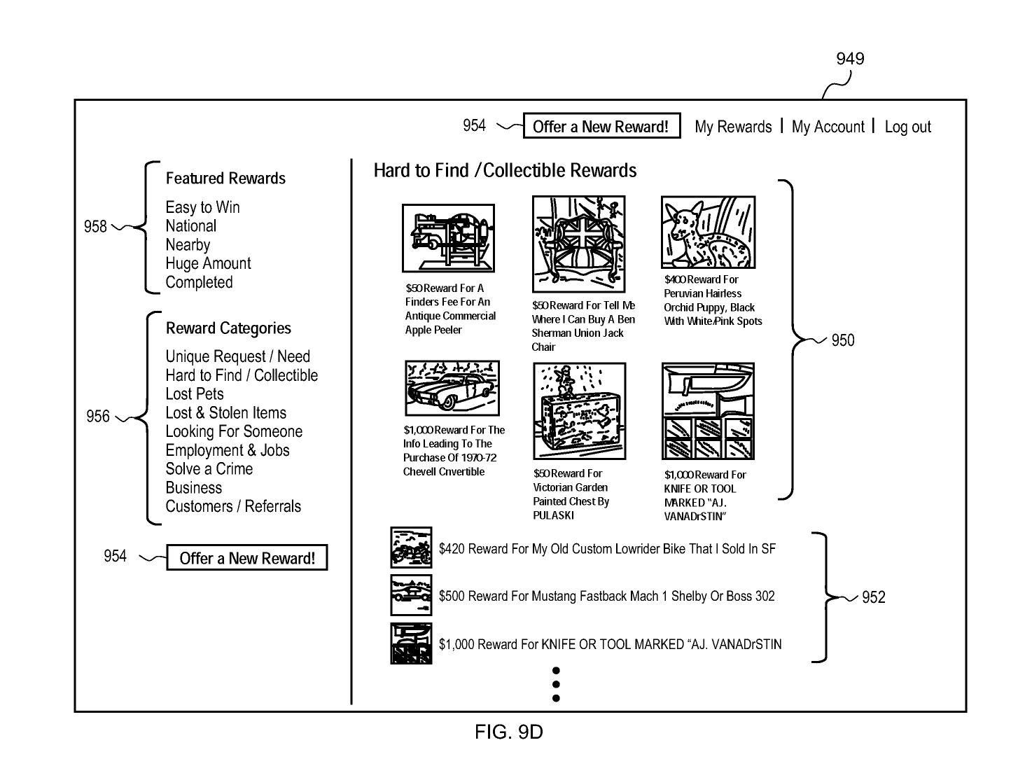

FIG. 9A illustrates sample search tool interface 940 of the Marketplace system 120 of FIG. 1A, where a user may search by various search categories such as need type, city, state, search radius, minimum reward, reward type, sort by and so on in a marketplace environment. Additionally, the data may be utilized for any search by any user or visitor of the incentive system 150, e.g., the Reward Hunter to be able to send or notify (via email, social network, mobile app, other communication platforms, and so on) when a new reward is being offered that matches any of the criteria they used when searching for rewards. The search tool interface 940 generates a search result list 942 according to the search results terms entered.

The incentive system 150 may use any number of factors in determining whether a user will be notified about a new reward. Some of those factors may include, but are not limited to:
Type of rewards that have interested them in the past
Their quality ratings on past submissions
Number of submission credits they have
User profile, activity history, interests, or demographic information

FIG. 9B shows examples of sorting bounties or rewards in the System Marketplace 120. Sorted lists 932 may be viewed on interfaces 930. This allows independent agents to find and view bounties or rewards that interest them. The marketplace 120 may be sorted in many ways including by Reward Creator location (state, city, zip code, distance from a geo location, etc.), Reward Creators that are connected to the individual in a social network, by goal or need category, by bounty or reward type, by bounty or reward amount, and so on. Individuals will be able to browse Reward Creators' goals or needs and bounties and rewards that interest them and then view any Reward Creator's goal or need pages. Interface 934 is an example of a sort request 936 according to the state of Alabama. As a result, a listing of marketplace users in Alabama 938 is displayed in interface 934.

In some embodiments, Reward Hunters may, e.g., in their registry or profile, indicate the types of rewards they are interested in so they can be notified about similar rewards. In some embodiments, the incentive system 150 tracks what rewards interest a user, such as any individual, Reward Hunter, or even Reward Creators. Such data may be utilized to assess user interests, preferences and/or needs to match new rewards or reward updates to appropriate users. More specifically, one or more algorithms may be utilized to retrieve and assess the data on a Reward Creator, specific Reward Hunters, agents, and other similar users to determine where to present or disseminate information about new rewards. The algorithm(s) may be based on input directly supplied by a user, Reward Creator, or Reward Hunter and also data collect from profile information, preferences, user activities, and so on.

FIG. 9C is a mockup of a Reward Creator's goal or need and bounty or reward from our system being fed into a third-party marketplace, such as Facebook's social network marketplace. This example shows a Reward Creator's Goal or need that is a job listing 916 having a bounty of $150 for an Accounting and Financing job.

One or more features of the Marketplace system's 120 features may be accessible via or integrated with third-party marketplaces through, for example, partnership agreements with third parties. In other embodiments, the Marketplace system 120 may provide a user interface marketplace tool that is separate from third-party marketplaces or web environments, which may be accessed via a separate URL link.

FIG. 9D is a screenshot example of a market place user interface (“UI”) 949, according to some embodiments. The Marketplace UI 949 may be accessed by a viewer who has logged in into the incentive system 150. The Marketplace UI 949 includes a gallery 950 of rewards to display to a viewer. The group of rewards to display in the gallery 950 may be selected by the viewer, based on criteria, or by preference. The group of rewards alternatively may be displayed in a list 952, or a combination of a gallery 950 and list 952. For example, most relevant rewards may be displayed in the gallery 950, and lower-ranked rewards may be displayed in the list 952. The market place UI 949 also includes additional features 958 that a user may select that may affect how the rewards are displayed or which rewards are selected to be displayed. A user may also select groupings of rewards based on reward Categories 956. As in other user interfaces, the user has the option of creating a new reward 954 or managing the user's account.

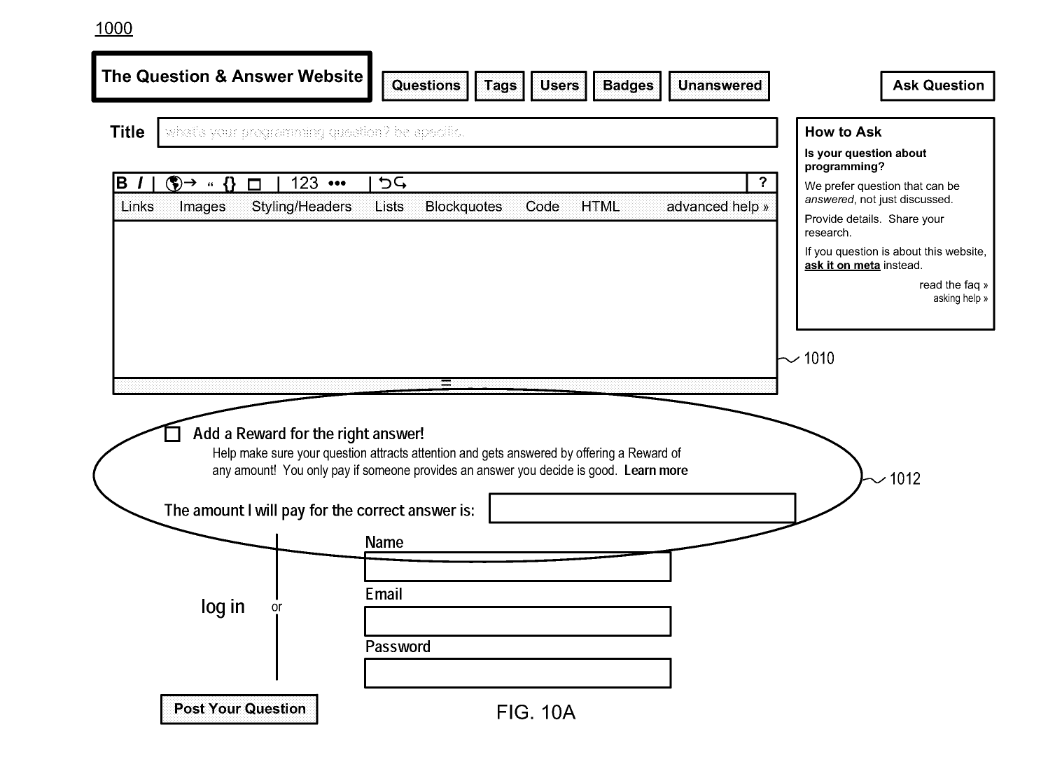

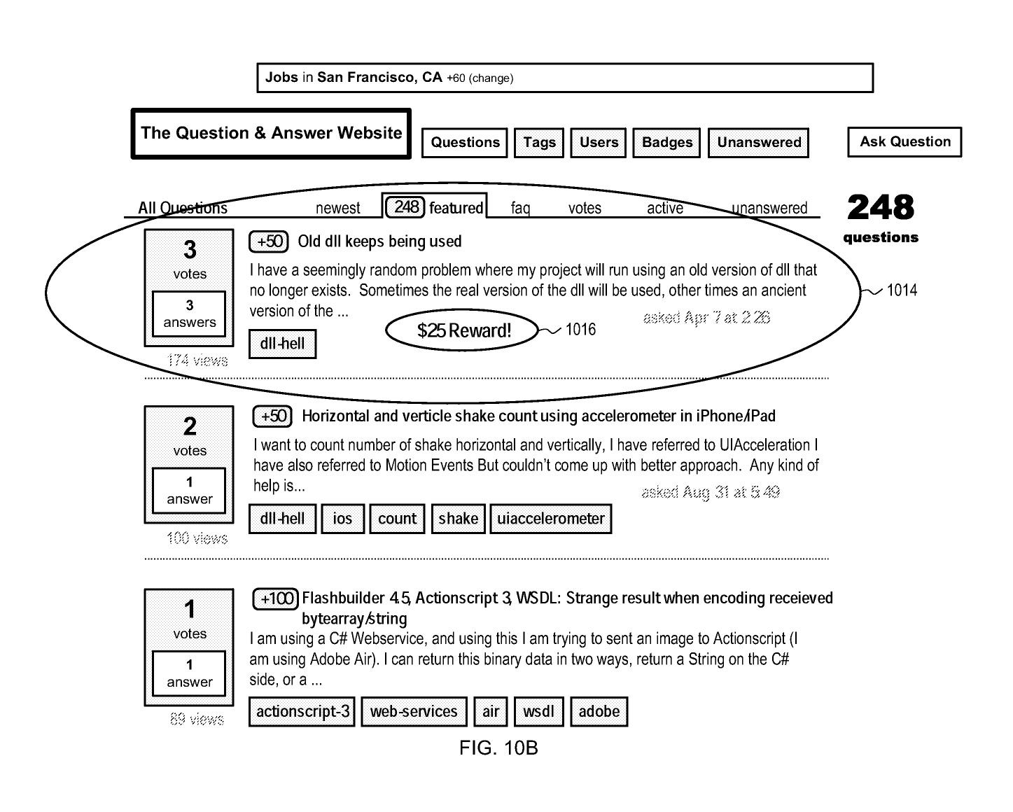

FIG. 10A is a sample integration interface 1000 for creating and posting a reward on a website of a third party service provider who may partner with the services provided by the incentive system 150. Many websites have user post content that involves requesting a response or solution, but the content typically gets few or even no responses. These third party content sites may have users express a particular need or something they are searching for, such as Classifieds site, Q & A sites, Lost Pet or Lost Item Sites and so on. By offering a reward for a response or a solution, people now have an incentive to respond to these requests, and could enhance the probability that people would now respond. Because it is not realistic for these content websites to build a complicated infrastructure, such as incentive system 150, the system 150 may for a subscription integrate one or more of its features with the third party's website. Thus, their users will be able to use features of the incentive system 150 to create rewards or bounties directly on their websites. The rewards and bounties may be show with the user posted content to incentivize the responses or solutions they are seeking.

For example, integration interface 1000 services “The Question & Answer” website, where people who post questions can now attach a reward to incentivize others to respond to it. The interface 1000 includes a field 1010 for posting a question and an “Add a Reward” feature 1012 for associating a reward incentive to the questions. When creating a question in the field 1010, the user encounters a checkbox of the reward feature 1012 allowing them to optionally offer a no-risk reward for a successful answer/solution. Checking the box allows them to enter a reward amount. The user may optionally sign into their existing incentive system 150 account and create the same reward for the third party website.

As in previous cases described, the rewards or bounties being generated on these partner sites may also be distributed through the user's social networks and communication platforms using services through the incentive system 150, such as the distributor engine 108 and opportunity/lead processor 109. The Reward Creator on the third party site will be able to share the reward with contact using the sharing tools of the system 150. The third party site might also allow for unique targeting of the reward to specifically qualified users or members of the third party site.

Basically, through this partnership, the third party site listing/posting now shows a reward that is powered by the incentive system 150. Thus allowing the user to utilize the features of the incentive system 150. The reward may also be shown on third party sites of the system 150, such as the Marketplace 120. The reward, even though created on the third party site, may be distributed by the user to their contacts using the tools available via the system 150. People can answer questions or provide solutions on third party site as normal. The third party site tells the incentive system 150 (e.g., via standardized API) that the reward was won, who the Reward Creator and winner were. Winning the reward may require submitting a solution via the incentive system 150 to the Reward Creator or submitting via the third party site that is enhanced to access the incentive system 150. The incentive system 150 may also handle the payment transaction in any manner previously described. The partnership may include an arrangement for payment of part of the transaction fee to the third party site.

Integration may be achieved using two main integration paths, however other paths are possible. Integration may be a custom integration with designated partner or a turn-key integration with an existing platform. The integration opportunity may be for pre-approved partners only or open to anyone and may be a self-service.

FIG. 10B is a screenshot illustrating posting a reward on the third party site “The Question & Answer” after creating it on interface 1000. In the list of questions posted, one question 1014 includes a $25 reward 1016 for responding.

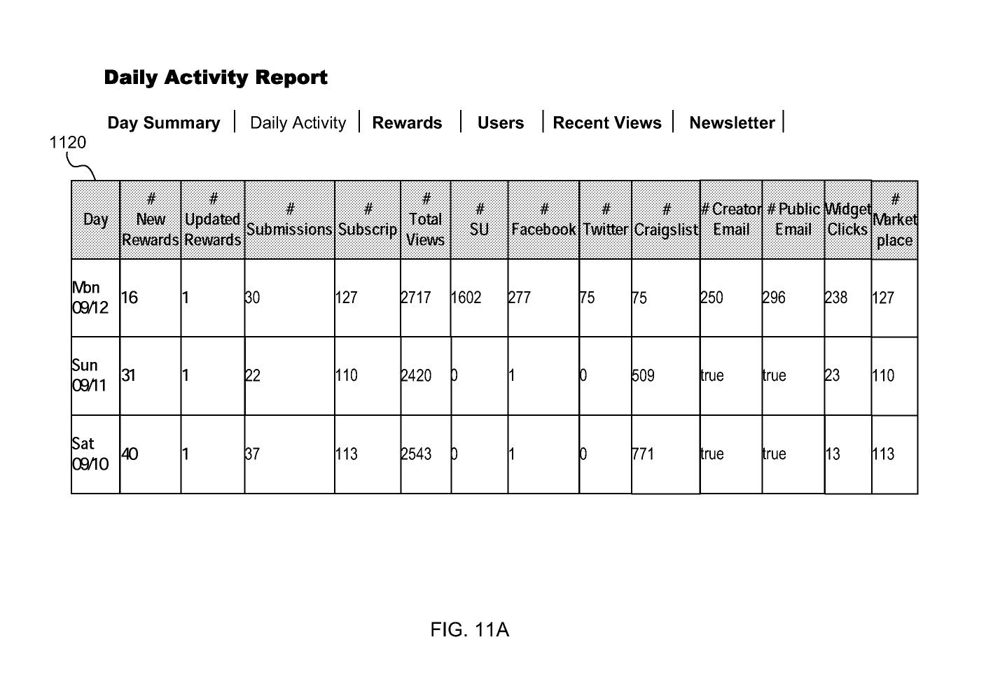

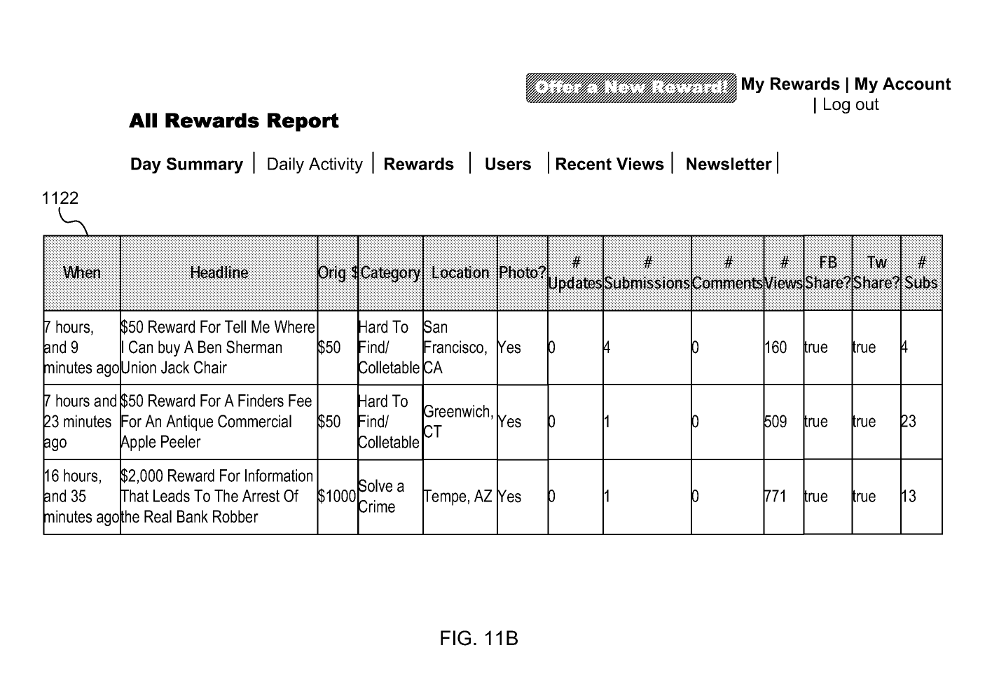

FIGS. 11A and 11B show data tables 1120, 1122 of sample tracking reports of Reward Creators, their bounties or rewards maintained by the incentive system 150 of FIG. 1A, according to some embodiments. Tracking reports may be generated for any user of the incentive system 150 such as the service provider, Reward Hunter, agents, and so on. For example, tracking reports may provide data that can be tracked from activities of Reward Creators, agents and contacts (that have submitted solution opportunities to Reward Creators). Other examples of data that can be tracked from the activities of the users includes, but is not limited to, other rewards that the Reward Creator is currently offering, past rewards that the Reward Creator has offered, where rewards have been posted, Reward Creator's response rate to submissions to a reward (or all the rewards that seeker has offered), ratings of the Reward Creator by people trying to win rewards, date/time stamps, click frequency, and so on. Additionally, the incentive system 150 may track and maintain data about a Reward Hunter, such as a Reward Hunter's submission history, frequency of submissions, duration between submissions, quality of the submissions, rating of the submissions by the Reward Creator, peers, contacts or others, duration since winning the last reward, searched and viewed rewards, and so on.

All of these examples of data may be tracked from the activities of the Reward Creator, Reward Hunter, or any user, and can be displayed by the incentive system 150. Some data may be publically displayed and some may be restricted with limited access. For example the incentive system may give a Reward Hunter a rating or score based on the Reward Hunter's performance of responding to submissions of past rewards. That rating score may be displayed on any future rewards that the Reward Hunter may submit to. Similar rating processes may be in place for activities of the Reward Creator, such as for the quality of the Rewards offered. For example, the incentive system 150 may display the total amount of rewards paid by a Reward Creator on goal or need page 110, 500, or in the marketplace 120.

The Recent users Report 1120 is a mock up of a reporting that may be available in the incentive system 150. Recent users can be Reward Creators, agents or contacts (that submitted solution opportunities to Reward Creators) or Reward Hunters. The Recent users Report 1120 allows the system 150 to internally monitor the activity and process of various users. Some examples include:
monitoring the average bounties or rewards of our users
the number of views a Reward Creator's goal or need gets
the average number of views specific goals or bounties get
the average number of views specific types of goals or needs get
the types of social networks that are generating the most goal views
the average number of solution opportunities a Reward Creator gets
the average number of times a goal or need was shared by an agent
click frequency
time/date stamps

The bounty users Report 1122 is a mock up of the reporting that may be available in the system 150 to track the various bounties or rewards that Reward Creators' offer. This report may show Reward Creators' favorite and least favorite bounty types (including the free text customer bounties that Reward Creators list). It may also include the number of views that each Reward Creator's bounty receives and how often it is shared and distributed with other contacts. The bounty user Report 1122 may also show whether Reward Creators increased their bounties and by how much they increased them. Additionally, the bounty users Report 1122 may show the bounty spit ratios that are chosen by the Reward Creators or agents. Other attributes in reward reports may include, reward category, reward headline, location, when the last viewing occurred, and so on.

The report also shows the various bounty features and functionality that users may choose to use in the system 150 and which functionality that they do not use.

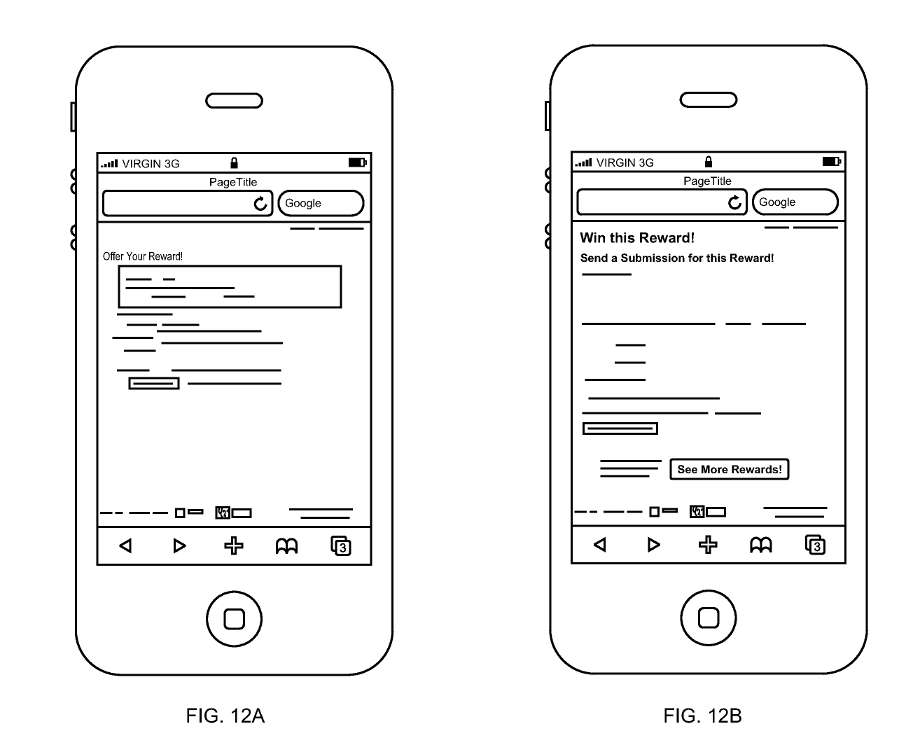

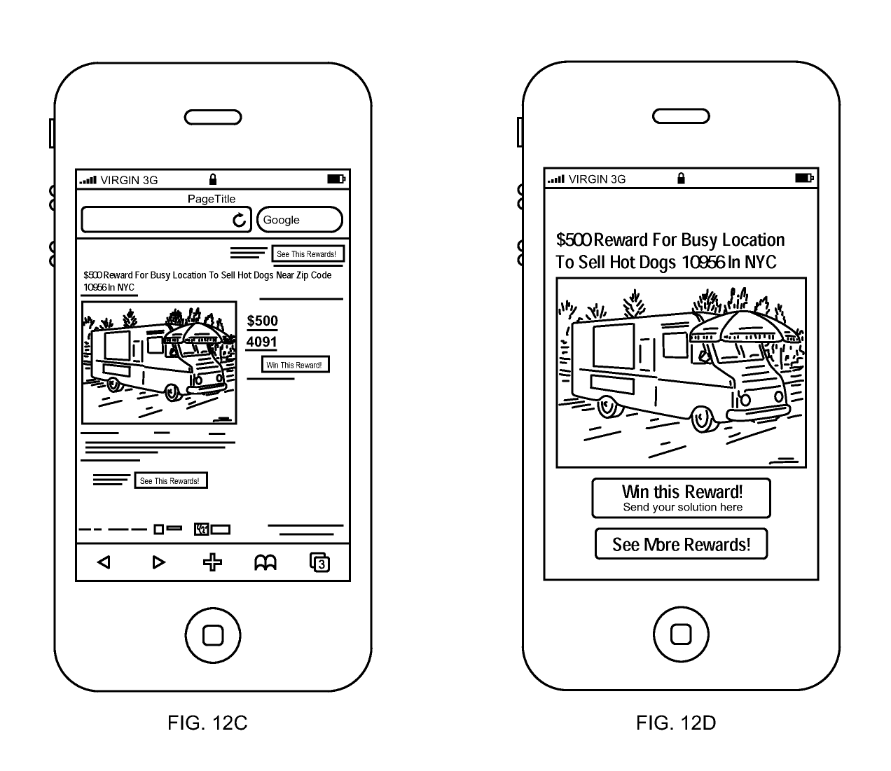

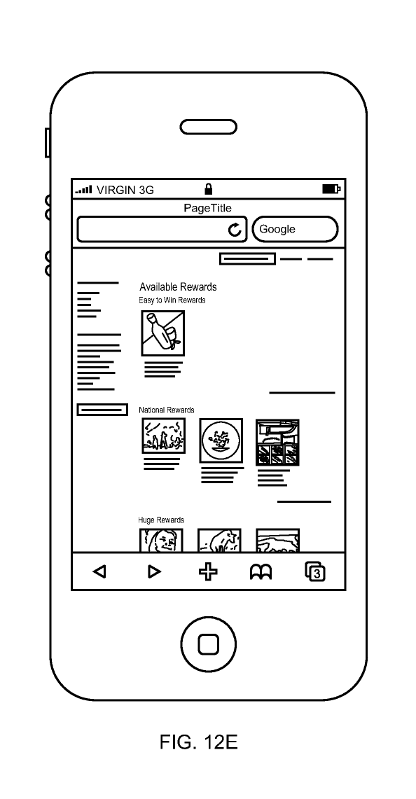

FIGS. 12A-E illustrate mobile devices configured (e.g., by mobile applications) to access various features and services of the incentive system 150, according to some embodiments. FIGS. 12A and 12B illustrate, with the use of one or more mobile applications, the ability to access a user's incentive system 150 account on the mobile device. A user may log into one's account and access features to create, edit, manage, and submit to reward postings. FIG. 2A allows a user, such as a Reward Creator, to create a reward on a mobile device. FIG. 12B allows a user, such as a Reward Hunter, to submit a solution opportunity for a posted reward. FIGS. 12C, 12D, and 12E illustrate, with the use of one or more mobile application for the incentive system 150, the ability to access reward postings on a mobile device. A viewer may view rewards in any detail level on the mobile device. Additionally, a viewer may access the Marketplace on the mobile device. In some embodiments, the mobile device may be any portable handheld device such as a tablet, blackberry device, iPhone, and so on.

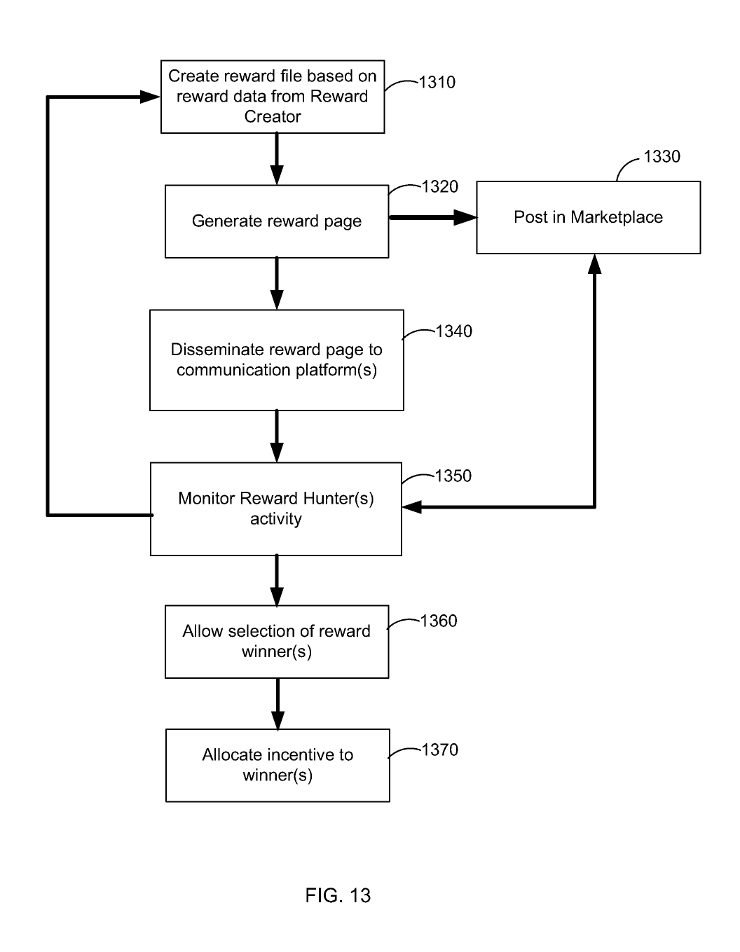

FIG. 13 is a flow chart illustrating the operation of the incentive system 150 of FIG. 1A, according to some embodiments. At step 1310, a reward file is created based on reward data from a Reward Creator. The reward file includes data that describes a goal or need and an incentive (financial or non-financial value) for successfully achieving that goal or need. At step 1320, a reward page for the reward file is generated. The reward page may be posted in a Marketplace at step 1330. At step 1340, the reward page is disseminated to at least one communication platform. Communication platforms include, but are not limited to, social networks, email, SMS, and mobile applications on mobile devices. At step 1350, one or more Reward Hunters' activity is monitored. This includes viewing rewards, submitting solution opportunities to fulfill a goal or need of a reward, and/or the Reward Hunter(s) becoming Reward Creator(s) and creating their own reward files. Monitoring Reward Hunter(s) include monitory activity in the Marketplace. At step 1360, selection of one or more reward winners is allowed. At step 1370, the incentive is allocated to the one or more reward winners.

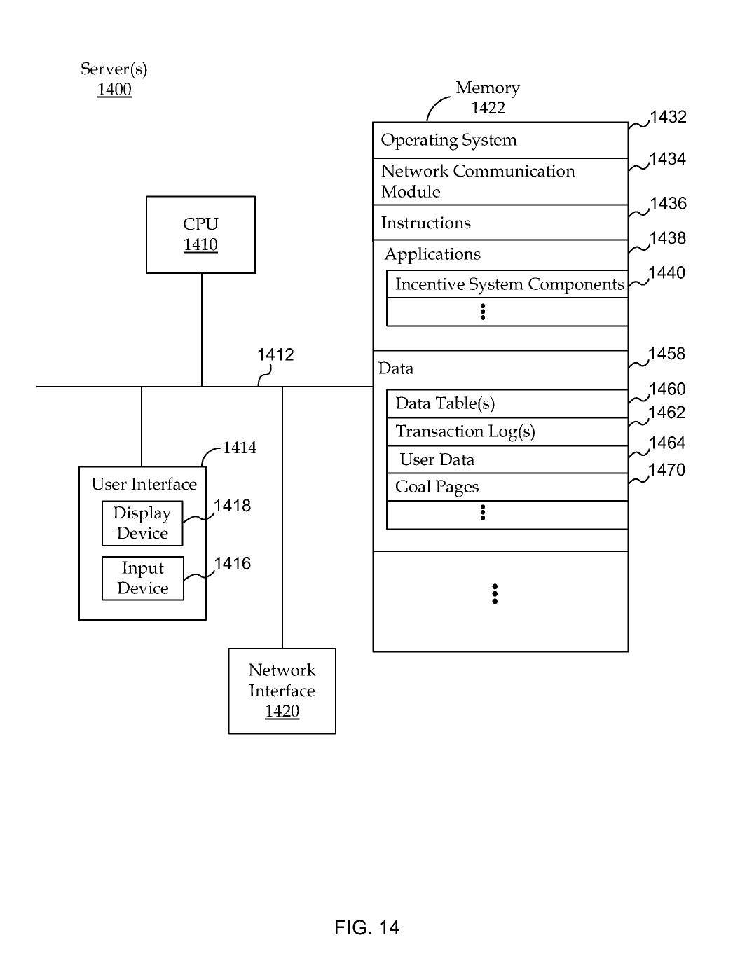

FIG. 14 is a block diagram illustrating an embodiment of at least one server system 1400 according to embodiments. It will be appreciated that the methodologies and systems described herein may be executed from a stand-alone machine, such as server 1400 or a plurality of machines.

The server system 1400 include at least one data processor or central processing unit (CPU) 1410, one or more optional user interfaces 1414, a communications or network interface 1420 for communicating with other computers, servers and/or clients, a memory 1422 and one or more signal lines 1412 for coupling these components to one another. The user interface 1414 may include or connect to an input device 1416, such as a keyboard, mouse, keypad, or the like, and/or a display device 1418. The one or more signal lines 1412 may constitute one or more communication busses.

The memory 1422 may include high-speed random access memory and/or non-volatile memory, such as one or more magnetic disk storage devices. The memory 1422 may store an operating system 1432, such as LINUX, UNIX or WINDOWS, that includes procedures for handling basic system services and for performing hardware dependent tasks. The memory 1422 may also store communication procedures in a network communication module 1434. The communication procedures are used for communicating with clients, such as the clients 101 (FIG. 1A), and with other servers and computers.

The memory 1422 may include instructions 1436 that, when executed, cause the server system 1400 to perform any one or more of the methodologies described herein. The memory 1422 may additionally, or in the alternative, include several applications 1438, including incentive system engines and components 1440 for server(s) 1400 to execute operations and provide services associated with the incentive system 150 of FIG. 1A in any manner previously described.

Memory 1422 also includes data storage 1458 to store data accessed and managed by applications 1438 or applications at other servers and machines. Stored data includes data tables 1460 and transaction logs 1462 for storing and recording data being retrieved or accessed. Data storage 1458 also includes user data 1464 and goal pages 1470, which may be accessed, modified, and utilized in any manner previously described.

FIG. 14 is intended more as a functional description of the various features which may be present in an incentive system such as incentive system 150 of FIG. 1A rather than as a structural schematic of the embodiments described herein. In practice, and as recognized by those of ordinary skill in the art, the functions of the server 1400 may be distributed over a large number of servers or computers, with various groups of the servers performing particular subsets of those functions. Items shown separately in FIG. 14 could be combined and some items could be separated. For example, some items shown separately in FIG. 14 could be implemented on single servers and single items could be implemented by one or more servers. The actual number of servers in incentive system, such as incentive system 150, and how features are allocated among them will vary from one implementation to another, and may depend in part on the amount of information stored by the system and/or the amount data traffic that the system must handle.

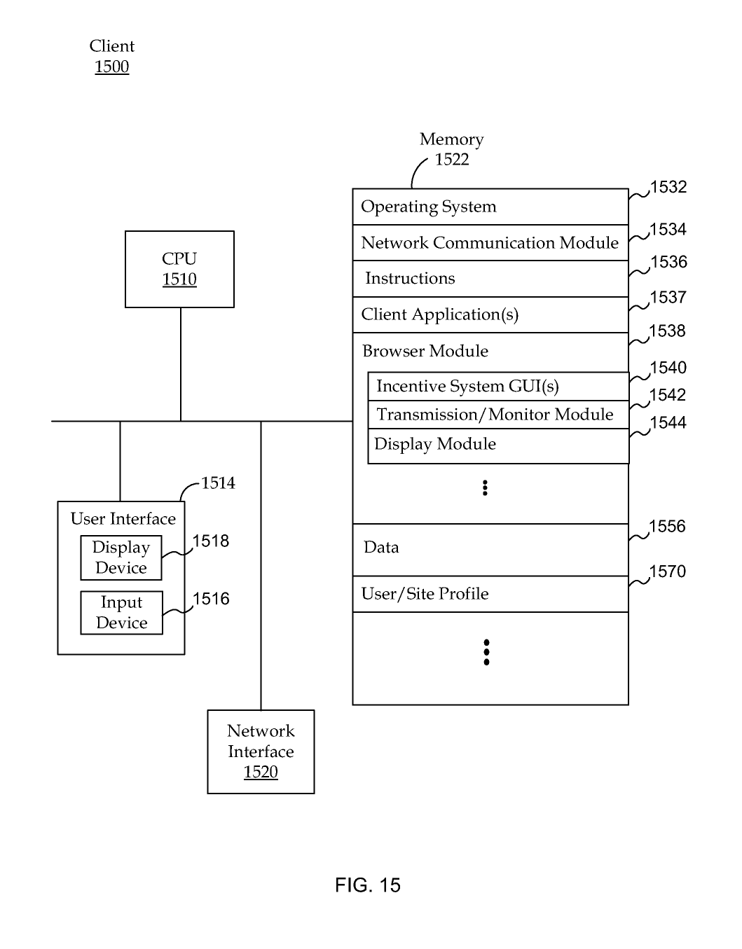

FIG. 15 illustrates a block diagram of an embodiment of a client system 1500, such as those used by the clients 101 (FIG. 1A). The client system 1500 may include at least one data processor or central processing unit (CPU) 1510, one or more optional user interfaces 1514, a communications or network interface 1520 for communicating with other computers, servers and/or clients, a memory 1522 and one or more signal lines 1512 for coupling these components to one another. The user interface 1514 may include or connect to an input device 1516, such as a keyboard, mouse, keypad, or the like, and/or a display device 1518. The one or more signal lines 1512 may constitute one or more communications busses.

The memory 1522 may include high-speed random access memory and/or non-volatile memory, such as one or more magnetic disk storage devices. The memory 1522 may store an operating system 1532, such as LINUX, UNIX or WINDOWS, that includes procedures for handling basic system services and for performing hardware dependent tasks. The memory 1522 may also store communication procedures in a network communication module 1534. The communication procedures are used for communicating with server(s) 1400 (FIG. 14).

The memory 1522 may also include the following elements, or a subset or superset of such elements: instructions 1536, client applications 1537, and a browser or browser tool module 1538. In embodiments where the client system 1500 is coupled to a local server computer, one or more of the modules and/or applications in the memory 1522 may be stored in a server computer at a different location than the client device 1500. The memory 1522 may include instructions 1536 that, when executed, cause the client system 1500 to perform any one or more of the client device methodologies described herein.

The browser tool 1538 may additionally include an incentive system graphical user interface 1540 to enter data for use by the incentive system 150 of FIG. 1A and a transmission/monitoring module 1542 for monitoring user input and/or for receiving and sending content to and from the server(s) 1400. A display module 1544 of the browser tool 1538 allows content received from server(s) 1400 to be displayed.

Each of the above identified modules and applications correspond to a set of instructions, such as instructions 1436, 1536, for performing one or more functions described herein. These modules (i.e., sets of instructions) and applications need not be implemented as separate software programs, procedures or modules, and thus various subsets of these modules may be combined or otherwise re-arranged in various embodiments. In some embodiments, memory 1522 or 1422 may store a subset of the modules and data structures identified above. In other embodiments, all or some data stored in data storage 1556 may be stored in memory 1422 at the server 1400. Furthermore, memory 1522 or 1422 may store additional modules and data structures remotely or in any other manner not described above. Additionally, user/site profile data 1570 may be stored in either memory 1422 on the server device 1400 or memory 1522 on the client device 1500, or a combination of both.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the invention(s) and its practical applications, to thereby enable others skilled in the art to best utilize the various embodiments with various modifications as are suited to the particular use(s) contemplated.

What is claimed:

1. A computer system on at least one server in a communication network, comprising:
one or more computers having one or more processors;
and a computer-readable medium coupled to the one or more computers having instructions stored thereon which, when executed by the one or more computers, cause the one or more computers to perform operations, the one or more computers being configured to:
receive a first request to share a reward page from a first user, the reward page indicating a goal or need;
in response to the received first request, disseminate the reward page to a first plurality of communication platforms via the network;
receive at least a second request to share the reward page from at least a second user, wherein the at least second user is a first contact from the first plurality of communication platforms;
in response to the received at least second request, disseminate the reward page to a second plurality of communication platforms via the network;
receive a plurality of solution opportunities from one or more contacts from the first and second plurality of communication platforms;
determine at least one received solution opportunity from the plurality of solution opportunities that achieves the goal or need of the reward page;
determine a chain of contacts that resulted in the submission of selected at least one solution; and
split the reward among the contacts in the chain.

2. A computer-implemented method for paying out a reward comprising:
receiving a first request to share a reward page from a first user, the reward page indicating a goal or need;
in response to receiving the first request, disseminating the reward page to a first plurality of communication platforms via the network;
receiving at least a second request to share the reward page from at least a second user, wherein the at least second user is a first contact from the first plurality of communication platforms;
in response to receiving the at least second request, disseminating the reward page to a second plurality of communication platforms via the network;
receiving a plurality of solution opportunities from one or more contacts from the first and second plurality of communication platforms;
determining at least one received solution opportunity from the plurality of solution opportunities that achieves the goal or need of the reward page;
determining a chain of contacts that resulted in the submission of selected at least one solution; and
splitting the reward among the contacts in the chain.

3. A computer system on at least one server in a communication network, comprising:
one or more computers having one or more processors;
and a computer-readable medium coupled to the one or more computers having instructions stored thereon which, when executed by the one or more computers, cause the one or more computers to perform operations, the one or more computers being configured to:
receive log in information from a user;
select a plurality of reward pages from a repository of reward pages;
display the plurality of reward pages for the user to view;
allow the user to select at least one reward page from the plurality of reward pages;
allow the user to submit a solution opportunity for the selected at least one reward page; and
notify a reward creator of the solution opportunity, wherein the selected at least one reward page was created based on information provided by the reward creator.

4. The system of claim 3, wherein the one or more computers are further configured to track the activity of the user on the communication network.

5. The system of claim 4, the one or more computers being configured to select the plurality of reward pages includes being configured to select based on the tracking activity of the user.

6. The system of claim 4, wherein the one or more computers being configured to select based on the tracking activity of the user includes being configured to select based on a combination of the tracking activity and the user login information.

7. The system of claim 3, wherein the one or more computers being configured to select the plurality of reward pages includes being configured to select based on preference information provided by the user.

8. The system of claim 3, wherein the one or more computers are further configured to access at least one service from a group consisting of: access to view the user's own account information, status of other reward opportunities submitted, history of rewards won, and history of rewards created.

9. The system of claim 3, wherein the one or more computers being configured to select the plurality of reward pages included being configured to select based on at least one criteria.

10. The system of claim 9, wherein the at least one criteria includes a duration of time.

11. A computer-implemented method for viewing and sharing a reward on a server in a communication network, comprising:
receiving log in information from a user;
selecting a plurality of reward pages from a repository of reward pages;
displaying the plurality of reward pages for the user to view;
allowing the user to select at least one reward page from the plurality of reward pages;
allowing the user to submit a solution opportunity for the selected at least one reward page; and
notifying a reward creator of the solution opportunity, wherein the selected at least one reward page was created based on information provided by the reward creator.

12. The method of claim 11, further comprising tracking the activity of the user on the communication network.

13. The method of claim 12, wherein selecting the plurality of reward pages includes selecting based on the tracking activity of the user.

14. The method of claim 12, wherein selecting based on the tracking activity of the user includes selecting based on a combination of the tracking activity and the user login information.

15. The method of claim 11, wherein selecting the plurality of reward pages includes selecting based on preference information provided by the user.

16. The method of claim 11, further comprising accessing at least one service from a group consisting of: access to view the user's own account information, status of other reward opportunities submitted, history of rewards won, and history of rewards created.

17. The method of claim 11, wherein selecting the plurality of reward pages is selected based on at least one criteria.

18. The method of claim 17, wherein the at least one criteria includes a duration of time.
